(19) United States
(12) Patent Application Publication
(10) Pub. No.: US 2005/0096950 A1
(43) Pub. Date: May 5, 2005

(54) Method and apparatus for creating and evaluating strategies

(76) Inventors: Scott Malcolm Caplan, Alpharetta, GA (US); Yen Fook Chang, Piedmont, CA (US); Michael Raymond Cohen, Richmond, CA (US); Stuart Crawford, Piedmont, CA (US); Brendan Del Favero, Davis, CA (US); Gerald Fahner, Novato, CA (US); Robert Mun-Cheong Fung, Davis, CA (US); Arthur Bruce Hoadley, Berkeley, CA (US); Jun Hua, Greenbrae, CA (US); Chisoo S. Lyons, San Rafael, CA (US); John Perlis, (US); Nina Shikaloff, San Rafael, CA (US); Gary Sullivan, San Francisco, CA (US); Aush Thaker, (US); Eric C. Wells, Berkeley, CA (US)

Correspondence Address: GLENN PATENT GROUP, 3475 EDISON WAY, SUITE L, MENLO PARK, CA, 94025, US

(21) Appl. No.: 10/697,907

(22) Filed: Oct. 29, 2003

(51) Int. Cl. G06F 17/60

(52) U.S. Cl. 705/7

(57) ABSTRACT

A method and apparatus for strategy science methodology involving computer implementation is provided. The invention includes a well-defined set of procedures for carrying out a full range of projects to develop strategies for clients. One embodiment of the invention produces custom consulting projects that are found at one end of the full range of projects. At the other end of the range are, for example, projects developing strategies from syndicated models. The strategies developed are for single decisions or for sequences of multiple decisions. Some parts of the preferred embodiment of the invention are categorized into the following areas: Team Development, Strategy Situation Analysis, Quantifying the Objective Function, Data Request and Reception, Data Transformation and Cleansing, Decision Key and Intermediate Variable Creation, Data Exploration, Decision Model Structuring, Decision Model Quantification, An Exemplary Score Tuner, Strategy Creation, An Exemplary Strategy Optimizer, An Exemplary Uncertainty Estimator, and Strategy Testing. Each of the sub-categories are described and discussed in detail under sections of the same headings. The invention uses judgment in addition to data for developing strategies for clients.

### BACKGROUND OF THE INVENTION

1. Technical Field

The invention relates to creating and evaluating strategies. More particularly, the invention relates to a method and apparatus for a strategy science methodology that uses data, procedures, tools, resources, improvements, and deliverables for completing sub-processes for creating and evaluating strategies for clients.

2. Description of the Prior Art

Today the modern, customer-facing enterprise has a wide variety of opportunities for interacting with its customers, where customer refers to both current and prospective. Channels for customer interaction typically include mail, email, retail stores and branches, inbound and outbound telephone contacts, and the World Wide Web (Web). Reasons for customer interactions include marketing, customer transactions, and customer service.

Given all such channels and types of interactions, it would be advantageous for an enterprise to present a set of customized, consistent messages to the customer, based on a clear understanding of the particular customer's needs, as well as of the goals on the enterprise.

Over the last several years, customer relationship management (CRM) has been recognized in the enterprise world as a major opportunity. To improve CRM, enterprises have invested significantly in data warehousing, business intelligence, customer service, and sales force automation systems. Such 1990's CRM investments have yielded operational efficiencies, referred to as cost-side gains. However, such investments have not generated expected and consistent strategic advantages, referred to as revenue-side gains.

It is believed that the failure to generate these expected strategic advantages from CRM initiatives is rooted in the lack of analytic infrastructure to connect an enterprise's back office data to its front-end operational processes. Currently, the typical enterprise has developed a jumble of processes that create analysis results from data, that make use of those analyses with judgment to develop customer strategies, and that then implement the designed strategies. Such processes vary widely from department to department and involve a substantial number of personnel.

It would therefore be advantageous to provide an integrated analytic infrastructure that is used throughout the enterprise for optimizing customer interactions with respect to explicitly stated objectives. Such integrated analytic infrastructure seamlessly integrates three major functions: 1) the collection of informative data sources in preparation for analysis, 2) the development of strategies via value-focused analytics, optimization, and simulation, and 3) the execution of these strategies in operational decision making systems, resulting in better decisions through data.

### SUMMARY OF THE INVENTION

A method and apparatus for strategy science methodology involving computer implementation is provided. The invention includes a well-defined set of procedures for carrying out a full range of projects to develop strategies for clients. An example of the invention is custom consulting projects that are found at one end of the full range of projects. At the other end of the range is, for example, projects developing strategies from syndicated models. The strategies developed are for single decisions or for sequences of multiple decisions. Some parts of the preferred embodiment of the invention are categorized into the following areas: Team Development, Strategy Situation Analysis, Quantifying the Objective Function, Data Request and Reception, Data Transformation and Cleansing, Decision Key and Intermediate Variable Creation, Data Exploration, Decision Model Structuring, Decision Model Quantification, An Exemplary Score Tuner, Strategy Creation, An Exemplary Strategy Optimizer, An Exemplary Uncertainty Estimator, and Strategy Testing. Each of the sub-categories are described and discussed in detail under sections of the same headings. The invention uses judgment in addition to data for developing strategies for clients.

### BRIEF DESCRIPTION OF THE DRAWINGS

FIG. 1 is a block diagram showing strategy science decision models rendering visible the impact of multiple variables on a portfolio under various economic conditions according to the invention;

FIG. 2 compares the performances of three strategies during both a “regular” economy and a simulated recession according to the invention;

FIG. 3 is a block diagram of the main modules and their relationships according to the invention;

FIG. 4 is a flow diagram of key sub-processes according to the invention;

FIG. 5 is a schematic diagram of the general structure of project organization according to the preferred embodiment of the invention;

FIG. 6 is an example project plan according to the invention;

FIG. 7 shows a block diagram of the relationship of a Team Creation component and a Decision Quality component according to the invention;

FIG. 8 is an illustration of a decision quality chain according to the prior art;

FIG. 9 shows a decision quality diagram according to the invention;

FIG. 10 is a schematic diagram of strategy situation analysis according to the invention;

FIG. 11 which shows a diagram of a decision hierarchy applied to a given decision situation according to the invention;

FIG. 12 is a block diagram showing five components of the data request and reception according to the invention;

FIG. 13 is a block diagram showing three main components of the data transformation and cleansing module according to the invention;

FIG. 14 is a block diagram showing two main components of the decision key and intermediate variable creation module according to the invention;

FIG. 15 is a block diagram showing the main components of the data exploration module according to the invention;

FIG. 16 is a block diagram showing the main components of the decision model structuring module according to the invention;

FIG. 17 is a schematic diagram of a tornado diagram according to the invention;

FIG. 18 is a block diagram showing three main components of the quantify and validate decision model according to the invention;

FIG. 19 is a schematic diagram of a decisioning client configuration including a score tuner component according to the invention;

FIG. 20 is a schematic diagram of the score tuner sub-system according to the invention;

FIG. 21 is a block diagram of Score Tuner in a given context according to the invention;

FIG. 22 is a configuration map of business components according to the invention;

FIG. 23 shows a schematic diagram of how the Modeler interacts with other business components according to the invention;

FIG. 24 is a schematic diagram showing control flow and iterative flow between model optimization, optimization results analysis, and develop strategies according to the invention;

FIG. 25 is a screen print of a user interface window according to the invention;

FIG. 26 is a flow diagram of designed data, precise models, optimal strategies, and maximum profits according to the invention; and

FIG. 27 is a schematic diagram showing control flow and iterative flow between test strategies, strategy evaluation, and active data collection according to the invention.

### DETAILED DESCRIPTION OF THE INVENTION

Glossary

Table A below provides a glossary of terms, some used frequently herein.

TABLE A

| | |
|---|---|
| action | An action to take on a customer. |
| action-based | A predictive model whose value depends on the |
| predictor | course of action selected for a particular |
| | decision. |
| active data | A technique for developing strategies to |
| collection | collect designed data to be used in later |
| | predictive modeling. |
| actual | The set of cases over which a strategy is |
| population | actually applied or executed (compare with |
| | target population and representative |
| | population). |
| case | An individual record or instance in a |
| | representative population. A case specifies |
| | a value for each decision key for the |
| | decision. |
| case-level | A constraint on the actions available at a |
| constraint | decision for a particular case, depending on |
| | the value of its decision keys. |
| constraint | A rule that limits the set of strategies that |
| | are feasible or acceptable. |
| continuous | A set of data is said to be continuous if the |
| data | values belonging to it may take on any value |
| | within a finite or infinite interval. |
| | Continuous data can be counted, ordered and |
| | measured. |
| decision | A commitment to an action. A decision can be |
| | made at a case level, by taking an action for |
| | a particular case in a representative |
| | population, or at a portfolio level, by |
| | selecting a strategy to apply to all cases in |
| | a representative population. |
| decision | The systematic and quantitative study of a |
| analysis | decision situation to provide insight into |
| | the situation and to suggest and justify the |
| | best course of action. |
| decision | An automated system that applies predictive |
| engine | models and strategies to determine a course |
| | of action for each individual case submitted |
| | to it. |
| decision | A variable whose value is known at the time a |
| key | decision is to be made. In an influence |
| | diagram, there is an arc into the decision |
| | node from each of its decision keys. In a |
| | strategy tree, the decision keys are the |
| | variables on which splits can be defined. |
| decision | The space (set) of all decision key |
| key space | combinations for a particular set of decision |
| | keys. |
| Decision- | An object (e.g. person) having authority to |
| Maker | allocate resources with respect to a decision. |
| decision | A mathematical description of a decision |
| model | situation that includes decision variables |
| | (representing the course of action), decision |
| | key variables (representing the known |
| | characteristics of a case), value variables |
| | (representing the objective function to be |
| | maximized), and constraints (representing |
| | limits on the set of acceptable strategies). |
| | The value variables and constraint variables |
| | are related mathematically to the decision |
| | and the decision keys by action-based |
| | predictors. A decision model can be shown |
| | graphically as an influence diagram. |
| decision | A unique combination of decisions for a set |
| scenario | of decisions. |
| decision | The set of all decision scenarios for a |
| scenario | particular set of decisions. |
| space | |
| Decision | Fair, Isaac and Company, Inc.'s decision |
| System | engine product. |
| designed | A data set resulting from an experimental |
| data | design process that systematically tests the |
| | results of applying various actions to |
| | various cases, intended to support future |
| | predictive modeling. |
| deterministic | A strategy that recommends the same action |
| strategy | for all cases that have identical values for |
| | their decision keys. |
| discrete | A set of data is said to be discrete if the |
| data | values/observations belonging to it are |
| | distinct and separate, i.e. they can be |
| | counted (A, B, C). |
| drivers | Uncertain quantities (intermediate variables). |
| framing | The process of clearly identifying the |
| | parameters of the decision to be made and |
| | specifying its context within the business |
| | processes of an organization. |
| influence | A graphical representation of a decision model |
| diagram | in which each node represents a variable and |
| | each arc between nodes represents a relationship |
| | between those variables. |
| INFORMPLUS | A software tool created by Fair, Isaac and |
| | Company, Inc. for developing scorecards and |
| | predictive models. |
| performance | Data that is associated with strategies |
| data | executed in the past. |
| performance | The period of time over which a quantity is |
| period | measured or a strategy is evaluated. |
| performance | A quantity of interest in a decision problem, |
| variable | such as the value variable (representing the |
| | objective function to be maximized) or a |
| | constraint variable. |
| portfolio | Another term for representative population. |
| portfolio- | A constraint that should be satisfied at the |
| level | portfolio-level. |
| constraint | |
| portfolio- | A quantity (such as mean of some case-level |
| level | characteristic or quantity) computed over all |
| variable | cases in a representative population or |
| | portfolio. |
| portfolio | The evaluation of a strategy by applying it |
| simulation | to each case in a portfolio or representative |
| | population, using Monte Carlo simulation |
| | methods. |
| predictive | A function or formula that can be evaluated |
| model | to estimate the value of some unknown quantity |
| | based on the values of known quantities. |
| predictor | Another term for decision key. |
| variable | |
| probabilistic | A strategy that recommends different outcomes |
| strategy | for cases with identical values of their |
| | decision keys. |
| representative | A finite set of cases used in strategy |
| population | development that is selected or designed to |
| | approximate the relative frequency of cases in |
| | the strategy's target population. |
| scenario | Shorthand for decision scenario. |
| segment | A subset of a strategy's target population |
| | identified by a specific set of discrete values |
| | (or range of numeric values) for each decision |
| | key. |
| sensitivity | A technique for determining the effect of |
| analysis | changing modeling assumptions on the behavior |
| | of the model in question. |
| strategy | A set of rules that completely specifies the |
| | course of action to take for a particular |
| | decision in each case in a particular |
| | target population. |
| strategy data | Data that recommends the currently optimal |
| | actions for a set of cases. |
| Model Builder | A software solution created and sold by Fair, |
| for Decision | Isaac and Company, Inc. for developing |
| Tree | data-driven strategies. |
| strategy key | Another term for decision key. |
| strategy | The analytic development of strategies from |
| modeling | quantitative models. Both data and subject |
| | matter expertise are used to build such |
| | quantitative models for specific business |
| | decisions. |
| Strategy | A software solution created by Fair, Isaac |
| Optimizer | and Company, Inc. and used internally by |
| | Fair, Isaac and Company, Inc. analysts |
| | for developing model-driven strategies. |
| Strategy | An exemplary methodology for modeling and |
| Science | developing optimized strategies for a decision |
| | situation, incorporating techniques of |
| | action-based predictive modeling, decision |
| | analysis, and active data collection. |
| strategy | A point in an enterprise's business process |
| situation | where interactions with customers occur and |
| | where choice of actions are automated. |
| strategy | Strategies are typically represented in the |
| tree | form of a strategy tree. In such strategy |
| | tree, each branch represents a specific |
| | volume of the decision key space and has |
| | associated with it specific actions from the |
| | scenario space. |
| subject | An object (e.g. person) that provides an |
| matter | important source of information with respect |
| expert | to a particular subject or business process. |
| target | The set of cases over which a strategy is |
| population | intended to be executed or applied. The |
| | relative frequency of cases in the target |
| | population can be quantified by a joint |
| | probability distribution over the decision keys. |
| | The target population is approximated during |
| | strategy development by the representative |
| | population. |
| TRIAD/ACS | A decision engine sold by Fair, Isaac and |
| | Company, Inc. for account management. |
| value of | A quantitative measure of how much a strategy |
| information | could be improved if some quantity that is |
| | currently not a decision key could be made a |
| | decision key. |
| value model | A specification of what a Decision-Maker wants |
| | more of (e.g. profit). |

### Strategy Science Overview

A method and apparatus for strategy science methodology involving computer implementation is provided. The invention includes a well-defined set of procedures for carrying out a full range of projects to develop strategies for clients. An example of the invention is custom consulting projects that are found at one end of the full range of projects. At the other end of the range is, for example, projects developing strategies from syndicated models. The strategies developed are for single decisions or for sequences of multiple decisions. Parts of the preferred embodiment of the invention are categorized into the following areas: Team Development, Strategy Situation Analysis, Quantifying the Objective Function, Data Request and Reception, Data Transformation and Cleansing, Decision Key and Intermediate Variable Creation, Data Exploration, Decision Model Structuring, Decision Model Quantification, An Exemplary Score Tuner, Strategy Creation, An Exemplary Strategy Optimizer, An Exemplary Uncertainty Estimator, and Strategy Testing. Each of the sub-categories are described and discussed in detail under sections of the same headings. The invention uses judgment in addition to data for developing strategies for clients.

In a rapidly changing economy, being able to simulate with greater clarity just how portfolios, such as credit card portfolios, perform in a new business environment gives a distinct competitive advantage over those businesses having portfolios that are not able to simulate. Yet up to now, forecasting performance has been a hit and miss process with guesswork playing a large part.

With Strategy Science, card issuers can use an analytically based methodology to gain greater insight into the impacts of their strategies in any given economic environment. That is, Strategy Science gives management insight on how economic changes impact portfolio profitability. The Strategy Science methodology makes the relevant factors affecting profitability very visible. This gives businesses a means to safeguard against an economic downturn, for example, or capitalize on an upswing.

Comparative Research

The performance of optimized credit line strategies developed, using the invention herein, was tested in varying economic conditions. The performance of these strategies was compared to those of the historical (judgmentally developed) strategy of a large lender under the same business conditions. The results show that Strategy Science strategies outperform judgmentally developed strategies under each of the economic conditions tested.

While the study was performed on credit line strategies, and while it simulated a recession economy, the use of Strategy Science is applicable to any decision area and any economic condition.

Visibility is Key to Management Control

Using Strategy Science methodology, users have the ability to stress-test a decision strategy. They can see the exact impact of business inputs, constraints, and tradeoffs before settling on precisely the right strategy to meet their stated business objectives.

Strategy Science allows the user to inject his own business expertise into an empirically based decision framework, the decision model, in a very precise and controlled way. The issuer can see the entire cycle of how a decision strategy impacts business performance, i.e. from evaluation of the decision inputs, how the decisions affect customer behavior, and how that behavior impacts profitability. Capturing the complexity of the interdependencies of all the relevant components of a decision through Strategy Science offers unprecedented insight into portfolio performance.

This visibility allows issuers to simulate various economic conditions or business environments and play out “what if” scenarios on decision strategies before they are implemented. The outcomes provide the insight for adjustment of the strategies to achieve maximum performance under a variety of economic conditions.

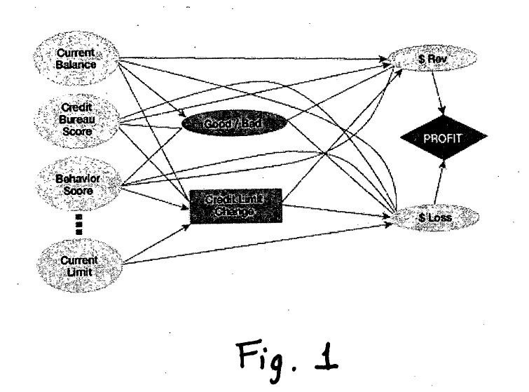

FIG. 1 is a block diagram showing strategy science decision models rendering visible the impact of multiple variables on a portfolio under various economic conditions.

Stress Testing Strategies for a Recession Economy

The impact of economic changes on a decision strategy can be observed by simulating the performance of the strategy through a decision model modified to reflect a changed economic environment. The critical relationships of the components of a decision, made explicit through a decision model, can be modified to reflect different assumptions with regard to how consumers might behave as a result of changes in the economy or business environment. Changing one or two assumptions regarding how decision components are linked together typically has ramifications on portfolio performance that no human could easily calculate with any precision.

For this study, researchers simulated a downward swing in the economy by modifying the decision model to reflect new bad-rate-by-score relationships and revised revenue assumptions. The historical strategies as well as strategies optimized under various lender-defined constraints were then played out in this new recessionary environment.

Using Strategy Science there are several ways to craft a decision strategy in anticipation of an economic shift. One way is to alter constraints as part of the optimization process. This approach shows the impact that defensive measures, such as raising score cutoffs or reducing contingent liability, has on overall portfolio profitability. Then the constraints can be adjusted to determine the appropriate decision strategies, balancing revenue increases, losses, balance growth, and profitability.

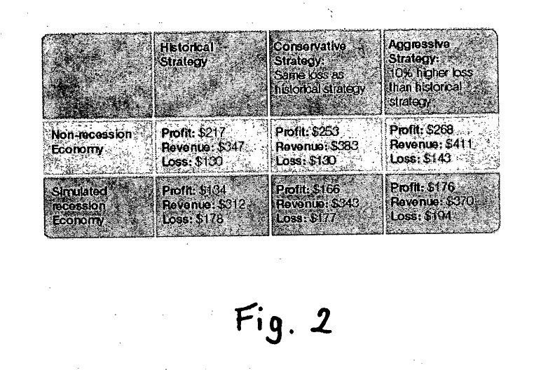

FIG. 2 compares the performances of three strategies during both a “regular” economy and a simulated recession. The three strategies are a Historical (non-Strategy Science, judgmental) strategy (which had been implemented by a national lender); and two Strategy Science strategies, conservative and aggressive, developed for a stable, non-recession economy. The study is based on revolving and transacting accounts, excluding in-active accounts.

The study shows that:
The Historical strategy takes a big fall in profitability—from $217 to $134.
The Conservative optimized strategy still increases profit over the Historical strategy—$166 vs. $134.
The Aggressive optimized strategy takes on a slim margin more in loss, but also increases profit over the Conservative strategy—$268 vs. $253. In a recession, losses rise somewhat more but the strategy still outperforms the Conservative strategy—$176 vs. $166.

The study also shows how optimized strategies can outperform Historical strategies in a regular economy. With the Strategy Science Conservative strategy maintaining the same credit risk exposure, profit can be significantly boosted from $217 to $253.

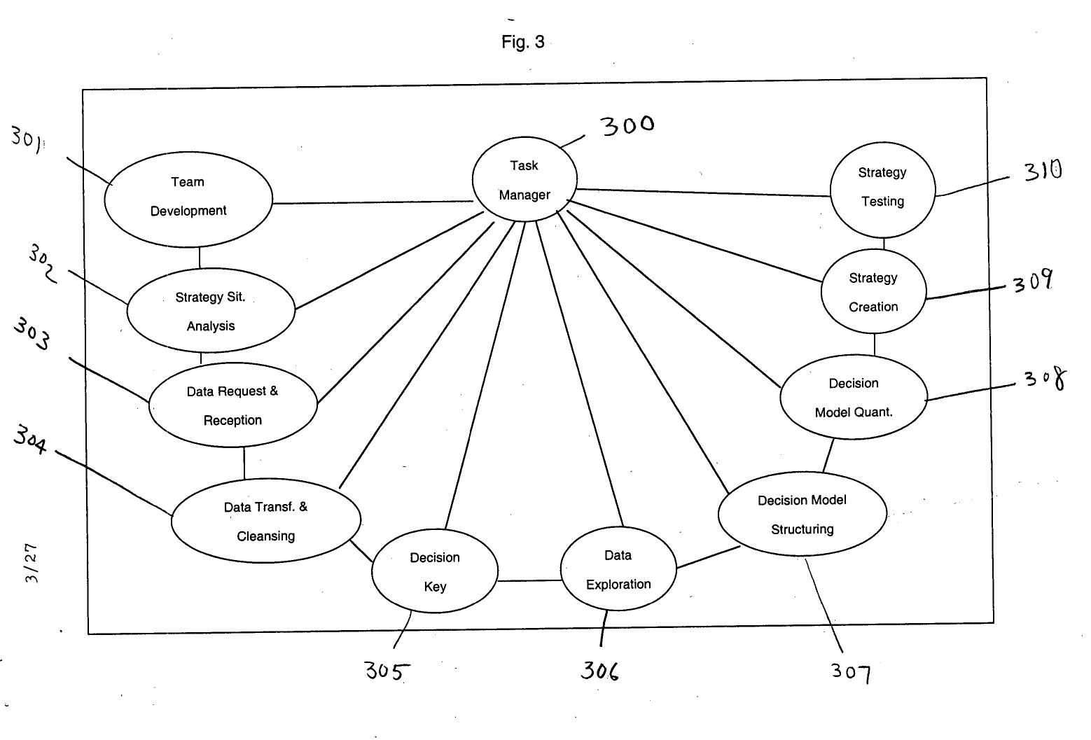

FIG. 3 is a block diagram of the main modules and their respective relationships according to the invention. One possible embodiment of the invention out of many possible embodiments provides ten main modules, each having the capability of interacting with an expert task manager 300. According to this embodiment of the invention, the first module is Team Development 301, which passes control to the Strategy Situation Analysis module 302, which passes control to the Data Request and Reception module 303, which passes control to the Data Transformation and Cleansing module 304, which passes control to the Decision Key and Intermediate Variable Creation module 305, which passes control to the Data Exploration module 306, which passes control to the Decision Model Structuring module 307, which passes control to the Decision Model Quantification module 308, which passes control to the Strategy Creation module 309, and which passes control to the Strategy Testing module 310. It is worth repeating that each main module has the capability to interact with the expert Task Manager 300.

It should be appreciated that various implementations of the invention herein are not required to use all of the ten main modules. Nor are various implementations required to interact with the Task Manager module 300. The particular modules implemented, and their sequence of implementation depends on the problem being solved by the user. The claimed invention is flexible to allow all variations.

It should also be appreciated that the invention is described herein mostly from the perspective of using all the modules and in a natural sequence, as shown in FIG. 3. The reason is to provide a framework with which to describe the invention and to be minimally confusing. Such embodiment of using all the modules and in the particular sequence is meant by example only.

Strategies define customer interactions, which in turn define an enterprise's relationship with the customer. According to the preferred embodiment of the invention, the strategy science process develops alternative strategies and selects a set of strategies that yields the greatest advantage for an enterprise. The strategy modeling process clearly defines a decision situation, as well as creates, evaluates, refines, and tests a set of candidate strategies for making the decision. The preferred embodiment of the invention provides seamless access to relevant data and smoothly exports strategies to operational systems.

The invention encompasses an analytic and decision-theoretic approach to the strategy science process, where analytic means the approach involves the analysis of data. That is not to say the approach is completely data-driven. In contrast thereto, the analytic philosophy herein incorporates the human expertise of the analyst and the client. Even when large amounts of historical enterprise data are available, the data in many important situations inadequately represents future behavior or the data is biased by previous decisions. Thus, the analyst uses judgment to weigh the input from subject matter experts with information contained in data when developing strategies according to the invention.

In the preferred embodiment of the invention, decision-theoretic means adhering to the principles and practices of decision theory in developing, testing, selecting, refining, and adapting strategies. Data and subject matter expertise are used to structure and quantify a decision model to connect the objectives of an enterprise to decisions and relevant variables. Once a decision model is constructed, the invention allows optimization algorithms to automatically discover new strategies. Constraints can be placed on the optimization to ensure that discovered strategies are implemented within the boundaries of the business process. Sensitivity analysis can be performed to determine the value of changing the boundaries. Finally, the preferred embodiment of the invention applies a closed-loop design of decision theory for the strategy science process. As strategies are executed, the data is collected to evaluate performance, refine strategies, and adapt to exogenous factors, such as chances in the economy.

In the preferred embodiment of the invention, experiments can also be used to ensure that strategies collect sufficient data for improving future system performance. Using such experiments to ensure strategies collect sufficient data often involves experimenting on a small subset of the customer population to test the outcomes of new interactions. The discovered strategies are compared to the status quo and easily modified by an analyst if need be. Such systematic approach for testing individual challenger strategies against a champion strategy addresses a high-level goal of understanding the performance of all challenger strategies with respect to the champion strategy.

According to one preferred embodiment of the invention, input to the strategy modeling process is a specification of a particular decision process to be studied. Outputs of the strategy science process are:
A set of strategies ready to be implemented;
A set of criteria for judging the performance of such strategies; and
Insight into the performance of the strategies and of the decision models.

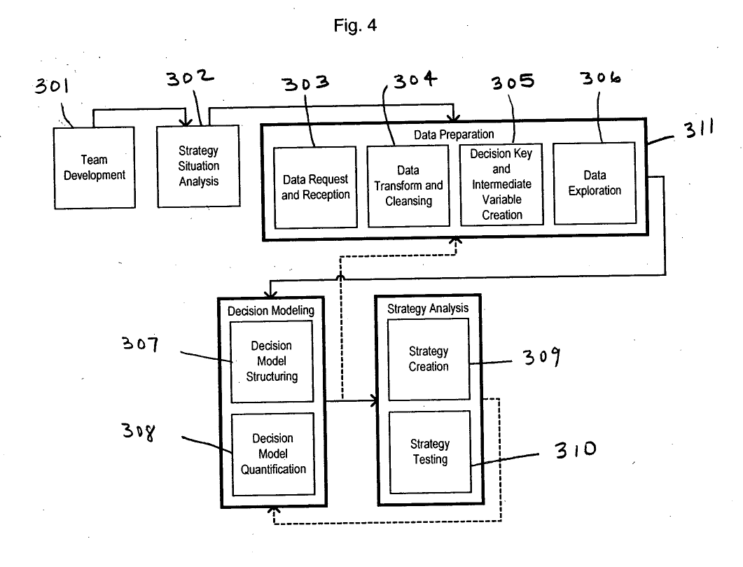

The preferred embodiment of the strategy science process is discussed with reference to FIG. 4, where FIG. 4 is a flow diagram of the key sub-processes, or modules of FIG. 3 according to the invention. The flow is primarily sequential from one sub-process to another from left to right along the solid arrows in the diagram. The feedback flow, shown by a dashed arrow into a process, represents iterative improvement of the results of each sub-process, based on information and insights discovered in subsequent sub-processes. This feedback flow is instrumental to the activity of the strategy science process.

In strategy science, the goal is to create a model that captures the essence of the business process. Experience with the strategy modeling shows that for capturing the essence of a business process, it is preferable to begin with a simple model and to add depth to parts of the model that seem to be most relevant to the essence at a later point in time. In contrast, for example, if an analyst begins by accounting for too much detail in a model, then it may be extremely difficult to gain insights into the factors that are driving the behavior of the model and business process. Superfluous concepts may be captured in the model, and it may be that little information is available for guiding the refinement of the parts of the model that could benefit from having more depth and detail.

The preferred embodiment of the strategy science begins with the development of a strategy modeling team 301. The responsibility of the strategy modeling team is to execute the analysis. The analysis is sufficient to allow the leader of the strategy team to convince the Decision-Maker to implement the strategy favored by the analysis. Such team often includes expert consultants, e.g. from a task manager, as well as persons selected from a client's enterprise. The strategy science team creation often includes an evaluation of the structure and dynamics of the Decision-Maker's organization to identify potential organizational roadblocks early in the process.

Next, the team focuses on strategy situation analysis 302 with a goal of identifying the values of the organization, and ensuring that the decisions and strategies considered in the analysis are the right ones. Strategy situation analysis is also referred to as framing the decision problem. Framing prevents finding an optimal solution to an irrelevant problem.

With framing complete, attention shifts to acquiring the relevant data. The data request and reception module 303 designs and executes the logistics of specifying, acquiring, and loading data required for decision and strategy modeling. The data transformation and cleansing module 304 goes a step further by verifying, cleansing, and transforming data. The decision key and intermediate variable creation module 305 includes computing additional variables from the data. Such module 305 also includes the construction of a data dictionary. A data exploration module 306 provides insight into the data, such as, for example, discovering which characteristics are effective decision keys and intermediate variables, and gaining valuable insight into a customer's business and business processes. With the data preparation 311 complete a team preferably has a thorough understanding of the quality and properties of the data.

Given prepared data, decision models are constructed 307 and 308. Decision models link the goals of an enterprise to the actions the enterprise can take and to the variables that have the potential to affect outcomes. That is, decision models are used to create and evaluate strategies. The decision key and intermediate variable creation module 305 begins with the focus on value and the quantities that can potentially drive such value directly. A sensitivity analysis is performed to determine the most significant drivers, which, in the decision model are called intermediate variables. Often such are dependent on both the decision and known quantities, called decision keys. Data exploration 306 is performed to provide insight into which decision keys are the most relevant for predicting the intermediate variables that drive value. The decision model structuring component 307 formalizes the relationships between decisions, decision keys, intermediate variables, and value by connecting them in the model. The decision model quantification module 308 refers to the process of encoding information into the decision model such as into a situation space and into an action space. The decision model quantification component 308 often includes building predictive models that map decision keys to intermediate variables.

It should be appreciated that in the preferred embodiment of the invention, the modules for decision modeling are highly iterative. An analyst preferably begins with a simplified value model with only a few drivers. Each driver is modeled crudely by one or two decision keys. No constraints are included at first. The goal of the first pass is to build a coarse model of a decision. Such model is then used to begin the strategy creation module 309 and the Strategy Testing module 310. The strategy creation module 309 and the Strategy Testing module 310 indicate areas of the decision model where refinement adds particular value. When an analyst is comfortable with the interaction between the decision model and the strategies, the analyst returns and adds details, such as constraints, that reflect limitations of the business process.

The strategy creation module 309 refers to the process of finding strategies that the client will consider testing. Optimization methods are applied to the decision model to determine the optimal strategy for a set of cases. New strategies can then be developed for benchmarking against the status quo using the results of the optimization. The strategy creation module is also a highly iterative process. As a decision model is enriched and as strategies are tested, the strategy creation sub-process evolves as well.

The strategy testing module 310 has two main components, evaluating each strategy based on simulation, and evaluating a strategy in the field, i.e. actively collecting data on performance of the strategy. It is preferable that much simulation is done to refine a decision model and the best strategy to the point where a client is comfortable testing the strategy in the field. Even then, it may be preferable for field deployment to begin on a small sample of the customer population and grow over time as newly collected data demonstrates the superiority of the new strategy.

Table B below shows a representative summary of the resource requirements for each sub-process or module in the preferred embodiment of the invention. The actual resource requirements for a particular project is estimated based on a variety of factors, such as project scope. All modules excluding the team development require the participation of a strategy modeling team. Therefore, tables for those sections focus on skills, or functionality, required from the particular strategy modeling team.

TABLE B

| Module | Resource Requirements |
|---|---|
| Team Development | Lead Consultantship: expertise in Strategy |
| | Modeling and Project Management |
| | Project Championship: signing the |
| | contract and understanding business |
| | process to be addressed |
| Strategy Situation | Lead Consultantship: expertise in Framing |
| Analysis | and group facilitation |
| | Strategy Modeling Team: heavy |
| | participation. |
| Data Request | Analyst functionality and that of |
| and Reception | counterpart on client side: expertise in |
| | software and hardware infrastructure of |
| | client and task manager, such as Fair, |
| | Isaac, Inc. |
| | Strategy Modeling Team: heavy |
| | participation. |
| Data Transformation | Analyst functionality and that of |
| and Cleansing | counterpart on client side: expertise in |
| | software and hardware infrastructure of |
| | client and task manager, such as Fair, |
| | Isaac, Inc. |
| | Strategy Modeling Team: heavy |
| | participation. |
| Decision Key and | Lead Consultantship: expertise in |
| Intermediate Variable | stimulating creativity, capturing business |
| Creation | process, creating variables, and decision |
| | analysis. |
| | Strategy Modeling Team: full |
| | participation. |
| Data Exploration | Strategy Modeling Team: provides |
| | guidance using business judgment. |
| | Consultantship: skill in methods and tools |
| | of data exploration; aptitude for |
| | understanding the business process. |
| Decision Model | Lead Consultantship: expertise in decision |
| Structuring | analysis and modeling value and |
| | uncertainty. |
| | Strategy Modeling Team: provides |
| | business expertise. |
| Decision Model | Consultantship and counterpart from the |
| Quantification | client: expertise in predictive modeling |
| | and its application to the business process. |
| Strategy Creation | Strategy Modeling Team: participation |
| | including Analyst expertise in Strategy |
| | Optimizer. |
| | Lead Consultantship: expertise in strategy |
| | creation and active data collection. |
| Strategy Testing | Strategy Modeling Team: must perform |
| | analysis and buy into results. |
| | Lead Consultantship: expertise in |
| | statistical methodologies. |

In the preferred embodiment of the invention, the client in general is involved in great detail at the start of a project, in framing the decision, and in setting the direction for subsequent analysis and development. Later processes require more involvement of analytical skills, such as for example those of a task manager's internal analytical skills, in developing the predictive models and creating the strategies.

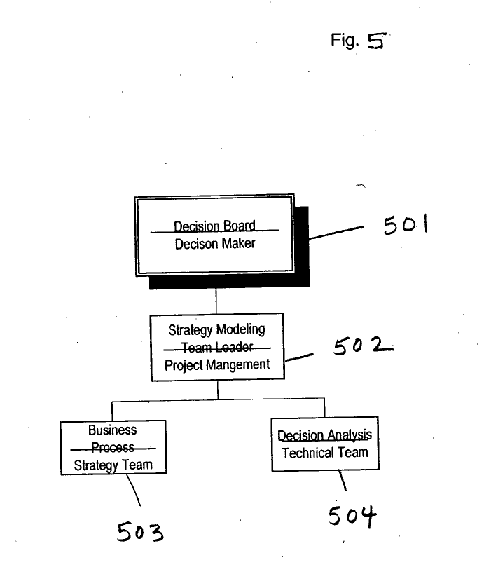

FIG. 5 is a schematic diagram of the general structure of project organization according to the preferred embodiment of the invention. The decision board 501, sometimes consisting of a single Decision-Maker, has the authority to implement the strategy to be selected. Task manager executives provide the primary interface with the decision board 501, where the task manager provides expert knowledge about the strategy modeling process and sub-processes (modules). The strategy modeling team provides analysis. Such team represents client's organization as well as the task manager's consultants. The strategy modeling team also can be subdivided into a project management team 502, a business process strategy team 503, and a technical team 504.

Example

For illustrating the important concepts of the strategy modeling process, an example is interwoven through the sub-sections that describes the strategy modeling process and sub-processes in detail.

It should be appreciated that the example includes a fictitious relationship with a retail company, where the sales process and the process of the engagements are often quite fluid. This example outlines one path through this process.

“RRR Retail” is a large retail store that communicates with its customers via multiple channels. In a meeting including representatives from professional services and a strategy modeling process champion within the organization, the champion is encouraged to begin thinking about all of the business processes where the strategy modeling process has the potential to add significant value. The meeting results in the discussion of business processes that could potentially be improved, including, for example: customer acquisition, credit scoring, credit line management, and marketing response. In this particular example, the champion is confident that the greatest return on investment (ROI) comes from addressing marketing response. Currently, all customers receive every offer, every month, through both email and mail. The President and Vice President of Marketing have recognized that this may be terribly wasteful given the large degree of variance in the response rate and amount of response across customers. For instance, many customers only respond to one offer per year and when they do purchase, they purchase only one inexpensive item. Clearly, it is not necessary to send offers through all channels to this type of customer every month. The Vice President expects that the ROI will be of an order of magnitude more from addressing these issues. Given this scenario, it is not necessary in this particular example to sell the organization a separate project that evaluates which business process(s) to address first.

The sales team of the professional services organization proposes a project to address the decision situation in marketing response. They also propose that the project be divided into multiple phases; each phase requiring a different contract. This division allows the client organization a better understanding of scope, and allows the client organization to adopt new infrastructures and strategies incrementally. Such sales team believes that this incremental approach to adopting a business process is more palatable to the project champion and the organization. It should be appreciated that the strategy modeling process typically is adopted by organizations incrementally. That is, it is likely that the client organization wants to try a pilot project to address a problem where value obviously can be added by the strategy modeling process. It is also likely that the client organization is conservative in the adoption of new infrastructure and strategies. With successful completion of each phase, the client organization typically is willing to consider strategies that differ more significantly from the status quo, as well as more aggressive changes to infrastructure and staffing.

In this example, a contract is signed for Phase 0. The goals of Phase 0 are to understand the marketing response business process, develop a detailed plan for Phase 1, and a high-level plan for additional phases. In this case, a decision dialog process, identification of teams and timeline, identification of issues, and development of a decision hierarchy are introduced. The outputs of such procedures are subsequently used to define the scope, budget, and timeline proposed in the contract for Phase 1. Such activities are discussed in the Team Development and Strategy Situation Analysis sections herein below.

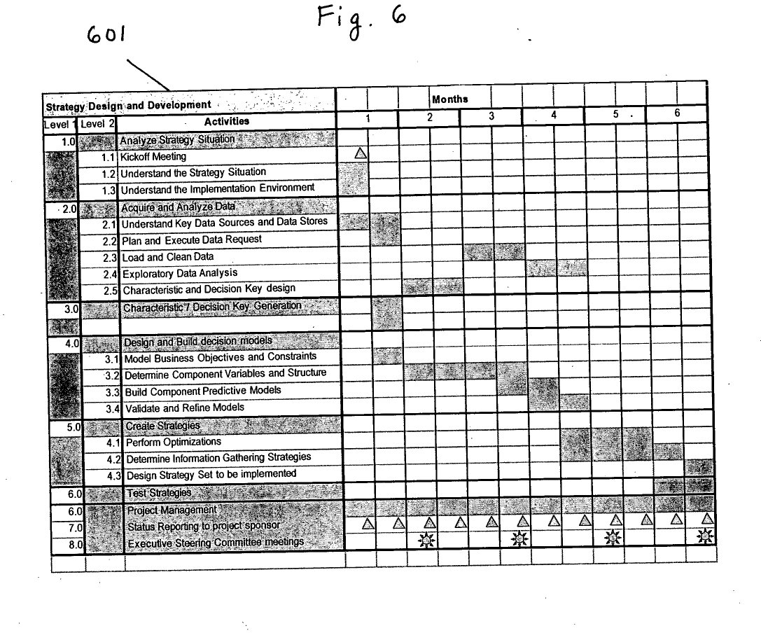

FIG. 6 is an example project plan 601 for Phases 0 and 1 of the current example.

Table C below lists outputs of the strategy modeling process and apparatus for a given project according to the example.

TABLE C

| Modules | Outputs |
|---|---|
| Team Development | Team Rosters |
| Strategy Situation | A Decision Hierarchy that describes the |
| Analysis | Frame of project. |
| Data Request and | A communication reporting the status of |
| Reception | the data request. |
| Data Transformation | A report on the cleaned data set. |
| and Cleansing | |
| Decision Key and | A list of candidate variables for decision |
| Intermediate | modeling; and |
| Variable Creation | A list of the variables that affect value |
| | directly. |
| Data Exploration | A report regarding the usefulness of |
| | Decision Keys for predicting value |
| | drivers; and |
| | A report about general insights gained |
| | about the business process. |
| Decision Model | A report on the structure of the decision |
| Structuring | model. |
| Decision Model | A report summarizing the assumptions |
| Quantification | made during modeling as well as a |
| | description of the decision model. |
| Strategy Creation | A report discussing the strategies |
| | considered and assumptions made. |
| Strategy Testing | A report that compares the candidate |
| | strategies and argues for the deployment |
| | of the best one. |

### Team Development

The team development sub-process is a task of strategy modeling. According to the preferred embodiment of the invention, a team is developed to ensure the strategy modeling task is performed. It should be appreciated that a group of persons (a team), software modules, and a hardware apparatus could perform the functionality of the team development sub-process described below. Various implementations are within scope of the invention. It should be appreciated that when the team development discussion refers to activities by persons, the functionality taking place within those activities can be performed by a method and apparatus.

The team development sub-process provides an opportunity for understanding the dynamics of the client organization with respect to the Decision-Maker. Given knowledge of the paths of influence to the Decision-Maker as input aids in avoiding roadblocks and streamlining the adaptation of strategy science methodology by an enterprise.

Inputs

In the preferred embodiment of the invention, input data includes information representing a client's business and the problem to be addressed with respect to the client's business.

Outputs

The preferred embodiment of the invention provides output in the form of a list or roster, of participating components, where a component can be a human being. A participating component analyzes the strategy situation, has information about the dynamics of the members of such list or roster, and has an assessment of the quality of the business process in question.

Procedure

The preferred embodiment of the invention provides conversation topic mechanisms for exchange of information. The conversation topics that are directly relevant to preparing for analyzing the strategy situation are: Team, Team Dynamics, Timeline, and Introduce Decision Quality. These are detailed below.

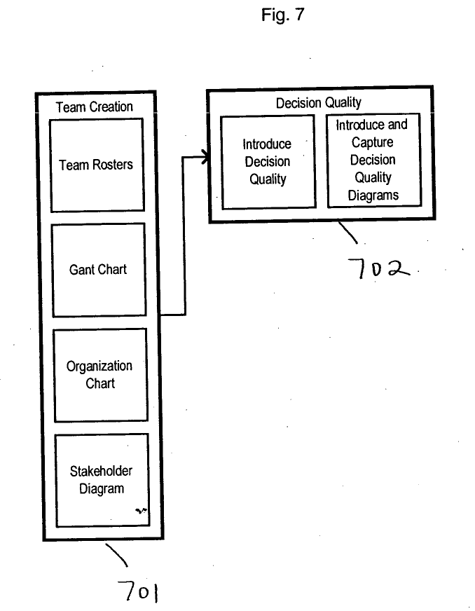

FIG. 7 shows a block diagram of the relationship of a Team Creation component 701 and a Decision Quality component 702 according to the invention.

Team Creation

In the preferred embodiment of the invention, a team for interacting during the strategy modeling process is developed. The team includes a Strategy Modeling sub-team and a Decision Board. The Decision Board oversees the strategy modeling process and the Strategy Modeling Team that works closely with consultant entities provided by the task manager on analysis. Members of the Decision Board have authority to make decisions and see to resource allocation. The Strategy Modeling Team consists of a consulting entity plus any other entities whose inputs and analysis are critical to getting the right information into the decision process. A Decision Dialog process is provided that serves as a prototype for the interaction between these two teams. The Strategy Modeling Team, Decision Board, and a timeline can be discussed together in one conversation with a sponsor entity of the project provided by the task manager. A useful tool for facilitating discussions about timelines is the Gantt Chart.

Also, in the preferred embodiment of the invention, such conversation presents an opportunity to gain insight into the dynamics of the organization and the influences exerted on member entities of the Decision Board. An Organizational Chart and Stakeholder Diagram are useful tools, and are described in the Tools section below.

Introduce Decision Quality

One equally preferred embodiment of the invention provides a conversation topic on Decision Quality. A Decision Quality process enables an organization to systematically identify, understand, and track all views of the quality of the decision-making process. Frame is a dimension of Decision Quality and a conversation about Decision Quality can also put the importance of having an appropriate Frame in context. See Tools section below.

Tools

The following tools are provided in the preferred embodiment of the invention. It should be appreciated that a user has discretion over which tools to use, according to the particular implementation of the invention for the user's particular needs.

Team Rosters

A clear understanding of the ideal properties of each team is the best tool for identifying members and assigning them to the rosters.

Gantt Chart

A standard Gantt Chart.

Organizational Chart

A standard organizational chart and a document with the address, email, office phone, home phone, and fax number for team members entities is created by a member of the client organization, preferably designated by the head of the Strategy Modeling Team.

Stakeholder Diagram

The stakeholder diagram is a tool for understanding what influences the Decision-Maker and the motivations behind such influences. Understanding goals, motivations, and paths of influence among team member entities is useful for sighting and removing potential roadblocks to adopting new strategies.

Stakeholders are motivated by their goals. Personal goals tend to be the strongest predictors of behavior. Some examples of such goals are financial security, complete personal life, fame, and notoriety. Practical goals are goals that must be accomplished to meet personal goals. Note that goals are not tasks as goals are “the ends” and tasks are “the means to the end.” Some examples of practical goals are saving time, saving effort, reducing mistakes, and reducing personal risk. Organizational goals are accomplished for the sake of the organization, but do not necessarily match personal goals. Some examples of organizational goals are becoming a market leader and exceeding analyst's forecasts.

The stakeholder diagram is analogous to the organizational chart and is preferably developed in the context of designing and selling software. In an organizational chart, arcs encode reporting relationships. In a stakeholder diagram, arcs represent a path of influence to the Decision-Maker. A stakeholder diagram includes all entities that have the potential to influence the Decision-Maker, not just those entities in the organization. Just as members in an organizational chart are given titles, members in a stakeholder diagram are given roles that describe their potential to influence the Decision-Maker.

Members in a stakeholder diagram:
Allies are those entities that have influence and stand to gain or lose depending on which alternative is selected;
Potential allies are also included;
Sponsors also have influence, but do NOT stand to gain or lose;
The Decision-Maker; and
Users that work with the alternative once it is selected.

The diagram is annotated with the goals of each stakeholder.

After only a few interactions or meetings with a client, the amount of information available to construct a stakeholder diagram may be rather limited for the client's needs. Therefore, engage a head member of the Strategy Modeling Team, where the head member is the most knowledgeable entity about the roles of the members in his/her organization. Discuss afterwards with any consultant entities provided by the task manager for learning about prior experience from working with that client before. Such tool is adaptable by incorporating developed names for roles that are more specific to each type of consulting engagement.

Decision Quality Chain

Decision quality is measured as a function of the decision-making process and not as a function of outcomes realized after making a decision. This is because uncertainty inherent in the world can result in a bad outcome even when a very high-quality decision-making process is followed. For example, hours could be spent on researching airline safety statistics, gathering information from mechanics, and interviewing pilots to select the safest aircraft, with the safest airline, at the airport with the best security. If the plane crashes, then such outcome would be bad. However, in this case, the decision or the process by which the decision was made is not at fault.

The decision quality chain is a tool that empowers users to think about decision quality in terms of process instead of in terms of outcomes.

An Exemplary Decision Quality Chain

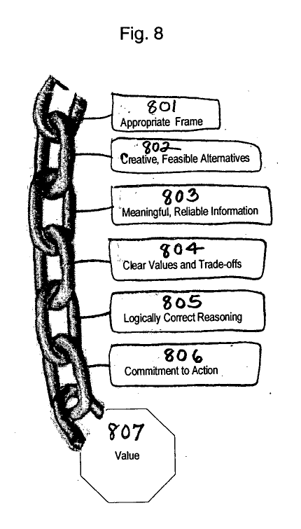

To this end, David and Jim Matheson pose the following question to people at all levels of organizations throughout the world, “Given this scenario, what questions would you want answered before you felt confident that you could make a good decision?” They find that this question and its answers define six dimensions of decision quality. Refer to FIG. 8 which shows these six dimensions associated with links in the decision quality chain:
Appropriate Frame 801;
Creative-Feasible Alternatives 802;
Meaningful-Reliable Information 803;
Clear Values and Tradeoffs 804;
Logically-Correct Reasoning 805; and
Commitment to Action 806.

It should be appreciated that the chain supports an organization's value 807. It is important to note that value hanging from a chain that is only as strong as the weakest link.

According to the preferred embodiment of the invention, the decision frame is the first link. It is the frame chosen by the Decision-Maker and colleague-members on the Decision Board. The frame defines the window through which the decision situation is viewed. The decision frame is the most elusive of the six dimensions. Yet, if not paid enough attention, the project runs the risk of finding the right solution to the wrong problem. A decision only exists if there are alternatives among which to choose. Developing new, creative, and feasible alternatives taps into “the greatest source of potential value . . . ” Meaningful and reliable information is desirable in any decision situation. Measuring the value of alternatives and making tradeoffs between different value metrics is essential. Put another way, Stephen R. Covey says that highly effective people make a habit of beginning with the end in mind. Logically-correct reasoning welds together all of the preceding links by taking their input data and from that data determining which alternative holds the most value. That is, “Does the modeling identify the ‘best’ alternative?” It is essential that a decision be executed wholeheartedly by the organization. This requires organizational commitment, that in part comes from strength in the first five links and in part from effectively communicating about the decision to all those involved.

The chain of decision quality can be used as a productive tool in the decision process in two ways. One, during the analysis, the tool facilitates discussion about quality and illuminates the dimensions of the decision that need work. Two, looking across many decisions, this tool is used to develop a benchmark to gage future decisions.

Decision Quality Diagram

The decision quality chain is used to facilitate discussion about the quality of the decision and to benchmark decisions. The decision quality diagram is analogous to the chain and aids the Decision-Maker and advising entities to the Decision-Maker by graphically representing the strength of each link. The diagram is used during the engagement to track progress and identify weakest links for further work. It also can be used to identify contrasting views of the quality of the decision across the team members entities.

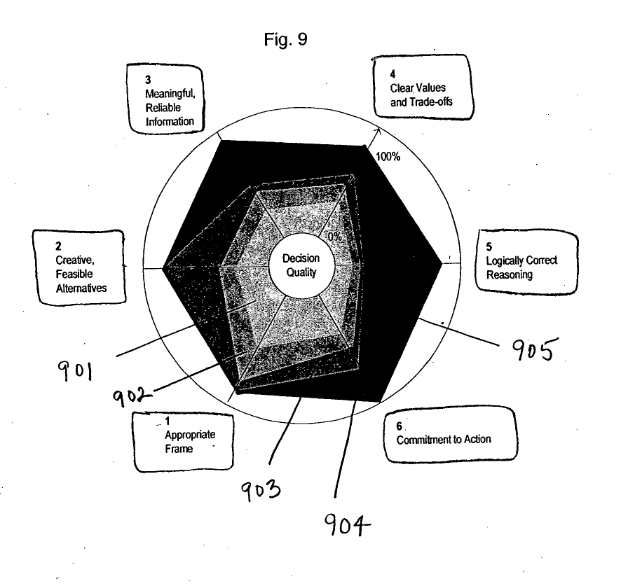

Refer to FIG. 9 which shows a decision quality diagram according to the invention. The figure shows the iterative use of the decision quality diagram. FIG. 9 illustrates the following example dimensions: Initial Assessment 901; Identify Issues and Decision Hierarchy 902; Alternatives Creation 903; Value Metrics 904; and Variable Creation and Decision Modeling 905. Each dimension is represented at a corner of the spider web. For each dimension, the user rates the quality from 0% to 100% by marking a point between the center of the web and the corresponding dimension on the perimeter. 100% decision quality on a dimension is defined as the point at which additional improvement efforts for that dimension would not be worth their cost. The points are then connected to each other to form an inner region. It should be appreciated that the Decision-Maker and decision advising entities may have different diagrams. Further discussion about the quality of the decision is warranted at any element in the analysis if the diagrams are vastly inconsistent for that element across participants.

When the Decision Board is satisfied that the chain is of sufficient strength, the process is complete, and resources are allocated to begin implementing the decision(s).

Resources

Typically, a project champion from the client organization, for example, who signed the contract, and a lead consulting entity provided by the task manager work together to select the members of the Strategy Modeling Team. The lead consultant contributes expertise in the Strategy Modeling process, excellent project management abilities, and knowledge of the skills and abilities of the pool of talent available to staff the project. The project champion brings knowledge of the business process that is being examined, as well as authority and knowledge required to draw talent from the enterprise. If decision quality is discussed, then the consultant is preferably a master of group facilitation and an expert in the tools of decision analysis.

Improvement

The methodology and tools for Team Development are generic with respect to the type of business process being addressed. While they can be applied in their generic form during any strategy consulting engagement, creating a problem-specific instantiation is often beneficial. For example, the Decision-Quality Chain and Diagram can be adapted to track the improvement of lower-level activities, such as predictive modeling. Examples of dimensions to track in this case include Data Integrity, Variable Creation, Modeling Iterations, Model Quality, and the like. Stakeholder Diagrams and Organizational Charts can also be specialized for a particular business process. In particular, the roles and paths of influence often take on patterns when examined across similar consulting projects. Such learning is captured so that the use of specialized versions is repeatable.

Deliverables

In one preferred embodiment of the invention, a deliverable is a roster for the Strategy Modeling Team.

### Strategy Situation Analysis

According to the preferred embodiment of the invention, with the Strategy Modeling Team described above formed, Strategy Situation Analysis helps the team to define the right problem to address. This section describes the conversation topics that are used to frame a decision situation according to the invention. It should be appreciated that many of the topics and tools described below are also useful for selling and scoping an engagement. Scoping and framing differ primarily in the level of resolution that is achieved on each topic. Determining the correct level of resolution in scoping can be viewed as an art.

Inputs

In the preferred embodiment of the invention, input data includes a documented understanding of the client's business and the problem to be addressed, preferably as defined in the task manager's proprietary Consulting Methodology.

Outputs

The preferred embodiment of the invention provides output in the form of a frame for the decision situation, defined in terms of a decision hierarchy, alternative strategies, and alternatives for each decision that is made by the selected strategy. The status quo strategy is preferably used as a benchmark.

Procedure

The preferred embodiment of the invention provides the following procedure for strategy situation analysis. In one embodiment of the invention, conversation topics are related to one another through a subsection of the Decision Dialog process. Recall that the Decision Dialog process expands beyond analyzing a strategy situation.

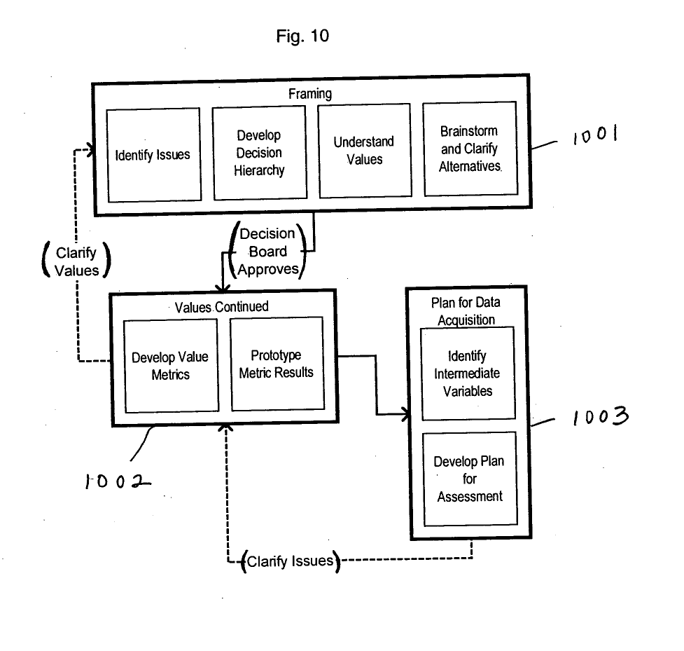

Conversation topics directly relevant to establishing a solid Frame for viewing the decision situation are: Identify Issues, Develop Decision Hierarchy, Develop Value Metrics, Brainstorm Alternatives, and optionally, Identify Uncertainties. Each topic is discussed in detail below. Such topics are shown in the FIG. 10, where FIG. 10 is a schematic diagram of strategy situation analysis according to the invention. FIG. 10 illustrates the iterative process between framing the problem 1001 to developing value metrics and prototyping metric results 1002, and between developing value metrics and prototyping metric results 1002 and planning for data acquisition 1003.

Identify Issues

It can be helpful to have a conversation about all of the business issues involved with the decision situation. The preferred embodiment of the invention provides a conversation that is structured around exploring, understanding, and categorizing issues into: Decisions, Uncertainties, Constraints, Values, and Other. Facilitating such a discussion offers the opportunity to help the organization internalize a structure for separating issues that are fundamental to Framing and the decision-analysis paradigm. Specifically, the conversation topic gives the organization the opportunity to identify decisions that become the heart of the Frame. In addition, this topic provides an excellent opportunity for the consulting entities to identify members of the team who may have hidden agendas. It should be made clear by the facilitator that this is the time to let it be known if there are political or other constraints that may impact the successful completion of the project. The preferred tool to use is sticky-notes.

Develop Decision Hierarchy

Facilitating a conversation that results in the sorting of decisions into a hierarchy is critical for developing the Frame and verifying the scope. Such discussion also provides key information about decisions and constraints that are addressed when decision models are constructed. The Decision Hierarchy is a tool for facilitating discussions about scope and reaching agreement. Applied to a given decision situation, Decision Hierarchy separates that which is given or is out of scope (policy), that which is to be decided now or is in scope (strategy), and that which is to be decided later (tactical).

Two types of decisions are considered on a project. Macro-decisions are one type that select among alternative strategies. The best strategy is then used to make micro-decisions for each case in the data set. Micro-decisions that are in scope become the decisions that are encoded in the decision model. The macro-decision that is in scope is always the selection among alternative strategies. Some decisions that are out of scope become constraint(s) and associated thresholds that are encoded in the decision model. Sensitivity analysis is performed to assess the cost of making policy decisions. Such analysis provides insight into how “sister” business processes are constraining the value of the process in question.

Invariably, the discussion tends to be too policy-focused or too tactically-focused. That is to say that the Strategy Modeling Team members may want to exclude too many decisions as policy or include too many decisions that are tactical. The challenge in successfully facilitating this conversation with the Strategy Modeling Team is to articulate and then critically evaluate the constraints that define the way the team groups the decisions.

A similar challenge faces with the Decision Board. The key to facilitating a review meeting with the Decision Board is helping members of the Decision Board understand why decisions are grouped the way that they are. Such understanding ensures that the Strategy Modeling Team has not over constrained, i.e. too many in policy category, or under constrained, i.e. not enough in policy, the decisions. See Decision Hierarchy in the Tools section below.

Brainstorm and Clarify Alternatives

In the preferred embodiment of the invention, another key component to the Frame is alternatives. The conversation topic on alternatives is possibly the most important of all, because value of strategies is limited by available alternatives. Too often, conversations about alternatives become constrained and center on the status quo. It is important to facilitate these conversations in a way that encourages a search for “out-of-the-box” alternatives that address the key issues.

The preferred embodiment provides using Back Casting as a tool. It is preferable to keep feasibility of modeling out of the conversation as much as possible. Discuss implementation as necessary to carefully define each alternative's potential costs and benefits. Costs and benefits are not assessed at this time. It is preferable also to try to ensure that the alternatives are as mutually exclusive and collectively exhaustive as possible. The conversation about alternatives needs to include micro and macro alternatives. For the macro-alternatives, the current strategy as well as others of interest to the client are captured for benchmarking. Such exploration includes a thorough exploration of alternatives for each decision, as well as definitions for each alternative with sufficient detail to allow the alternatives to be compared based on a value metric selected in another conversation described herein below.

The Alternative Table is another useful tool for facilitating the discussion on alternatives when an exhaustive combination of all alternatives for each decision cannot be reasonably evaluated.

Develop Value Metrics

The preferred embodiment of the invention provides a value and risk metrics conversation topic related to developing the Frame. This topic is broken into two parts. First, a value measure is defined before generating alternatives. A value measure is what the client wants more/less of, such as for example profit, revenue, market share, and customer satisfaction, etc. Tradeoffs are specified when multiple value measures are used. Second, the topic of value is revisited after the alternatives are generated. The revisit contributes to developing a level of resolution on the value measure that is required for analysts to compute the value measure and to rank the alternatives. The Strategy Modeling Team establishes a template for the results that they believe are sufficient to convince the Decision Board that the best alternative is truly the best.

Conversations surrounding this topic also offer an opportunity to discuss the concept of risk. The Strategy Modeling team needs to have the right tools to understand the degree to which uncertainty reduces the perceived value of an alternative. According to the preferred embodiment of the invention, if appropriate, the company's risk tolerance is determined.

Identify Intermediate Variables and Decision Keys: Develop Plan for Assessment

The preferred embodiment of the invention provides a final conversation topic that is indirectly related to Framing. When analyzing the strategy situation it may be appropriate to have a conversation about the degree to which uncertainty can reduce the value of the alternatives. It should be appreciated that uncertainty is often a central concern when thinking about alternative strategies and values. For example, the status quo strategy may consider uncertainties, either assessed by experts or parameterized from data, e.g. Intermediate Variables or Decision Keys. Using the Decision Model as a tool during this conversation can help clarify the status quo. An opportunity may be available to gather high-level information about how extensively uncertainty needs to be modeled to identify the best alternative.

In one embodiment of the invention, a prototype of the decision diagram is used as a tool for demonstrating how uncertainties and decisions drive value. It is not necessary to accurately model interactions among uncertainties in this conversation.

Only the structure is drawn, no parameters are assessed. As the data is explored and modeled this “prior” decision diagram is completed in a later sub-process to reflect a refined understanding of how uncertainties interact.

Tools

The following tools are provided in the preferred embodiment of the invention. It should be appreciated that a user has discretion over which tools to use, according to the particular implementation of the invention for the user's particular needs.

Sticky-Notes

Sticky-notes that are large enough to fit 5-10 words and are large enough to read if placed on a wall or whiteboard. Hexagonal notes are best for sorting and grouping ideas together.

Decision Hierarchy

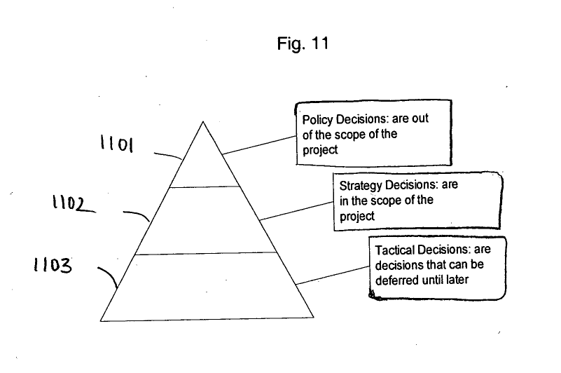

Refer to FIG. 11 which shows a diagram of a decision hierarchy applied to a given decision situation separating that which is given or out of scope (policy) 1101, that which is to be decided now or is in scope (strategy) 1102, and that which is to be decided later (tactical) 1103.

Each member of the Strategy Modeling Team and the Decision Board thinks about the decision hierarchy in a different way. The hierarchy can then be used a conversational tool to help the Decision-Maker integrate the unique structure and perspective on the strategic decision that each team member contributes into the Decision-Maker's natural decision processing mechanism.

The Decision-Maker and the Decision Board set policy agenda before the modeling takes place. The team takes the policy as a given. They may then discuss strategic decisions without getting stuck on tactical decisions that can be delegated or decided at a later date or time.

It has been found that some people strongly object to the idea of “tactical” decisions. For them, the strategy is not sufficiently defined unless all of the decisions necessary to implement it have been spelled out. If this happens, it is useful to ask “if I move that decision into Strategy, are my alternatives significantly different or do I have to do something similar here no matter what other Strategy decisions I choose?”

Alternatives Table and Strategy Descriptions

An alternatives table is provided with decisions across the rows and alternatives down the columns. A path across the rows of the table defines a meta-alternative, i.e. one alternative selected for each decision. It is common that not all paths are feasible.

Back-Casting

A Back-casting technique is provided. For example, Back-Casting provides an answer to the following question, “What if I were to tell you that it is now N years down the road, and Company Y has increased market share by 80% as a result of our project. What did we recommend to the Decision Board?”

The Decision Model

The decision model integrates work done on the first four links of the decision quality chain and assists with strategic decisions. Typically, knowledge is represented in the form of a directed graph, knowledge maps, concept maps, brain storming diagrams, relevance diagrams, etc. All of these tools have a shortcoming; they do not directly address the decision and an associated value measure. The decision diagram represents the relationships among decisions, values and uncertainties. Once these relationships are depicted, decision theory provides solid tools for logically correct reasoning. Logically correct reasoning allows the Decision-Maker to select the alternative or action that is best given the available information.

This tool is also useful for ensuring that the Decision Board is satisfied with method of assessment that is selected for uncertainties, whether they are modeled from data or assessed by subject matter experts.

Resources

Typically, the entire Strategy Modeling Team participates in Strategy Situation Analysis. Recall that the Decision-Maker is preferably not part of this team. The lead consultant is therefore an expert in group facilitation with respect to the tools and techniques required for Framing. Specifically, the lead has full command of fundamentals of Framing, has contributed to improving or developing Framing methodology, and has gained humility through pushing framing techniques to new frontiers with success and failure. The consultant or analyst preferably has an understanding of the fundamentals so that is able to assist the lead. The remainder of the Strategy Modeling Team only needs expertise with respect to the enterprise and the business process being addressed.

Improvement

The procedure for Strategy Situation Analysis is derived from methods used in decision analysis consulting firms. These firms typically spend six months to two years modeling a single critical decision with stakes in the hundreds of millions of dollars. An example of such an engagement is helping a pharmaceutical firm decide whether to take a candidate cancer drug through the next FDA approval stages. Because such techniques are subsequently applied to a wide variety of consulting projects, these tools and techniques described herein are adapted in practice to the scale of the engagement. These adaptations are preferably documented and, as the process is repeated, such documentation ensures that strategy situation analysis is measurable and can be optimized.

Deliverables

The preferred embodiment of the invention provides information, preferably a document, describing alternative framings of the decision and the frame that was agreed upon by the team.

An Exemplary Means for Quantifying the Objective Function

Recall from the Glossary that a decision model is a mathematical description of a decision situation that includes decision variables (representing the course of action), decision key variables (representing the known characteristics of a case), value variables (representing the objective function to be maximized), and constraints (representing limits on the set of acceptable strategies). The preferred embodiment of the invention provides an exemplary means for quantifying the objective function for the decision model.

The preferred embodiment of the invention obtains specific data from the user and applies that data as input into deriving an objective function. Specifically, the obtained data from the user is taken from a questionnaire given to the user.

Example Questionnaire

Table D is an example questionnaire from which data is obtained from users according to the invention.

### Table D

### Questionnaire About Portfolio Performance Goals

Your profit and losses goals for your credit card portfolio for next year are the information that should guide your operating strategies. The goals specify where you want to go and the resultant policies are intended to do the best job of trying to get there. However, there are always uncertainties about the market and economic climate. This causes uncertainties about the exact performance of any operating strategy. Hence, there is no guarantee that your goals will be achieved even though you make smart consistent decisions. Quite simply, if a goal is set to increase profits ten-fold next year, there is some chance that that goal will not be met.
This questionnaire is to obtain information to help quantify your objectives for evaluating different strategies to manage your portfolio. It addresses the way your institution wants to balance profits and losses and the appropriate attitudes towards risk.
Please fill out this questionnaire after thinking carefully about your responses.

Answer in terms of what is best from your institution's perspective. You may find it useful, as well as insightful and interesting, to discuss your responses with other members of your portfolio team before providing final responses. Your responses are obviously important as the policies we will suggest will be designed to bet meet your stated goals.
If you have any questions about any aspects of this questionnaire, please feel free to call ______ at (415)______ at your convenience.
For administering this questionnaire, comments on each question were added in italics following the question. They indicate why the question is asked and sometimes give suggestions for how to proceed in cases that appear somewhat out of the ordinary or that are particularly difficult.
1. For your credit card portfolio, answer the following with the most recent information available.
   a. Number of accounts: ______
   b. Annual receivables: $______
   c. Annual profit: $______ (this is called P_{O})
   d. Annual losses: $______ (this is called L_{O})
   e. Total exposure: $______ (this is called E_{O})
The purpose of question 1 is to establish the financial portfolio being evaluated. It is obviously an easy question and allows the participant to readily answer and hopefully get into the swing of things. Also, the responses P₀, L₀, and E₀ are used in subsequent questions.
2. How would you characterize your institution's attitude towards accepting risks to increase profits for your financial portfolio? Circle the appropriate risk attitude:
   a. Conservative b. Moderate c. Aggressive
The purpose of question 2 is to ask about the institution's risk attitude in the way that portfolio managers might customarily view it. It should be easy to answer. It will also be interesting to correlate these responses to the quantitative characterization of the institution's risk attitudes for the portfolio that are assessed in questions 7-10.
3. What is your profit goal for the coming year: $______ (this is called P₁)
The purpose of question 3 is to establish the profit goal. In many cases, this might be clearly stated. In others, where the portfolio managers are particularly concerned about losses and some other aspects of the portfolio, it may be useful to help the respondent identify a level of profit that they would be quite happy with for the next year. The answer to this question need not be a level of profit that is established by a policy of the organization.

4. Suppose that next year you exactly meet your profit goal but annual losses also increase to an amount L. For different amounts of L in the list below, which do you prefer to a stable performance (i.e. next year's performance equals this year's performance) or are they equally desirable. Check the appropriate column. Note that the notation (P,L) below means next year's profits are P and losses are L. Fill in the profit and loss amounts for your portfolio in the first two columns of the table below and then check the preferred performance or if they are equally desirable.

| Next Year's Portfolio Performance | | | | |
|---|---|---|---|---|
| | | Prefer | | Prefer |
| Changed | Stable | Changed | Equally | Stable |
| Performance | Performance | Performance | Desirable | Performance |
| (P₁, L₀) = ($ , $ ) | (P₀, L₀) = ($ , $ ) | | | |
| (P₁, 1.2 L₀) = ($ , $ ) | (P₀, L₀) = ($ , $ ) | | | |
| (P₁, 1.4 L₀) = ($ , $ ) | (P₀, L₀) = ($ , $ ) | | | |
| (P₁, 1.6 L₀) = ($ , $ ) | (P₀, L₀) = ($ , $ ) | | | |
| (P₁, 1.8 L₀) = ($ , $ ) | (P₀, L₀) = ($ , $ ) | | | |
| (P₁, 2 L₀) = ($ , $ ) | (P₀, L₀) = ($ , $ ) | | | |

The purpose of question 4 is to begin to get the individual to think about the tradeoffs between profits and losses. The range of comparisons between the first two columns should always result in a preference to change performance on the first row and a preference for stable performance on the last row. Then, somewhere between these two rows, there would have to be a crossover level of losses that would make the consequences in the first two columns equally desirable. It need not be the case that one of these particular rows has the property where the consequences in the two columns are exactly equally desirable. Question 5 addresses this.
5. Suppose that next year you exactly meet your profit goal but your annual losses also increase to L₁. What is the amount L₁ such that the following two descriptions of next year's portfolio performance are indifferent:
   Case A: Next year's profit equals this year's annual profit (i.e. P₀) and next year's losses equal this year's annual losses (i.e. L₀).
   Case B: Next year's profit equals your goal (i.e. P₁) and next year's losses increase to L₁.
   What is L₁? $______
The purpose of question 5 is to find the level of this year's losses (called L₁) such that one is indifferent between increasing losses from last year's level to this year's level if the corresponding jump in profits from last year's level to this year's goal (which is response P₁ in question 3) occurs. Essentially, this question pushes the individual to find the “equally desirable” consequence corresponding to question 4. One can check this response because it should be either the same as the one row checked “equally desirable” in question 4, or the level of losses should be between those where preferences switch from “prefer change performance” to “prefer stable performance” in question 4.
   6. What is the maximum amount of losses, call it L₂, that you would accept for next year if you knew your profits would increase to your goal P₁? What is L₂? $______
   The purpose of question 6 is to ask for the same response as question 5 in a different manner. Essentially, as one keeps increasing the level of losses, the consequences become less desirable when profits are fixed. The maximum amount one should accept is where one is indifferent to the profits and losses of last year. If the responses to questions 6 and 5 are different, then it would be useful to point this out to the individual and have them rethink through the tradeoff issue. They should be able to resolve the stated differences, and end up with a common response to both questions 5 and 6. A consistency check like this is important because the appropriate tradeoff between profits and losses is one of the critical inputs to a useful objective function.
   7. Because of uncertainty, we want to quantify your institution's risk attitude with respect to next year's profit. Consider the range of profit from 50% of your goal to 150% of your goal. Now suppose that you had two policies, C and D, to chose between: policy C is much less risky than policy D, but policy D may be worth the risk. They produce the following profits:
   Policy C: Next year's profit will be an amount P.
   Policy D: Next year's profit has a one-half chance of being 150% of your profit goal P₁ and a one-half chance of being 50% of your profit goal.
   In pictures, the choice is:

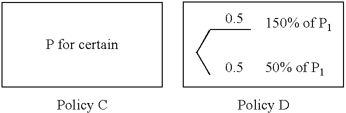

Fill in the profit amounts in the first three columns of the table below and then check the preferred policy or if they are equally desirable (i.e. indifferent) for your institution.

| | 150% | 50% | Preferred Policy | | |
|---|---|---|---|---|---|
| P | of P₁ | of P₁ | Policy C | Policy D | Indifferent |
| 1.4P₁ = | | | | | |
| 1.3P₁ = | | | | | |
| 1.2P₁ = | | | | | |
| 1.1P₁ = | | | | | |
| 1.0P₁ = | | | | | |
| 0.9P₁ = | | | | | |
| 0.8P₁ = | | | | | |
| 0.7P₁ = | | | | | |
| 0.6P₁ = | | | | | |

The purpose of question 7 is to begin to assess the utility function for profits over the range where profits would likely occur. The table asks a number of questions that should be easy, namely those at the top and bottom, and harder ones in the middle. At the top of the table, one would expect a preference for policy C and that this would switch to a preference for policy D at the end of the table. As with the earlier question 4, somewhere in between the switch from policy C to policy D, there must be an indifference point. It need not be one of the levels of profits indicated in the first column of question 7, but it could be. Essentially, question 7 is to help provide a basis for zeroing in on the indifference points in question 8.
8. For what amount of P, call it P_{N}, in the pictures above do you find policies C and D equally desirable for your institution? P_{N}=$______
The purpose of question 8 is to specify the level of profits for policy C that is indifferent to policy D. This level is technically referred to as the certainty equivalent for the lottery in policy D. The utility of the certainty equivalent is set equal to the expected utility of the lottery. Hence, if we assign a utility of 100 to the greatest profit (i.e. 150% of P₁) and a utility of 0 to the least profit (i.e. 50% of P₁), then the utility assigned to the certainty equivalent P_{N} should be 50. Knowing these three points, we can get a reasonable utility curve that quantifies the risk attitude for profits of a portfolio.
Because of bonuses or reward structures related to meeting a specific goal, the respondent may want to have an S-shaped utility function that becomes quite steep near the goal. At the extreme, anything above the goal means bonuses will be paid and the respondent might be equally as happy. Anything below the goal means bonuses will not be paid and other bad events may happen, and so these consequences may roughly be equally desirable. To try to avoid specifying such a utility function that is not in the best interest of the institution, the questions always stress that the responses should be from the perspective of what is best for the institution, meaning not necessarily what is best for the individual in the institution.
9. Consider the range of losses from 25% less than your response L₂ in question 6 to 25% above that level. Now suppose that you have two policies, X and Y, to choose between: policy X is much less risky than policy Y, but policy Y may be worth the risk. They result in the following losses:
   Policy X: Next year's losses will be an amount L.
   Policy Y: Next year's losses have a one-half chance of being 25% less than L₂ and a one-half chance of being 25% greater than L₂.
   In pictures, the choice is:

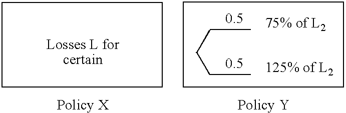

Fill in the loss amounts in the first three columns of the table below and then check the preferred policy or if they are equally preferred (i.e. indifferent) for your institution.

| | 75% | 125% | Preferred Policy | | |
|---|---|---|---|---|---|
| L | of L₂ | of L₂ | Policy X | Policy Y | Indifferent |
| 0.75L₂ = | | | | | |
| 0.8L₂ = | | | | | |
| 0.9L₂ = | | | | | |
| 1.0L₂ = | | | | | |
| 1.1L₂ = | | | | | |
| 1.2L₂ = | | | | | |
| 1.25L₂ = | | | | | |

The purpose of question 9 is to begin to assess the utility function for losses over the range of losses that might occur. It is similar in style to that of question 7 and has the same purpose. We would definitely expect a preference for policy X over policy Y for the first row of the table, and expect a preference of policy Y over policy X for the last row. Somewhere in between, there should be indifference, although this need not be the case for the particular levels of losses indicated in the table. However, there should only be one switch from the preference for policy X to a preference for policy Y as one goes down the table.
10. For what amount of L, call it L_{N}, in the pictures above do you find policies X and Y equally desirable for your institution? L_{N}=$______
The purpose of question 10 is to specify the level of losses that makes policy X indifferent to policy Y Again, this is called a certainty equivalent and it can be used to determine a relative point on a utility function. Specifically, if we assign a utility of 100 to the lowest losses (i.e. 75% of L₂) in policy Y and a utility of 0 to the highest level of losses (i.e. 125% of L₂), then the utility assigned to the certainty equivalent LN should be 50, which is equal to the expected utility of policy Y
11. If you exactly meet next year's profit goal P₁, what do you think your exposure will be at the end of the year? $______ (call this E₁)
The purpose of question 11 is to help determine whether it is worthwhile to explicitly include exposure in the objectives quantified to evaluate strategies. This question should be very easy to answer. It simply causes one to think about what they're exposure might be if they meet their profit goal for the coming year.
12. Consider two possible performance results of profits and exposure for next year and assume that losses are equal in both cases:
   Result 1: Profit=P₁ and Exposure=E₁
   Result 2: Profit=P₂ and Exposure increases 10% to 1.1E₁
   What is the amount of profits P₂ such that your institution would find results 1 and 2 equally desirable? P₂=$______
The purpose here is the find a specific tradeoff of how much additional profit is needed in order to accept an increase in exposure of 10% from what they expect exposure to be in the coming year. If a very little amount of profit is needed to compensate for the increase in exposure, this would suggest that there is little reason to explicitly include exposure in the objective function. On the other hand, if the amount of profits needed to compensate for the 10% increase in exposure is large, then it would be worthwhile to follow up on the reasoning for why this seems to be so important. What this means in practical terms is the following. Suppose the range of profits considered in question 7 was $50 million. Then, if a 10% increase in exposure required, for example, $20 million in compensation to reach indifference, this might suggest that exposure is relevant to explicitly include in the objective function. On the other hand, if just $1 million or $2 million of additional profits was enough to compensate for the 10% increase in exposure, then we could justifiably consider exposure to be a secondary factor and evaluate consequences of strategies in terms of profits and losses only.
   Quantifying the Objective Function Given Responses to the Questionnaire

Table E illustrates how to quantify the objective function given responses to the questionnaire. It should be appreciated that the directly relevant responses are those responses to questions 5 and 6 (they should be the same) and questions 8 and 10.

### Table E

A utility function for profit. The response to question 8 gives us a basis for the utility function for profit. We will define up as the utility function for profit and u_{P}(P) as the utility of profit amount P.
We will scale up from a utility of 0 to 100, where higher utilities are preferred, as follows
   u_{P}(0.5P₁)=0 (1)
and
   u_{P}(1.5P₁)=100. (2)
The response P_{N} to question 8 is indifferent to a one-half chance at each of 0.5 P₁ and 1.5 P₁. Hence, we can equate expected utilities and find
   u_{P}(P_{N})=0.5u_{P}(0.5P₁)+0.5u_{P}(1.5P₁)=50. (3)
For most situations, P_{N} will not equal P₁. In these cases, a reasonable utility function is the constantly risk averse function
   u_{P}(P)=a_{P}−b_{P}e^{-c}P^{P}. (4a)
Using (4a) to evaluate (3) and solving yields constant c_{P}, which is a measure of risk aversion for profits. Then, substituting the value of c_{P} into (4a) and simultaneously solving (1) and (2) provides the scaling constants a_{P} and b_{P}. The result will look like that in FIG. 1.
In the case when P_{N}=P₁, the utility function should be the risk neutral linear function
   u_{P}(P)=a_{P}+b_{P}P. (4b)
Simultaneously solving (1) and (2) using u_{P} in (4b) will provide the scaling constraints a_{P} and b_{P}.
A utility function for losses. The response to question 10 gives us a basis for the utility function for losses. We will define U_{L} as the utility function for losses and u_{L}(L) as the utility of loss amount L.
We will scale u_{L} from a utility of 0 to 100, where higher utilities are preferred, as follows
   u_{L}(1.25L₂)=0 (5)
and
   u_{L}(0.75L₂)=100. (6)
The response L_{N} to question 10 is indifferent to a one-half chance at each of 0.75 L₂ and 1.25 L₂. Hence, we can equate expected utilities and find
   u_{L}(L_{N})=0.5u_{L}(0.75L₂)+0.5u_{L}(1.25L₂)=50. (7)
When L_{N} is not equal to L₂, a reasonable utility function is the constantly risk averse function
   u_{L}(L)=a_{L}−b_{L}e^{c}L^{L} (8a)
Using (8a) to evaluate (7) and solving yields constant c_{L}, which is a measure of risk aversion for losses. When c_{L} is positive, the utility function exhibits risk aversion. Then, substituting the value of c_{L} into (8a) and simultaneously solving (5) and (6) provides the scaling constants a_{L} and b_{L}. The result will look like that in FIG. 2 for a risk averse function. The plus sign before constant c_{L} in (8a) is different than the minus sign before constant c_{P} in (4a) because more losses are less desirable, whereas more profits are more desirable.
When L_{N}=L₂, the utility function should be the risk neutral linear utility function
   u_{L}(L)=a_{L}−b_{L}L. (8b)
Simultaneously solving (5) and (6) using u_{L} in (8b) will provide the scaling constraints a_{L} and b_{L}.
The utility function for profits and losses. We assume an additive utility function for profits and losses. Hence,
   u(P,L)=k_{P}u_{P}(P)+k_{L}u_{L}(L), (9)
where k_{P} and k_{L} are the weights of the respective component utility functions. Our ranges of consequences for this utility function are those in questions 7 and 9, namely 0.5 P₁≦P≦1.5 P₁ and 0.75 L₂≦L≦1.25 L₂. FIG. 3 shows this consequences space.
We will also scale the additive utility function from 0 to 100. Hence, the worst consequence in FIG. 3, which is (0.5 P₁, 1.25 L₂) is assigned 0 and the best consequence (1.5 P₁, 0.75 L₂) is assigned 100:
   u(1.5P₁,0.75 L₂)=100 (10)
and
   u(0.5P₁,1.25L₂)=0. (11)
Evaluating (10) with (9), and then (2) and (6), we find
   u(1.5P₁,0.75L₂)=k_{P}u_{P}(1.5P₁)+k_{L}u_{L}(0.75L₂)
   100=k_{P}(100)+k_{L}(100)
   1=k_{P}+k_{L}. (12)
To get one more equation with constants k_{P} and k_{L}, we equate the utilities of the two indifferent consequences from question 6, which are (P₀,L₀) and (P₁,L₂). Equating these utilities yields
   u(P₀,L₀)=u(P₁,L₂)
   k_{P}u_{P}(P₀)+k_{L}u_{L}(L₀)=k_{P}u_{P}(P₁)+k_{L}u_{L}(L₂).
Substituting the values of u_{P}(P₀), u_{L}(L₀), +u_{P}(P₁), and u_{L}(L₂) from the already calculated component utility function yields a second equation relating constants k_{P} and k_{L}. Solving this with (12) provides the weighting constants for (9). Then (9) with the component utility functions is our overall utility function for profits and losses.
Including preferences for exposure. If exposure is added to the utility function, it should be done as an adjustment to profits based on the tradeoff given in question 12. For example, suppose the 10% increase in exposure was assessed as requiring $4 million in additional profits to reach indifference.
If exposure was expected to increase 10% next year with some policy that resulted in expected profits of P, then simply evaluate this as a profit level of (P—$4 million). If exposure increased 5%, then reduce the expected profits by $2 million in evaluation to take into account this increase in exposure.
A few comments. As shown in FIG. 3, the calculations assume that both P₀ and L₀ are within the ranges of the assessed utility functions. This will normally be the case given the way ranges for profits and losses were selected. If it is not the case in some instances, then extrapolate the component utility functions and proceed.
The assumption of an additive utility function (9) is probably reasonable if interests of the institution are quantified. It is also likely reasonable for most consequences as higher profits are probably correlated with higher losses. It is the case where lower profits and higher losses arise together that this may be particularly a problem for individuals managing a portfolio.

### Data Request and Reception

According to the preferred embodiment of the invention, as soon as the decision is properly framed work can begin on requesting and receiving the necessary data. Often the data comes solely from the client. However, data may also need to be transferred from other parties. In effect, such data also serves as the foundation for an enterprise data store.

Requesting and receiving data from the client can often be a very long and unclear part of the Strategy Modeling process. Many times the data received looks drastically different, either in format, structure or content from expected on the receiving end.

The preferred embodiment of the invention provides the structure needed to ensure both sides are aware of the needs and requirements in requesting and receiving data to start the project on the correct foot.

Inputs

In the preferred embodiment of the invention, input data includes:
the correctly framed decision problem; and
understanding of client and task manager systems.
description of data types and data fields required and the time frame associated with the data.
   Outputs

The preferred embodiment of the invention provides output in the form of:
Original data sets from the client stored in the task manager's system; and
A data dictionary describing all the data received from the client.
   Procedure

The preferred embodiment of the invention provides the following procedure for data request and receiving. The data requesting and receiving process begins with a meeting between the client and the task manager entity to design the predictive period, the performance period and data elements. When the data parameters are developed, another meeting takes place in which teams on either side determine transfer parameters. Also, when the data elements are agreed upon, an initial data dictionary is constructed. When the entire data collection and transfer process is clear, the client assembles and transfers the data to the task manager for loading onto the task manager's systems.

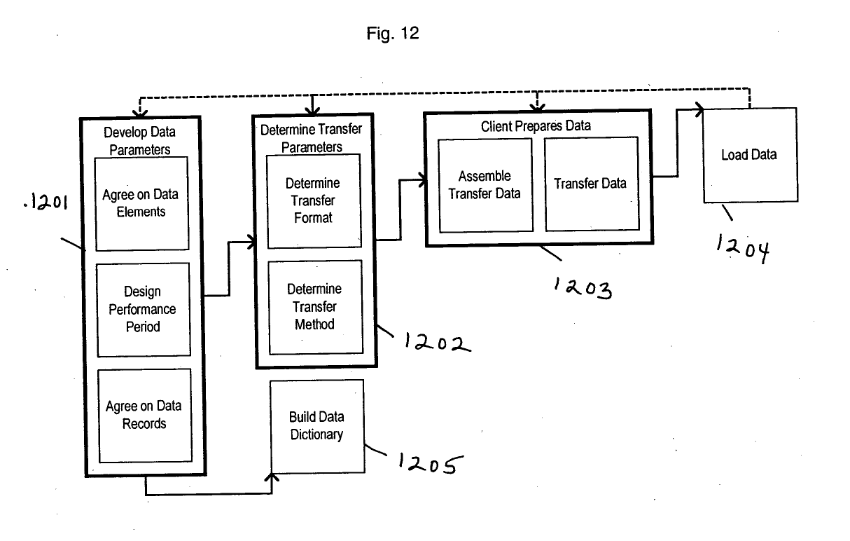

Referring to FIG. 12, it should be appreciated that the data parameters and transfer parameters processes are iterative. FIG. 12 is a schematic diagram showing control flow from developing data parameters 1201 to determining transfer parameters 1202 to client preparing data 1203, and finally to loading data 1204. The process includes building a data dictionary 1205. The process is iterative from loading data 1204 to any of the previous three. For example, during the transfer parameters meeting it may be decided that to transfer data in a particular manner or in a particular format may be very time consuming because of a few variables or because of the performance period. It may be necessary, therefore, to revisit the data parameters section. Also, during the time the client is preparing the data to transfer, issues may crop up. Depending on the magnitude of the issues, revisiting the data parameters or transfer parameters discussions may be required. During loading into the task manager's systems, errors may be encountered which prompt the data to be prepared again or just retransferred.

Develop Data Parameters

Develop the Data Parameters includes the following three sub-steps:
Design Performance Period;
Agree on Data Elements; and
Agree on Data Records.

Such steps are dependent on one another and are done preferably in parallel with one another in a kickoff meeting between the client's team and the task manager's team.

Design Performance Periods

The preferred embodiment of the invention provides a first step for getting data from the client, where the window of data the analysis team is going to work with is designed and how the data within that window is going to be divided into individual performance periods is also designed.

This process is dependent on the framing of the decision problem (see Strategy Situation Analysis). For example, if the modeled decision is how many actions to make in a week, the performance period needs to be a number of weeks and the window of data received from the client needs to be some multiple of that.

Also, in the preferred embodiment of the invention, the domain of the training data set vs. the domain of the validation data set is decided in this step. Options include having different time windows for the training and validation sets, e.g. train on October 2000 data and validate on October 2001 data, or having one time window and creating a holdout sample to use as a validation data set.

Agree on Data Elements

The preferred embodiment of the invention uses any knowledge of any of the following for determining data elements:
Current Data Collection Practices;
Data Elements Currently Used in the Decision Process;
How and Where Data is Currently Stored;
Multiple Data Formats;
Frequency and Process of Updating Fields;
If and When Roll-ups Occur;
How the Fields Have Changed Over Time;
Fields that are Reliably Maintained;
Planned Future Changes; and
When Decision-Key and Outcome Variables Become Known.

The preferred embodiment of the invention is flexible to accommodate using variables determined by a range of means. That is, a user preferably performs some form of cost/benefit analysis to determine which variables are worth getting. It may be that certain variables in certain systems require a large amount of processing time to include such variables. Certain other variables, such as performance metrics, are required regardless of potential costs.

According to the preferred embodiment of the invention, requested data elements are formulated as a series of requests, depending on the nature of the project. For example, performance data elements are specified separately from variables needed for action-based predictors.

According to the preferred embodiment of the invention, a user can perform the following: preferably begin planning early for active data collection that is used for evaluating the selected strategy in the field; assessing if there are improvements that would be useful for future analysis work, improvements that can be implemented now; and determining if there are more efficient ways to collect the information to make future projects or implementing strategies easier.

Agree on Records to Transfer

In the preferred embodiment of the invention, along with the performance period and data elements, the team determines the number of records and the sampling scheme used to obtain those records.

The number of records is a function of the decision problem (see Strategy Situation Analysis) and the different sets of data elements agreed upon above.

When determining the sampling scheme the distribution of the data preferably is taken into account wherever possible. For example, if 90% of the records in the historical data were given the same treatment it might not be advantageous to sample equally over that distribution, because this 90% of the records may not provide much information for driving the decision. It should be appreciated that it is preferable to over sample interesting, revenue driving records to get an accurate picture and understanding of how such records behave.

The result of this step is a quantified set of rules the client uses to pull the data.

Build Initial Data Dictionary

In the preferred embodiment of the invention, after the Develop Data Parameters steps are complete an Initial Data Dictionary is constructed by the client and conveyed to the task manager.

The preferred embodiment of the invention provides a document that includes:
A high-level description of each data collection process involved;
An English description of each deliverable file;
An English description of each data item;
A domain for each data item; and
A few sample records to allow for setup work prior to receiving the entire data set.

In an ideal situation the client has a current data dictionary that is examined before the data is transferred. Missing pieces of data may need to be filled in after the data is transferred. It should be appreciated, however, that the push is to have any such data as soon as possible so modification of the import/cleaning process can be made prior to receiving all the data.

Determine Transfer Parameters

Once the Develop Data Parameters steps are complete the client's technical team and the task manager's technical team meet to determine the most efficient way to get the data from the client to the task manager.

Determine Transfer Format

Once the data elements are determined, the preferred embodiment of the invention determines the form in which the data is extracted. The format preferably is the easiest format for the client. If the client has no preference, then a predetermined standard format is preferred. The amount of work required to extract such data is determined, using the task manager, if desirable.

Determine Method (and Frequency) of Transfer

The preferred embodiment of the invention, in anticipation of data transfer, determines the media the client feels most comfortable using to transfer data. If the client has no preference, then the task manager recommends a media and method. The task manager considers constraints, such as for example: how long the transfer takes on both sides, reliability of the transfer, security, etc. Also determined is whether files are transferred in one large batch or streamed to the task manager as they are completed.

According to the preferred embodiment, potential media include any of:
Email—Fine for small data sets, but not preferred for when files are large. Not recommended as a general policy;
FTP to task manager's server;
CDs/Tapes/DVDs. Clients burn data onto CDs or DVDs and send the data to the task manager. This could also include legacy systems data such as very old tapes.
FTP to a client server—Clients could make their data accessible on one of their own servers and give the task manager access to ftp to the server.

A discussion of potential time and cost tradeoffs associated with the potential options is conducted. It may be the case that a particular format requires additional hardware or manpower to successfully transfer and load the data.

The preferred embodiment of the invention also provides for determining if data is transferred once or if periodic updates are necessary, and ensuring that the client is comfortable with the process to ensure security both in transfer and onsite. A written security process for handling such data is preferred.

Load Data

According to the preferred embodiment of the invention, after the client assembles and delivers the data to the task manager, such data is loaded into the systems for analysts to use.

If necessary, all formats are converted to the task manager's preferred file format, using corresponding scripts, which, preferably, are reusable from project to project.

Such scripts create data dictionaries which are summaries of the data captured in each file. These generated data dictionaries are compared to those constructed in the previous step to ensure what the task manager receives from the client corresponds to what was agreed upon.

The data is now ready for initial integrity checking, cleansing, and transformation.

Resources

Typically, the entire Strategy Modeling Team is involved early on to ensure the proper selection of performance periods and data elements. The experience of the lead and of the enterprise is preferable to such selection. When the selection is made, the rest of the process is mechanical and is performed by an analyst or task manager consultant with input from a counterpart from the enterprise and supervisory input from the lead. The analyst engages the counterpart entity in the enterprise to negotiate the mechanics of the request and reception. Knowledge of the hardware and software to be used is essential. In one embodiment of the invention, the analyst preferably is selected based on experience with the enterprise's operating environments. In another equally preferred embodiment, a second analyst is on hand to ensure quality and to bring a fresh perspective.

Improvements

It should be appreciated that the early Strategy Modeling clients likely have different data infrastructures and analysts will use the tools and procedures that they are most familiar with to execute data reception. According to the preferred embodiment of the invention, as the process is repeated for clients with similar infrastructures or in similar industries, standardized procedures are developed. This serves two roles, standardizing the process and ensuring that the process is repeatable and can be inspected for quality. Software or scripts for common tasks are developed and preferably are captured in a library. Documentation and comments in the code are especially important. Moreover, a prototype for a script is often more useful as a reference than a full program with all of the detail required during an engagement.

Logs of the process also preferably are saved such that mistakes are tracked and corrected later. Thus, the preferred embodiment of the invention provides a type of system for storing and versioning.

Deliverables

The preferred embodiment of the invention provides communications to the client reporting the status of the data request.

### Data Transformation and Cleansing

According to the preferred embodiment of the invention, after the requested data and data dictionary are warehoused, the data is cleansed and transformed so that it is useful for decision modeling. Data transformation and cleansing ensures that data is transformed and that the integrity of the data is verified.

Inputs

In the preferred embodiment of the invention, input data includes client's raw data input into the task manager's systems with accompanying data dictionaries.

Outputs

The preferred embodiment of the invention provides output in the form of cleaned data sets having knowledge of or references to all the variables and domains, and data dictionaries of those data sets.

Procedure

The preferred embodiment of the invention provides the following procedure.

Analysts take the loaded data sets and check the validity of the data received from the client. This step involves cleaning of data elements or data rows, i.e. original data is cleaned, that is, transformed into a form analysts can use to explore and eventually build models. When such transformed data sets, referred to as analysis data sets, are built, they too are investigated and cleaned just like the original data sets.

The iterative nature of the invention should be appreciated. That is, while creating an analysis data set, problems may be uncovered in the original data set requiring more cleaning of the original data and retransformation. During validation of the analysis data set, problems in the transformation process itself or in the original data may be discovered, forcing such tasks to be revisited.

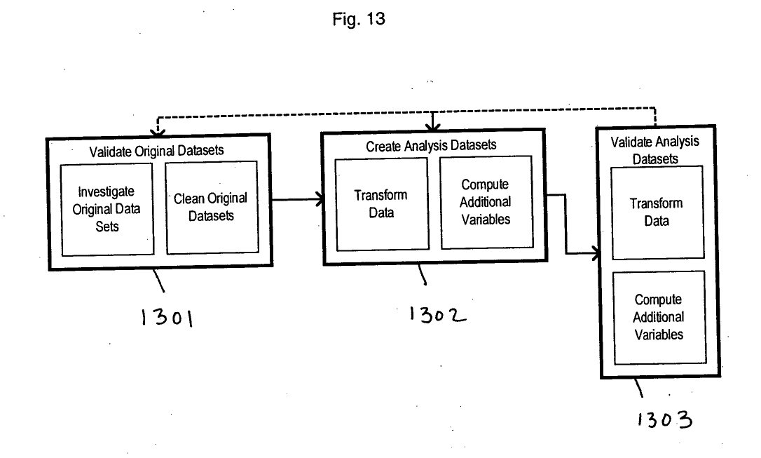

Referring to FIG. 13, the preferred embodiment of the invention provides three main components to the data transformation and cleansing module: validate original data sets 1301, create analysis data sets 1302, and validate analysis data sets 1303, described in detail herein below.

Validate Original Data sets

The preferred embodiment of the invention provides validating original data sets using the following two steps:
Investigating Original Data sets; and
Cleaning Original Data sets.

Such validating steps preferably are completed in conjunction with one another, with the findings of the investigation step driving the cleaning process.

Investigate Original Data sets

According to the preferred embodiment of the invention, If a data dictionary accompanies files sent from the client, then that data dictionary is compared to the dictionary automatically created by the process of loading the data into the database, such as SQL Server. The variable types are compared and any inconsistencies between the documents are addressed, such as discussing the inconsistencies with the client.

If no data dictionary accompanied the client's data, the analyst reviews the automatically generated data dictionary.

Following is an example of an analyst efficiently reviewing the data. That is, after looking at the data dictionary, the analyst pulls a predetermined number of random records from each of the raw database tables and looks at the data. Such method eases the analyst into the data and also points out suspicious looking data, such as particular variables consistently missing, or consistently having the same, constant value. As the analyst reviews the data, the analyst consults the data dictionary to cross-check, ensuring the data makes sense.

Also in the preferred embodiment of the invention, the analyst runs the stored procedure that creates summary statistics for all variables in a table. The results give the analyst a sense of the values in particular fields and their distribution, and a sense of the quality of a particular field.

After the above is completed, the analyst sets up a meeting to go over the list of inconsistencies or items not understood, which preferably is compiled as the above processes are completed.

During this step, the data is learned and understood inside and out upfront. The more work and effort done to understand the data at this point saves a lot more time than if features need reengineering later.

Clean the Original Data Sets

After initial investigation of data, there is sometimes cleanup work required on the data set before transformations can begin.

Following is a list of possible clean up tasks:
Deletions of particular records that may have bad or missing data;
Deletions of particular columns that are not useful/needed for the analysis or that have bad data or too much missing data;
Correcting typos/badly entered data; and
Changing the types of variables to be used in transformation/analysis.

In the preferred embodiment of the invention, the task manager has a series of scripts that help to automate this process. Such scripts are modifiable for a particular project, where file names and variable names are changed, and are run to clean the data.

Create Analysis Data Sets

In the preferred embodiment of the invention, creating analysis data sets includes the following two steps:
Transforming Data; and
Computing Additional Variables. A process for creating the concepts for these additional variables is presented in Create Decision Keys and Intermediate Variables herein below.

These two steps should be done in parallel. Often times it is easiest to create certain new variables while the data is being transformed and rolled up into the correct level of analysis. Once the rollup is complete there is most likely the need to create additional computational variables post transformation.

A major concern in this step of the process is the potential need to take a number of cleaned data sets from different sources and merge them together. For example, a marketing department may have a database outlining the client's marketing campaigns, but a different business unit tracks the responses to those campaigns, and another separate business unit records the performance. Therefore, in this transformation process, the data is combined together, rolled up correctly, and a usable analysis data set is created.

Transform Data into Data Sets (Tables) at the Correct Level of Analysis

Recall that in the first stage of the project, framing the decision problem, the correct level of analysis, e.g. account-level, transaction-level, and the performance period(s) for analysis are decided upon.

The data is summarized at the correct level of analysis for each performance period in the determined time horizon.

In certain instances the raw data may already be at the correct level of analysis, but in many cases the data is transformed manually.

Snapshot Data

In the case when data received is a series of snapshots of an account over time, then the snapshots needed are filtered. For example, if snapshots of accounts are on a week-by-week basis and the appropriate performance period is a month, then the process filters down to just those needed records.

Transaction Data

If data received is at the transaction level, then those transactions are aggregated at the appropriated account/time period level. For example, if a set of Web data is received with the particular clicks made by a user, then those clicks are rolled up into a summary of each user, turning individual transactions into counts of transactions and sums of variables.

Compute Additional Variables Needed for Analysis

Once the data is obtained at the correct level of analysis, it may be necessary to create additional variables beyond those in the existing data set. Often times this is because certain variables are not very useful in one form, but are useful in another form. For example, consider a gender variable that is either “f” (female) or “m” (male). While useful, such variable may not be used in its current form to build regression or predictive models. Instead, it may be more useful to have an “is male” variable that is 1 for males and 0 for females. These additional variables can then be used numerically to build models.

It may be the case that the variables required to benchmark against the current strategy or variables requested by the client during an earlier phase need to be computed. For example, given a response a client may compute profit as a function of other data elements. However profit may not be immediately available for the relevant performance periods. It should be appreciated that an appropriate liaison on the client-side preferably is identified to aid in the computation and verification of such variables.

It may also be the case that the team wishes to have variables that are the difference between two records in the data set. For example, in the snapshot data it may be necessary to compute the difference between the ending snapshot and the beginning snapshot to figure out the number of events during a particular time period.

Validate Analysis Data sets

Validate Analysis Data sets includes the following two sub-steps:
Investigate Analysis Data sets; and
Build Data Dictionary.

The investigation process occurs and once the data sets are in a satisfactory state a data dictionary is constructed. This allows others, such as analysts and team members to know all the variables being used.

Investigate Analysis Data Sets

See also Investigate Original Data set. The process is very similar to investigating original data sets as described above, including checking for unusual or bad data and data not understood. It may be that an observation missed something in the original data that explains current problems, or it may indicate errors in the scripts and code run to process the data.

If possible, distributions of decision-key and decision variables are checked with the client to ensure that the variables are being computed consistently and correctly. This step is especially useful when evaluating the current strategy of a client. If the client does not agree with the integrity of data used to evaluate their strategy, comparison with new strategies will be moot.

Regardless, the analysis data set is understood as much as possible before beginning the modeling process. Some cleanup may be required in this phase as well.

Preferably, scripts used in this process are stored in a database possibly with versioning to allow for duplication of the process.

Build a Data Dictionary for the Analysis Data Set

When a level of comfort with the analysis data set is reached, running the same scripts ran to create the dictionary for the original data set(s) creates a corresponding data dictionary.

Tools

The following tools may be provided in the preferred embodiment of the invention. It should be appreciated that a user has discretion over which tools to use, according to the particular implementation of the invention for the user's particular needs.
Commercial statistical tools—Have a number of procedures that are designed for manipulating and rolling up data.
SQL—Enables computations quickly and defines the grouping over which those calculations are performed. For example, variables such as average, min, and max are very easy to do in a one line SQL query.
Matlab—Has useful data structures for manipulating tables or matrices of data.
   Resources

Typically, this process is mechanical and is performed by an analyst with moderate supervision from a task manager's consultant that provides guidance when anomalies in the data are discovered. Interaction with a counterpart on the client side is most likely essential to resolve issues. The consultant or even a lead may be needed in the early stages to help define the Enterprise Data Store and architecture. Also, senior members of the Strategy Modeling Team may be heavily involved if the construction of an Enterprise Data Store. Preferably, the analyst is selected based on experience with the enterprise's operating environments and has support for quality assurance from another team member.

Improvements

New designs and tools, such as for data extraction, transformation, and loading (ETL) tools can be considered in this process.

Deliverables

The preferred embodiment of the invention provides a report to the client on the cleaning process and the cleaned data sets.

### Decision Key and Intermediate Variable Creation

According to the preferred embodiment of the invention, with the decision frame defined and the data and data dictionary prepared, variables that are potentially useful for the decision models are defined and created. Recall that most decision models have at least one intermediate variable. Intermediate variables can depend on decision keys, other intermediate variables, or decisions. Each intermediate variable contains a model that maps the values of the nodes it depends on to the values that it can take on. If an intermediate variable depends on a decision and is developed from data, then the model is called an action-based predictor. In this way, each intermediate variable encapsulates a predictive model with a dependent variable (the intermediate variable) and independent variables (decision(s), decision key(s), and possibly other intermediate variable(s)). This section focuses on the models contained in intermediate variables and not on the decision model as a whole.

Intermediate variables that encapsulate predictive models of high-quality contribute greatly to the development of optimal strategies. The quality of a predictive model is primarily driven by the quality of variables. No amount of care in developing and validating a model can yield a satisfactory model if the information required for prediction is not captured sufficiently by the variables.

In the preferred embodiment of the invention, across multiple engagements that address the same business process, a library of the best variables is provided. The challenge analysts face is to use all the information available on an individual or case to predict the future of that individual. Examples of variables created in the context of business processes traditionally addressed by the task manager are: response/non-response, revenue generation, attrition/non-attrition, and payment/default of obligations.

It should be appreciated that on one hand, it is best to strive to simplify the library. On the other hand, there is a constant desire to squeeze as much relevant information out of the data as possible. The development of such libraries creates a strategic advantage. Thus, the purpose of this section is to guide the creation of variables according to the invention. The guidelines are based on any of a number of distinctions that are drawn about a given variable.

When triaging independent variables for creation there are two useful distinctions. One distinction is to consider spreading out variables across a spectrum of granularity that ranges from coarse to fine. Variables at the coarse end of the spectrum tend to reflect summary information, e.g. average revenue per response. Variables at the fine end of the spectrum tend to represent highly-detailed specific information, e.g. minimum revenue-per response. The second distinction is that some concepts are very likely to be relevant to predicting the independent variables while others are less so. It is important that variables be created to cover all of the concepts so that the most important concepts are identified and focused on. Thus, it is best to start with a broad set of coarse summary variables that cover a broad range of concepts and then use exploratory data analysis to focus on creating finer variables to represent the most important concepts. These distinctions apply to dependent variables as well.

Inputs

In the preferred embodiment of the invention, input data includes a basic understanding of the intermediate variables that drive value, and a basic understanding of the decision keys and intermediate variables (independent variables) that traditionally have been useful for predicting the dependent variables (intermediate variables).

Output

The preferred embodiment of the invention provides output in the form of a set of candidate decision keys and intermediate variables.

Procedure

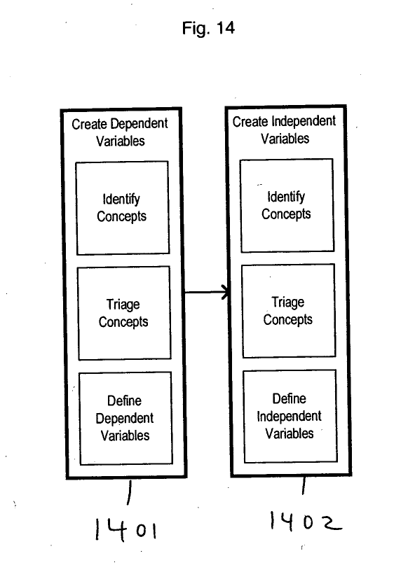

The preferred embodiment of the invention provides the following process and means for creating decision key and intermediate variables. Referring to FIG. 14, two main components of the decision key and intermediate variable creation module are create dependent variables 1402 and create independent variables 1402, described in detail herein below.

Define Dependent Variables

Recall that intermediate variables can depend on other intermediate variables. So each intermediate variable is a dependent variable. But when building a model encapsulated in a given intermediate variable, other intermediate variables may be considered to be independent variables with respect to it. It is first necessary to clearly define each dependent variable such that it can be computed from the available data elements. While the concept behind an independent variable may be obvious, defining it with sufficient clarity such that it can be computed is an art. For example, in marketing, response to a promotion is a common dependent variable. However, measures of response can range from coarse to fine depending on what subtleties of the business process are accounted for. For example, the invention is flexible to either account for or not account for the following example criteria: Canceled orders; Returned orders; Partial cancellations; Partial Returns; etc. It is often best to start with a coarse measure and refine it over time to account for the subtleties that arise in the definition.

Identify Concepts

With the dependent variables identified, attention turns to brainstorming concepts that may be relevant for defining independent variables. There are three primary sources for concepts. One, subject matter experts or experts in the business process that is being addressed may have a wealth of experience in predicting the dependent variables. In fact, the client may have a library of independent variables to consider. For example, recency, frequency, and monetary are considered to be the main concepts for understanding response in marketing. Two, brainstorming new concepts can often be fruitful. Three, over time the task manager will develop libraries of concepts that are useful for describing particular business processes.

Here the focus is on developing the broadest set of concepts.

Triage Concepts

In most cases, the set of concepts is small enough such that there are sufficient resources to cover each concept with at least one variable. If this is not the case, the value of expertise in the business process is paramount for triaging concepts.

Define Variables

Defining variables starts by focusing on defining coarse variables that cover the concepts. These coarse variables are most likely summary variables, such as averages over long periods or totals. Some attention is paid to ensuring that variables are normalized where appropriate. For example, lifetime revenue is not as good a summary measure as lifetime revenue/lifetime, etc. Also, it is important to specify when a variable is marked as “cannot compute.” That is, for certain cases a variable may have no meaning, e.g. skew (x) if there are only three data points for x. It should be appreciated that there is no need to be concerned with the correlation among concepts or variables at this time.

Refinement

The set of variables under consideration can be expanded as exploratory data analysis indicates that some concepts are more promising than others for predicting a dependent variable. More variables can be created for describing the promising concepts. These variables often tend toward the fine end of the spectrum. This refinement can be guided by the concepts of Diminishing Returns and Value of Information, as follows. It is likely that a coarse variable that covers a concept contains most of the power to predict a dependent variable. Adding more specific variables often only yield a diminishing return to the quality of the predictive model. Moreover, it may turn out that with respect to the decisions being made, having a better prediction of the independent variable has very little chance of changing the decision for most cases, i.e. the value of information of the independent variable is not significant.

Tools

The following tools are provided in the preferred embodiment of the invention. It should be appreciated that a user has discretion over which tools to use, according to the particular implementation of the invention for the user's particular needs.

Value of Information

Consider a particular decision where uncertainty has the potential to affect the value captured after the decision is made. It is possible and may be useful to resolve some of the uncertainty before making the decision. A different alternative might be chosen if information could be gathered to eliminate or reduce uncertainty. The value of information with respect to one uncertainty is the amount that the Decision Board is willing to pay to resolve the uncertainty before making a decision. If the value of information turns out to be very small, then the uncertainty can be removed from the decision model.

Resources

Typically, the entire Strategy Modeling team works together at this stage. Any past experience that the enterprise has in modeling the business process is relevant to creating variables. In addition, it is preferable if the task manager consultants have experience with the business process and the way it is typically modeled across multiple enterprises. The lead consultant preferably is skilled in facilitating discussions about business processes, variable creation, and decision analysis concepts, such as sensitivity analysis and value of information. This requires strong knowledge of the iterative nature of the process so that through each iteration the lead consultant keeps the team members on track and focused at the right level of granularity. The ability to stimulate creativity in the team members is also useful. Also, the consultant preferably is familiar with these concepts as well to provide documentation and support.

Improvement

A keystone to achieving repeatability of Decision Key and Intermediate Variable Creation is developing libraries of effective variables and variable concepts for different types of projects. With the completion of every customer project, the team learns which variable concepts and which variable definitions lead to the best quality predictive models. Such observations are captured and re-used. They become part of the knowledge capital of the task manager. Moreover, it is preferable to develop metrics that describe how well the creative process has done at capturing concepts and measuring them with clearly defined variables.

In addition to creating and maintaining libraries, the process for facilitating discussions with clients about variables evolves as more engagements are completed.

Deliverables

The preferred embodiment of the invention provides a list of candidate variables for decision modeling and a list of variables that affect value directly.

### Data Exploration

The previous section described how the invention ensures that a wealth of potential useful characteristics is available for creating predictive models. The preferred embodiment of the invention provides means for gaining insight as to which characteristics are effective Decision Keys and Intermediate Variables as described herein. After exploratory data analysis, the list of candidate variables is narrowed. Secondarily, the exploratory nature of the analysis provides an opportunity to gain valuable insights into the customer's business and business process. Such insights can often be reported to the client to build confidence and add value.

Data exploration is aimed at maximizing the analyst's insight into a data set and into the underlying structure of the data, while providing all of the specific items that an analyst would want to extract from a data set. The preferred embodiment of the invention provides a sequence of tasks and guidelines for the analyst designed to achieve this objective.

Input

In the preferred embodiment of the invention, input data includes a clean data warehouse (Strategy Data Network) coming from the original databases and the newly created variables coming from the previous sub-process (Decision Key and Intermediate Variable Creation).

Output

The preferred embodiment of the invention provides output in the form of a report that summarizes potential usefulness of candidate Decision Keys and Intermediate Variables, and a report that is designed for the consultants as well as a customized and/or limited version to be shared with the entire strategy team.

Procedure

The preferred embodiment of the invention provides the following procedure for data exploration. The analyst starts extracting some general information based on means and variances for continuous variables. Then, the analyst finds relevant variables by applying multivariate methods such as principal component analysis. Advanced statistical techniques then are performed on the relevant variables in order to extract deeper insight from the data. Once the results are validated using testing sets, data sets are ready to be formatted. The report integrates the conclusions and presents the tendencies that provide insight and might be useful thereafter.

Various advanced statistical methods are applied to find patterns, relations, trends, etc. Then the results are validated and proven useful using alternate data sets. In case the validation data sets cannot corroborate the results based on the development data sets, the analyst may have to reconsider the way to explore the data.

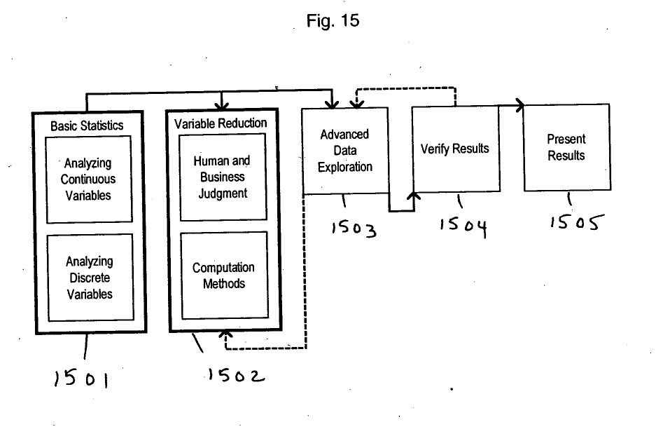

Referring to FIG. 15, the main components of the data exploration module are basic statistics 1502, variable reduction 1502, advanced data exploration 1503, verify results 1504, and present results 1505 described in detail herein below.

Applying Basic Statistical Analysis

The analyst starts by applying the fundamental descriptive statistical tools to summarize both continuous and categorical data. Frequencies, means, other measures of central tendency and dispersion, and cross tabulations, decision trees and cluster analysis are the most fundamental descriptive statistical analysis techniques. The analyst preferably begins by looking at plots of the data as the plots provide more insight than basic statistical measures.

Analyzing Continuous Variables

The structure of a distribution of a variable is inferred much more quickly from looking at a histogram than from reviewing the mean, variance, and skew. Similarly, a scatter plot of two variables is much more revealing than a correlation coefficient or the results from a regression. A simple histogram can help identify whether the distribution of the examined variable is highly skewed, non-normal, or bi-modal, etc. In addition, the histogram, box-plots, stem-and-leafs, etc. are also useful. Once a high-level understanding is achieved through basic visualizations, descriptive statistics are used to quantify the insights.

Descriptive statistics for continuous data include indices, averages, and variances. Sometimes rather than using the mean and the standard deviation, analysts categorize continuous variables to report frequencies. Transformation of continuous variables is typically done because traditional modeling techniques, such as linear and logistic regression, do not handle non-linear data relationships unless the data are first transformed. The analyst also preferably reviews large correlation matrices for coefficients that meet certain thresholds when working with continuous variables.

Analyzing Discrete Variables

Categorical descriptive techniques include one-way frequencies and cross tabulation. Customarily, if a data set includes any categorical data, then one of the first steps in the data analysis is to compute a frequency table for those categorical variables. Frequency or one-way tables represent the simplest method for analyzing categorical (nominal) data. Such tables are often used as one of the exploratory procedures to review how different categories of values are distributed in the sample.

Cross tabulation is a combination of two or more frequency tables arranged such that each cell in the resulting table represents a unique combination of specific values of cross tabulated variables. Thus, cross tabulation allows examining frequencies of observations that belong to specific categories on more than one variable. By examining such frequencies, relations between cross-tabulated variables are identified. Preferably, only categorical variables or variables with a relatively small number of different meaningful values are cross tabulated. A two-way table may be visualized in a three dimensional histogram, which has the advantage of producing an integrated picture of the entire table. The advantage of the categorized graph is that it allows precisely evaluating specific frequencies in each cell of the table.

In the preferred embodiment of the invention, basic exploratory analysis delivers considerable value to a client either to confirm their internal analysis or to provide information that their team does not have the resources to find. Specifically, cross-tabulation of candidate Decision Keys and Intermediate Variables can provide insight into which Decision Keys provides the most information for predicting and modeling a given Intermediate Variable. Such insights guide more sophisticated modeling.

Applying Variable Reduction Techniques

It is not unusual that the client provides the task manager with a customer file with hundreds of variables (columns) and millions of observations (rows). Therefore, the second action taken by the analyst is to reduce the dimensionality (number of variables) by squeezing out redundant information represented by many variables.

The reduced dimensionality is necessary to make any sense of the action based predictive models development and further data exploratory investigation. It is important to select the smallest subset of variables that will represent underlying dimensions of the data. The analyst uses several variable reduction techniques to reduce the number of variables in the database, such as any of:
Human and Business Judgment;
Multivariate Exploratory Technique;
Principal Component Analysis;
Factor Analysis;
Canonical Discriminant Analysis;
Multidimensional Scaling;
Stepwise Regression Variable Selection; and
Bayesian Network Learning.
   Human and Business Judgment

Judgment often plays an important role in the selection and creation of variables for analysis. There are typically hundreds of candidates to choose among and the variables often contain redundant information. An analyst may choose some variables over others that contain similar information. For example, for credit scoring models, regulations require that variables need to be used to explain to customers the reasons behind credit decisions.

Multivariate Exploratory Techniques

Multivariate exploratory techniques are designed specifically to identify patterns in multivariate or univariate (sequences of measurements) data sets. It should be appreciated that those of interest are such that can be applied to reduce the number of variables in a data set: Principal Component Analysis, Factor Analysis, Canonical Discriminant Analysis, and Multidimensional Scaling. Following is a detailed description of these methods.

Principal Component Analysis

Many variables in an analysis data set may maintain redundant information. For example, some variables may be highly correlated. The fundamental concept behind Principal Components Analysis (PCA) is that the variables are condensed such that redundant information is eliminated without losing much information value. For example, the correlation between two variables can be summarized in a scatter plot. A regression line through the points can represent the linear relationship between the variables. A variable that approximates the regression line would then capture most of the information value in the two variables in the scatter plot. In essence, two variables are reduced into one that approximates a linear combination of the two. Note that if the relationships among the variables are not linear and obvious, then this compression may not be as useful. This technique can clearly be extended to work with multiple variables.

One central question in PCA is how many factors to extract. As factors are extracted consecutively, they account for less and less variability. The decision of when to stop extracting factors primarily depends on when there is only very little random variability left. The nature of this decision is arbitrary; however, various guidelines have been developed based on the Eigen-values.

Factor Analysis

Factor analysis is related to principal component analysis in that its goal is also to search for a few representative variables to explain the observable variables in the data. However, the philosophical difference in factor analysis is that it assumes that the correlation exhibited among the observable variables is really the external reflection of the true correlation of the observable variables to a few underlying but not directly observable variables. These latent variables are called factors that drive the observable variables. When conditioned on the factors, there is no correlation between the observable variables.

For example, the concepts of ability to pay and willingness to pay, although difficult to observe directly, are two very general factors that may drive most of the credit risk variables typically encountered. More specific and practical examples of factors in credit data are revolving credit capacity, revolving credit utilization, and revolving credit experience.

Factor analysis is the process by which various alternative choices are made towards generating the factors and selection of the factor scheme that most intuitively relates the original observable variables is made. In addition to choosing the trade-off between number of factors and amount of correlation/covariance to explain, there are additional choices of whether to allow the factors to be correlated (oblique) or uncorrelated (orthogonal).

Principal Factors vs. Principal Components

PCA is most often used as a method of reducing the number of variables under consideration, thus compressing the data. Principal Factors is more useful for understanding the structure of the data, by searching for external drivers of the relationships among variables.

Canonical Discriminant Analysis

PCA can be used when no prior assumption has been made about reducing the dimensionality of the input space. On the other hand it might be more useful to reduce the dimension whilst separating a number of a priori known classes or categories in the original data as much as possible. An alternative dimension reduction technique that concentrates on maintaining class separability rather than information (variance) in the subspace projection is that of Canonical Discriminant Analysis (CDA), also known as Canonical Variates Analysis.

This transform is essentially the generalization of Fisher's linear discriminant function to multiple dimensions

Multidimensional Scaling

Multidimensional scaling (MDSCAL) is a multivariate statistical technique, which through computer applications seeks to simplify complex information. The main aim is to develop spatial structure from numerical data. The starting point is a series of units, and some way of measuring or estimating the distances between them, often in terms of similarity and difference, where a larger difference is treated as much the same as a larger distance. This technique allows for reaching the best arrangement (usually in two dimensions) of the various units in terms of similarities and differences.

An interesting feature of the method is that it does not need fully quantitative measures of similarity and difference: it is sufficient to know the nearest unit for a particular unit, and then the next and so on in rank order. For this reason the method is sometimes called multi-dimensional scaling.

Stepwise (Multiple Linear) Regression

This statistical technique measures the correlation between each predictor variable and, unlike multivariate techniques, the outcome variable. As an extension to the standard multiple linear regression, stepwise selection techniques compare each variable to its ability to predict or explain the desired outcome. Predictor variables are sequentially added to and/or deleted from the solution until there is no improvement to the model. Forward stepwise variable selection methods start with the variable that has the highest relationship with the outcome variable, then select those with the next strongest relationship, that is, adds the variable that maximizes the fit. The backward elimination methods start with a model containing all potential predictors and at each step, drop those with the weakest correlation to the outcome, retaining only those with the highest correlation. The stepwise elimination methods develop a sequence of regression models, at each step adding and/or deleting a variable until the “best” subset of variables is identified. Note that the term “stepwise” is sometimes used vaguely to encompass forward, backward, stepwise, as well as other variations of the search procedure.

Analysts must be careful to avoid correlated predictor variables when using stepwise regression. Too many correlated variables in a scoring model can cause problems if an analyst desires to make judgments about the relative importance of the predictor variables used in the model.

Before applying any of the variable reduction techniques to the raw data set, variables that tend a priori to describe the same behavior are preferably grouped together. For example, all the variables that come from the credit bureau first are grouped, and a reduction variable technique is applied afterward.

Bayesian Network Learning

Bayesian networks are graphical models that organize the body of knowledge in any given area by mapping out relationships among key variables and encoding them with numbers that represent the extent to which one variable is likely to affect another. The key advantage of Bayesian Networks is their ability to discover non-linear relationships. By examining the network, it is possible to immediately determine which Decision Keys are most relevant to predicting Intermediate Variables as well as when it may be necessary to account for correlation among Decision Keys and Intermediate Variables in future modeling.

Applying Advanced Statistical Analysis

When a data set has a reasonable number of variables, the analyst proceeds to the next step of the exploratory data analysis, consisting of applying different techniques that identify relations, trends, and biases hidden in unstructured data sets, as follows.

Graphical Data Exploration Techniques

Beyond histograms and box-plots there exist a wealth of advanced visualization approaches the can yield insight into the structure in data. These techniques are often useful not only before more quantitative modeling, but also after to evaluate how models map Decision Keys to Intermediate Variables or even decisions.

Brushing

Historically, brushing was one of the first techniques associated with graphical data exploration. It is an interactive method for highlighting subsets of data points in a visualization. It should be appreciated that the brushing approach is not limited to scatter plots and histograms. Software exists that allows brushing in 3D plots, parallel coordinates plots, geographic information plots also known as maps, etc.

Parallel Coordinates Plots

A traditional two variable scatter plot shows variables in orthogonal coordinates.

Another alternative is to show data in parallel coordinates. The primary advantage is the ability to visualize in multiple dimensions. In an example, each variable is plotted along one of the vertical bars. With respect to the data table, a record or case is represented by a path across the variables in the plot.

This technique is particularly useful for understanding the dynamics of predictive or decision models. Imagine that the last variable represents a dependent variable in a model and the others represent the independent variable. By highlighting the points of the dependent variable, it is possible to display all of the combinations of independent variable values that result in this prediction. Similarly for a decision model, selecting a decision can allow a user to visualize all of the combinations of values of the Decision Keys that resulted in that decision. Even further, the optimal decisions and Decision Keys are plotted with the approximate decisions from a strategy tree. Such technique is used to understand which Decision Key to optimal decision relationships are not captured well by the tree.

Other Graphical Exploratory Data Analysis Techniques

Many other visualization methods exist. Often an expert decides which plots are most useful for the task at hand. For example, a map is the best representation for traffic data that is relevant to deciding when to telecommute.

Other Advanced Exploratory Data Analysis Techniques

There are a tremendous amount of statistical techniques that the analyst can use to identify patterns in the data available in the literature.

Verifying the Results of Data Exploration

It is sometimes useful to verify the results of Data Exploration as is done when building quantitative models. The analyst can generate the same plot for a development and validation data set to validate that the relationships appear to exist in both.

It should be appreciated that for an analyst to attain such level of detail may not be necessary as Exploratory Data Analysis guides more formal modeling of the data.

Presenting Data

In the preferred embodiment of the invention, after data analysis is complete, analyses to be presented are carefully chosen and are integrated into overall pictures. Conclusions regarding what the data show are developed. Sometimes this integration of findings becomes very challenging, as the different data sources do not yield completely consistent results. While it is always preferable to produce a report that is able to reconcile differences and explain apparent contradictions, sometimes the findings must simply be allowed to stand as they are, unresolved and thought provoking.

Tools

The following tools may be provided in the preferred embodiment of the invention. It should be appreciated that a user has discretion over which tools to use, according to the particular implementation of the invention for the user's particular needs.

Commercial Statistical Tools

Commercial statistical tools have the advantage of being widely used and provide a large amount of functionalities to perform statistical analysis. For instance, these tools provide a relatively straightforward processing of different types of regressions such as linear, logistic, weighted least square, etc. These tools compute useful statistical indicators that allow the analyst to assess the reliability of the coefficients. Another main strength of these tools is the capability to manage very large data sets, which might be essential when dealing with millions of records.

MATLAB

Matlab is a programming language that was originally designed to compute formulas involving matrices. For instance, Ordinary Least Squares is a typical problem that can be solved very efficiently using Matlab. However, since Matlab has become incredibly popular, a great amount of libraries has been developed, emanating from both the Mathworks and the scientific community. Therefore, Matlab is suitable to solve a large range of computational problems.

S-PLUS, R

S-PLUS is a language and environment for statistical computing and graphics. To illustrate the combination of these two main features consider the following example: when performing a linear regression, a summary can be generated graphically that gives the analyst a great deal of information to assess the suitability of the model. Another advantage is that a user can specify different types of data structure and then proceed to the analysis. S-PLUS is similar to Matlab as a true computer language with control-flow constructions for iteration and alternation, and it allows users to add additional functionality by defining new functions. R is basically the open source version of S-PLUS and therefore has the great advantage to be free.

INFORMPLUS

INFORMPLUS is proprietary predictive modeling software used by Fair, Isaac and Company, Inc. to construct scoring models. It is unique in its ability to optimize an objective under a comprehensive set of constraints. With the exception of problem formulation, INFORMPLUS is designed to perform all the major steps in the model development process: data analysis and processing, variable selection, weights calculation, model evaluation, and model interpretation.

Predictive Modeling Wizard

The Predictive Modeling Wizard (PMW) is a fully integrated utility contained within Strategy Optimizer of Fair, Isaac and Company, Inc. As such, it uses the same data format and can be accessed directly when developing decision models within Strategy Optimizer. The PMW can be used to perform stepwise linear and logistic regressions and it provides visualization tools useful in assessing predictive modeling results and in performing exploratory data analysis. The visualization abilities available to the analyst allow interactive and iterative model building and data exploration.

Model Builder for Decision Tree

Model Builder for Decision Tree is a Fair, Isaac and Company, Inc., application that allows analysts to explore and mine historical data during strategy development. The analyst can use the statistical algorithms to identify the variables and their thresholds with the most predictive power for the performance variable of interest. The software allows performance variables to be selected and changed as the strategy is developed. It also accommodates hard coding of business logic. Because this is a Fair, Isaac and Company, Inc., application, it can export strategies directly to the TRIAD and Decision System execution engines, but is also compatible with other systems via XML and SQL exports.

Resources

In the preferred embodiment of the invention, typically, Data Exploration begins with the input of the entire Strategy Modeling Team. Senior members of the team that have experience in the business are able to provide guidance as to the activities that will benefit later stages. With this guidance, the analysis is performed by a consultant and the consultant's counterpart from the enterprise. The consultant preferably is skilled in the tools and techniques of Data Exploration as well as has the ability to focus the exploration for maximum benefit to Strategy Modeling. The expert in the business of the enterprise does not need to be a tools or techniques expert, but, preferably is very familiar with the data, business, and previous modeling efforts.

Improvement

The current sub-process for Data Exploration is fairly generic with respect to the goals of the exploration. Over time it is likely that the methodology, techniques, and tools will be focused on the tasks of gathering information for predictive modeling and gaining insights into the business process. Such focus allows for more clearly defined project management that will reduce the ad hoc nature of data exploration. It should be appreciated that although data exploration by nature tends to be an ad hoc activity, it does not necessarily follow the whims of the analyst. Rather it is aligned with the goals of Strategy Modeling.

Deliverables

The preferred embodiment of the invention provides a report regarding the usefulness of Decision Keys for predicting value drivers and a report about general insights gained about the business process.

### Decision Model Structuring

In the preferred embodiment of the invention, based on the established frame of the decision problem and the data analysis, the team builds the structure of the decision model. That is, the team determines variables used in the decision model, and how the variables are related to each other.

Inputs

In the preferred embodiment of the invention, input data includes
Decision and Alternatives from the Frame;
General understanding (definition) of value metric;
A set of candidate decision keys and intermediate variables as defined by the exploratory data analysis; and
General understanding (identification) of constraints.
   Outputs

The preferred embodiment of the invention provides output in the form of a decision model with specified structure.

Procedure

The preferred embodiment of the invention provides the following procedure for Decision Modeling. More specifically, it provides value-focused constructing of the structure of the Decision Model. This approach minimizes the risk of introducing unnecessary complexity that does not ultimately drive value. Before discussing the process further, each component of the Decision Model is discussed below.

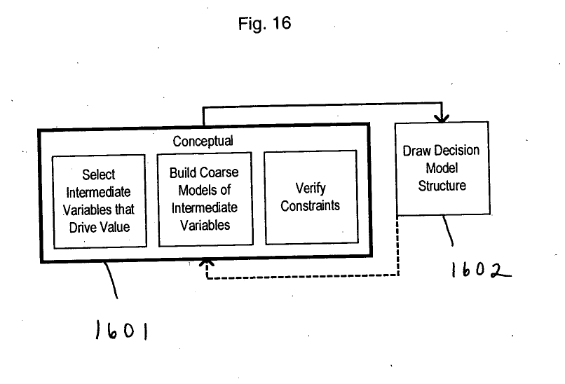

Referring to FIG. 16, the main components of the decision model structuring are conceptual 1601 to drawing the decision model structure 1602, described in detail herein below.

Decision Model Components

Objective Function

The objective function specifies what is optimized. Profit is the most common objective to maximize. However, if transaction cost is the objective function, then the goal is to minimize its value. Minimization is merely the maximization of a negative value. In the context of Fair, Isaac's Strategy Optimizer, the value node is the repository of the objective function.

Intermediate Variables

Intermediate Variables link the Decision Keys and the Decision Node to the Value Node. They are not the decision, objective, or constraints. Intermediate outcomes are dependent on the decision or the Decision Keys, but are not the final outcome. Intermediate Variables typically contain a formula or a lookup table.

Decision Variables

The Decision Variables contain all possible decisions that can be made, forming a state space. If some decisions are mutually exclusive, multiple decision variables preferably are used in building the model.

Decision Keys

Decision Keys are the explanatory variables or independent variables that usually come directly from the data set.

Constraints and Their Thresholds

There are two types of constraints, case level and portfolio level. Case level constraints apply at the level of the case or individual. They constrain the set of alternatives for a particular case. Portfolio level constraints set thresholds that need to be satisfied at the portfolio level. For example, the total loss can not exceed $10 M.

Arcs

Arcs represent relationships among the variables. In most cases the relationships are causal, although not a necessity. Arcs between variables can represent a purely mathematical relationship as well.

Select Intermediate Variables that will Drive Value

Many potential drivers of value are uncovered during framing. Before finalizing the equation used to compute value it is important to understand the potential impact of each of the drivers. Recall that the drivers are uncertain quantities (Intermediate Variables). It may be the case, however, that no matter what value the variable takes on for a particular case the decisions are the same. This fact presents an outstanding opportunity to remove unnecessary complexity from models by eliminating candidate Intermediate Variables that represent uncertainties that ultimately do not drive value in a significant way. Sensitivity Analysis and the Tornado Diagram are tools that can be used for eliminating insignificant candidate drivers. See the tools section below.

Develop Coarse Models of Intermediate Variables

Intermediate Variables can depend on three things, other intermediate variables, decision keys, and decisions. These dependencies are encoded as arcs in the structure of the Decision Model. Before the structure of the Decision Model is determined, models for Intermediate Variables are roughly sketched. The goal is not to develop the best predictive models for each Intermediate Variable. The goal is only to prune the set of candidate Decision Keys and to understand (identify) most of relationships among Decision Keys and Intermediate Variables. A process for developing the best predictive models is outlined in Decision Model Quantification herein below.

Verify Constraints

Framing often uncovers constraints for the Decision Model. In one embodiment of the invention, the strategy modeling team verifies portfolio level and case level constraints with sufficient detail for defining them in Fair, Isaac's Strategy Optimizer. Constraints preferably are not included in the first iteration of modeling, because such constraints may confound any abnormal behavior in the model needing to be identified early.

Draw Decision Model Structure

The final step is to encode or draw the structure of the decision model. Such process is mechanical.

It should be appreciated that Strategy Optimizer is by way of an exemplary optimizer only, and that any other non-linear constrained optimization tool can be substituted to provide the same intermediate results.

Tools

The following tools are provided in the preferred embodiment of the invention. It should be appreciated that a user has discretion over which tools to use, according to the particular implementation of the invention for the user's particular needs.

Sensitivity Analysis

Sensitivity analysis is a technique that is used to understand what uncertainties most significantly affect the value of each alternative in the decision. Specifically, it determines the potential impact of each uncertainty on the value equation. In its basic form, it ignores interactions between drivers.

According to Matheson & Matheson, for each continuous candidate driver “estimate three values: a low value at the 10^{th} percentile (a 1 in 10 chance the variable falls below this value), a high value at the 50^{th} percentile (a 1 in 10 chance the variable falls above this value), and a medium or base value at the 50^{th} percentile (an equal chance the variable is above or below this value).” For each categorical driver, specify a base case.

For each driver, use the value equation to compute the impact on value of the low, high, and medium cases, i.e. assume that all other drivers are at their medium or base value and evaluate the equation for the low, high and medium cases.

Rank the drivers according to their impact.

Remove any terms in the value equation to which the value metric is not sensitive.

Tornado Diagram

A Tornado Diagram is a way to visualize the ranking of sensitivity analysis. The range of possible outcome, based on varying each driver across High, Medium, and Low while holding the other drivers at Medium, is plotted. An excellent example is provided in Fair, Isaac's white paper “Decision Analysis: Concepts, Tools and Promise,” by Zvi Covaliu.

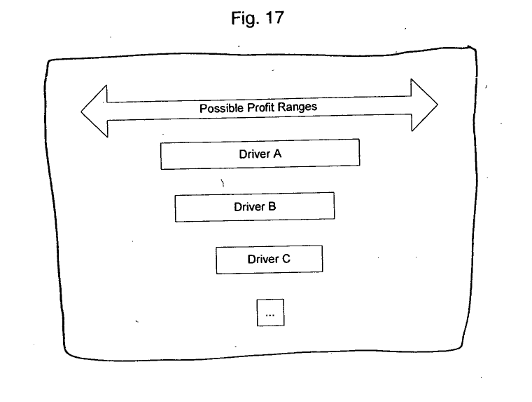

FIG. 17 is a schematic diagram of a tornado diagram according to the invention.

Resources

Decision Model Structuring begins with the entire Strategy Modeling Team and guidance from the Decision-Maker as to the enterprise values. The lead consultant preferably is proficient in modeling value mathematically so that the consultant facilitates discussions with the team about the value function as models are created and refined. The lead also is capable of teaching the team about value and the uncertainties that affect value after a decision is made.

In one preferred embodiment of the invention, a consultant or analyst that is also Strategy Optimizer expert handles the mechanics of the process. Such analyst often works closely with a peer from the enterprise to showcase the process.

Improvements

Some parts of Decision Model Structuring may require specialized tools. For example, sensitivity analysis for refining the value measure can be performed manually in Strategy Optimizer, but software analysis tools may save the analysts significant time and effort. The preferred embodiment of the invention provides for, as the first few Strategy Modeling engagements are executed, attention paid not only to performing the task at hand, but, also to investing in developing tools that will further streamline Decision Model Structuring.

Deliverables

The preferred embodiment of the invention provides a report on the structure of the decision model that describes the variables considered, variables included, and why.

### Decision Model Quantification

The preferred embodiment of the invention provides steps to finish encoding the Decision Model and for validating the Decision Model, as described herein.

Inputs

In the preferred embodiment of the invention, input data includes structure of the Decision Model encoded.

Outputs

The preferred embodiment of the invention provides output in the form of a complete Decision Model and a report discussing model validity.

Process

The preferred embodiment of the invention provides the following procedure for Decision Model Quantification. Three tasks remain in building the decision model. One, develop and validate models for Intermediate Variables. Two, fill each node of the Decision Model with the appropriate models, formulas, or constants. Three, validate the Decision Model so that the Strategy Modeling Team is comfortable with the dynamics of the model and the quality of the decisions it makes.

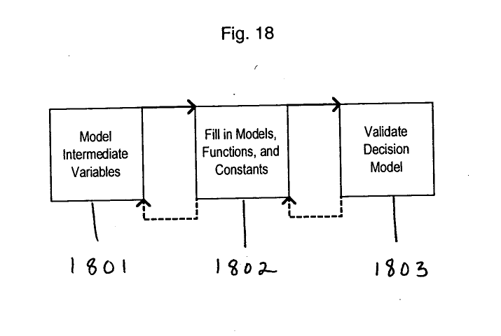

Referring to FIG. 18, three components of the quantify and validate decision model module are model intermediate variables 1801, fill in models, functions, and constants 1802, and validate decision model 1803 described in detail herein below.

Model Intermediate Variables

In the first iteration of modeling, it may be sufficient to use the coarse predictive models that were developed to specify the structure of the decision model. If such is the case, there is no need to again model Intermediate Variables. If more refinement is desired in the models of Intermediate Variables, then the process below is recommended.

Refinement preferably is done when an initial pass through Strategy Creation and Strategy Testing indicate that certain predictive models in the Intermediate Variables are important to the behavior of the decision model. That is, the decision is sensitive to the variables. Such models are then refined.

Partition Data

Data often needs to be partitioned for validating the model and for separating out sub-populations that have different behavioral drivers. Historically, research has shown that it is best to build separate models for sub-populations when the independent variables and/or interactions among the independent variables are vastly different for each of the sub-populations.

In the preferred embodiment of the invention, for validating and comparing models, data is divided into two sets, a set for model development and a set for model validation. The development data is used to calibrate the models. The validation data set is used to evaluate the degree to which the model(s) over-fit the development data set. Over-fit refers to a model that reflects too many of the specifics of the development data set, yet does not model well the population in general.

It is common for the cases to be distributed evenly between the development and validation data sets. In contrast and as an example, suppose that the division is made 90%/10%, instead. If the model performs well on the validation data set, then who is to say that the good performance is not due to a particularly lucky selection of the 10%. If half of the data is not sufficient for the development set, then preferably a cross validation scheme is used.

Build Models

A number of classes of models can be used for prediction. Such often include additive models, decision/regression trees, neural networks, support vector machines, and Bayesian networks. Most modern tools allow for the simultaneous fitting and comparison of multiple classes of models. This is extremely useful as no one class of model outperforms all of the time. Classes of models are discussed below.

It should be appreciated that some of the highest quality models often come from blending the information contained in data with the knowledge of a Subject Matter Expert. Organizations are often averse to using models that are not backed by data. When sufficient data is available, it should be used. When there is not enough data or when it is believed that the data does not reflect the population well, Subject Matter Experts can contribute their knowledge to the models. It is often useful to begin by building models from data and then make the necessary adjustments or augmentations with the advice of the Subject Matter Expert.

Regression

Non-Linear, Ordinary, and Weighted additive models are the most common methods to model continuous phenomenon. Such models are fit using least squares optimization, and are used broadly in models that are already in the production stage.

It should be appreciated that least squares techniques are considered extremely useful as a modeling tool for the analyst to quantify continuous nodes in the decision model.

Additive models are often used because they are so easily interpreted. A positive weight (coefficient) for an attribute contributes to increase the performance variables, while a negative weight decreases it, when the relationship makes sense. However, the additive model does not do very well at capturing underlying interactions. Therefore, characteristics for additive models capture such interactions explicitly in the preferred embodiment of the invention. Such characteristics include variables measuring: percentage of utilization, percentage of utilization on newly opened trades, percentage of utilization on non-retail trade lines, balance on delinquent trade lines, etc.

In this way a model of the following form is used:
Y=μ₀+μ₁X1+μ2X2+μ3X3+ . . . +μnXn+e

However, each predictive characteristic may have a more complex meaning such as:
X4=(X1+X2)/X5
   Logistic Regression

Logistic regression is suitable to model probabilities of a dependent variable that is categorical, e.g. good and bad, while the predictor variables can be continuous or categorical or both. This method is appropriate for modeling binary outcomes. The usual objective is to estimate the likelihood that an individual with a given set of variables will respond in one way, or belong to one group, and not the other.

The multinomial logit model, which is a generalization of the logistic regression analysis, provides a solution for a categorical dependent variable that has more than two response categories.

Although unusual, there can be some discrete variables downstream from decision keys and decision node. This is possible if and only if all predecessors are discrete as well. In such cases, it can result in a large number of cells that need to be filled, i.e. the number of states of the node multiplied by the number of states of all parents.

Pivot Tables

Pivot tables are useful for determining the probability distribution of discrete variables. One useful technique is to build pivot tables using the historical data provided by the client. However, because pivot tables can only cover the combinations of states that occur at least once in the data set, they are meaningful only if the amount of the state's combinations is limited. For a large number of combinations, many cells may be empty and others based on a few records. It can be totally misleading when those few records are outliers because they are given the same weight as probabilities based on thousands of records that provide real predictive power.

Bayesian Network Learning

Bayesian Network learning comes in two flavors, general networks and Naïve networks. Naïve networks are often excellent predictive models for a single variable. General networks do not focus on predicting any one variable, but provide an overall model that displays the dependences among variables. General networks are more useful for selecting variables than for making high-quality predictions.

Compare Models

There are a number of common metrics that can be used to compare candidate models and evaluate their quality. Some metrics are abstract and measure how well the model encodes the information in the data. Other metrics are concrete and aim to judge the performance of the model in a task, such as classification. In general, preferably both types of metrics are used during model validation. When comparing models, it is imperative that the comparison be based on the Validation data set to evaluate the effects of over-fitting:
Qualitative (Coefficients, Parallel Axes Plots, Interactive Models);
Quantitative Performance (RoC, Confusion Matrix, trade-off curves, holistic profit curves); and
Quantitative Abstract (divergence, KS statistic, Cross Entropy).
   Enter Formulas and Constants

In the preferred embodiment of the invention, when the Intermediate Variables and the models encapsulated in them are sufficiently refined, the formulas and constants are entered into the Decision Model. It is important to consider the order of the nodes when quantifying the Decision Model, because quantifying a node with arcs incident on it requires the quantification of the nodes at the other end of the incident arcs first. Following are some general recommendations.

First, quantify the Decision Nodes by entering the alternatives. Remember that almost always a default or status-quo alternative needs to be encoded as well. The set of possible actions or state space must be provided at the very beginning of the process when framing the decision situation.

Second, quantify the Decision Keys by mapping them to the appropriate development data set. Decision keys are continuous or discrete.

Third, quantify the Intermediate Variables. Start with the Intermediate Variables that have no arcs incident on them or with the Intermediate Variables that only have arcs incident from Decision Keys. Traverse the Intermediate Variables in the direction of the arcs, encoding the variables along the way.

Fourth, specifically enter the expert assessments on the predictive models that have been developed.

Fifth, encode portfolio and case level constraints with their appropriate thresholds.

Remember that it is not recommended to add constraints in the early iterations.

Finally, quantify the Value Node with the value equation.

Also, perform adequate checking to ensure that no errors have been made.

Validate the Decision Model

In the preferred embodiment of the invention and in the ideal case, all of the alternatives have been tried before and sufficient data is available to measure the results of each alternative. In this case, the same type of validation techniques can be applied to validate the Decision Model as were used to validate the predictive models. Decisions are made for a validation data set and the total value is computed.

Most of the time, sufficient data is not available, either because results of past decisions were not tracked or new alternatives are generated for which there is no historical data.

Another technique is Historical Validation, referring to the process of verifying how well the decision model can reproduce the historical strategy. Strategy Optimizer produces projections on the historical strategy as one of the potential reports. This process can also be done outside of Strategy Optimizer with a different programming language. The next step compares all the variables that appear in the calibration model with the actual historical values. This is a very powerful way to assess the quality of the entire decision model, as well as whether or not the action based predictive models are well specified. Indeed the differences between historical values and predicted values (if any) can be immediately identified. Therefore, effort is concentrated on variables that do not match, meaning that the analyst may have to return to the previous stage, eventually modifying the structure of the decision model.

At this point, it should be appreciated that the design of a complex decision model typically is an iterative process until a satisfying level of accuracy is reached.

Resources

According to the preferred embodiment of the invention, Decision Model Quantification mostly requires the efforts of a task manager consultant and a peer from the enterprise supervised by a lead. The consultant works to build, validate, and enter predictive models into the decision model. Often, the consultant leverages the experience of the peer in the enterprise having experience in modeling the data. When the knowledge of a subject matter expert is required, a lead may be called upon to facilitate the elicitation of model parameters from the expert.

Improvements

Recall that Decision Model Quantification is likely to happen many times in an engagement as models are iteratively refined. Thus, preferably the modeling process is captured (source code, etc.) so that the modeling on a particular project is repeatable.

Currently, predictive modeling is often performed in a separate environment from the decision model construction. Ideally, these two activities are interwoven in a software application. Another possibility is the close integration of the Model Builder tool into these processes.

It should be appreciated that for Strategy Modeling projects, a standard set of reports preferably is reviewed for every candidate predictive model. Software can streamline the preparation of data, the creation of models, and the reporting of model quality. Predictive models preferably are stored in a library so that across engagements, the commonality can be leveraged.

Deliverables

The preferred embodiment of the invention provides a report summarizing the assumptions made during modeling as well as a description of the decision model.

### An Exemplary Score Tuner

The preferred embodiment of the invention provides an exemplary automated model updating and reporting system, referred to herein as score tuner.

Background

Given an existing model or set of models and a desire to keep the model(s) up to date with the most recent data, or tailor the model(s) to individual populations, the only previous options were to rebuild the model(s) or apply alignment factors.

Rebuilding the model is a labor and time intensive process. Attempts have been made to simplify the process, such as in Fair, Isaac's Data Modeling Service and Response Modeling Service, but extensive project management and data processing support have still been required.

Applying alignment factors is an adjustment that usually results in only minor performance improvements. The main benefit of alignments is in keeping odds-to-score relationships constant thus easing model usage. They do not improve the rank ordering capability of a single model. They only improve rank ordering on systems of multiple segmented models and even then, the improvement is limited to the overlapping regions of the population.

As a result of these constraints, models often go without an update or with only alignment updates for extended periods. In addition, the cost of full model developments is often not justified for populations that might benefit from custom models. In such cases, compromises are made in terms of using models not developed specifically for an individual population.

Scoring Model Overview

The preferred embodiment of the invention creates the capability to deliver self-updating scoring models as components of decision environments. Some generic features of such component are:
data awareness;
triggering rules;
model history retention;
self-guided model development;
tight connection to decision engine; and
execution and analytic audit trails.

According to the preferred embodiment of the invention, users interact with a server that handles tuning parameters and runs a scripted model optimization engine, such as Fair, Isaac's INFORM engine. The model optimization engine generates the new models and evaluation reports.

Tuning parameters include sample sizes, population definition, and whether the tuning is manually initiated or triggered on a set schedule. In some contexts, most or all tuning runs and manually initiated. For example, tuning marketing response models likely require the definition of population to change with each tuning run. In other contexts, periodic scheduled runs might be appropriate.

When a tuning run is triggered, the user reviews the results and either accepts and deploys the update or rejects it. Model deployment in the current implementation is through XML, an emerging industry standard for data exchange.

Score Tuner

The preferred embodiment provides a score tuner that periodically tunes the score weights in the published (implemented) scorecards.

Preferably, score tuner is based on existing scorecard development software. In addition, an equally preferred embodiment of the invention provides a simple framework for the first, second, and fifth bulleted items above.

Decisioning Client Configuration

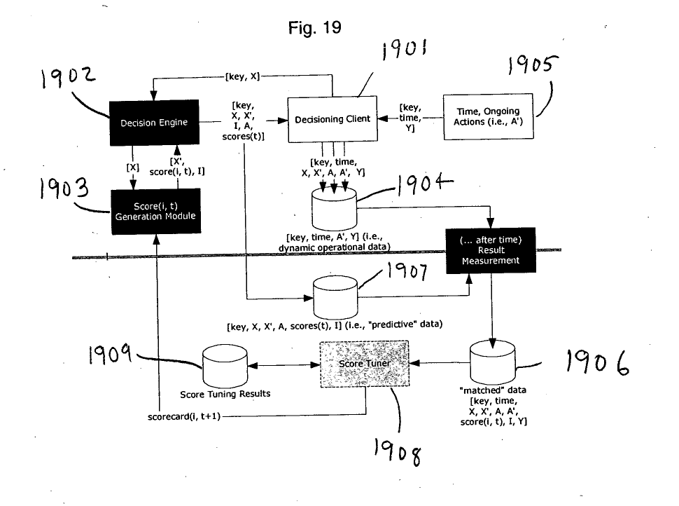

FIG. 19 is a block diagram of a decisioning client configuration including a score tuner component according to the invention. A decisioning client 1901, e.g. for example, application processing or account processing system, supplies some data, X, for a customer identified by key to a decision engine 1902 and asks for a decision. The decision engine 1902, such as for example Fair, Isaac's TRIAD™, DecisionWare™, or strategyWare™, through a sub-process such as the score generation module 1903, e.g. DecisionWare™ or ScoreWare™, generates needed transformations of X, i.e. X′, and one or more scores (score(i, t)) based on the score weights of the i^{th} scorecard(s) at time t. The decision engine applies pre-specified decision rules and strategies using X, X′, and scores(t) to generate a vector of recommended decision actions (A). The decision engine returns the requested data, the transformations, the scores, information about the scorecards (I), and the recommended actions to the decisioning client 1901. The decisioning client optionally implements the recommended actions A and stores the results into a data store 1904. The decisioning client may take additional (non-score-based) decisions (A′) 1905 over time. The decisioning client also monitors and records periodic signals from the customer as well as the general environment. Over time, the decisioning client gathers data (Y) about the customer (key) that helps determine one or more outcomes of interest. A particular asynchronous process (controlled by the run-time environment or the score-tuner process) periodically triggers the preparation of a “matched dataset” from “recent” information about the customer 1906. The results are appended to the growing store of predictive+performance data records 1907. The score tuner process 1908, based on its own triggering mechanism (optionally driven by the user or by a rule database), periodically takes the matched dataset 1906 and produces (if appropriate) score weight updates of the active scorecard(s) 1909. See below for details of such process. The scorecard is installed into the score generation module 1903 after a review, preferably a recommendation, by a human.

Score Tuner Configuration

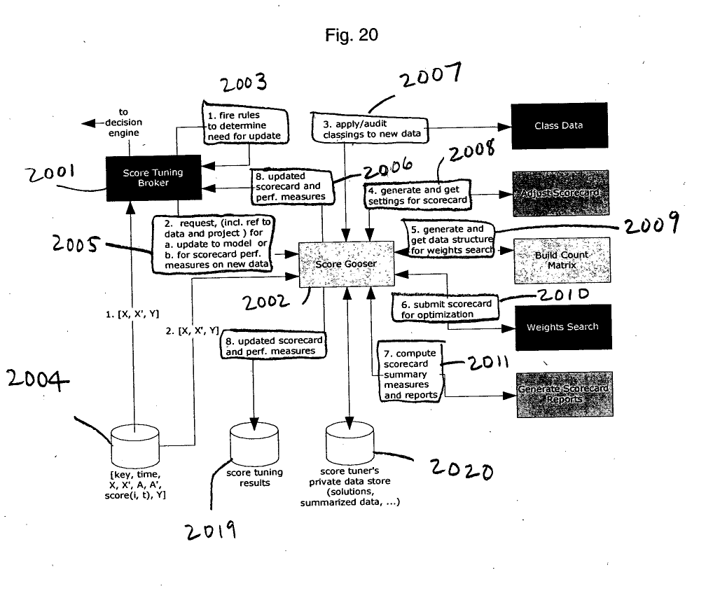

FIG. 20 is a schematic diagram of the score tuner sub-system according to the invention. Score tuner is comprised of two major modules, score tuning broker 2001 and score weight engine 2002, described in detail as follows.

Score tuning broker is responsible for the administrative tasks associated with updating of score weights. The score tuning broker:
determines which scorecards are candidates for tuning 2003:
checks if user has flagged any operating scorecards for updates; and
at a pre-specified and parameterized time frequency, determines from a rule database which scorecards are up for a possible score weight re-tuning;
extracts the needed dataset sub-population 2004 based on rules determining what sampling window and stratification the current scorecard needs;
for scorecards that are candidates for re-tuning for the current time stamp:
requests the generation of a dataset to be used for tuning it; and
determines what score weight engine project is associated with that scorecard;
passes a reference to the dataset and the project id 2005 to the score weight engine and requests metrics of scorecard performance (divergence, jack-knifed divergence estimate, score distributions) from the score weight engine 2006; and
determines whether updated version is better.

The score weight engine is responsible for all activities related to scorecard results and score weights. The score weight engine:
reports on an existing scorecard's development measures (divergence, jack-knifed variance of divergence, score distributions by percentiles);
computes a scorecard's performance measures on a new sample 2011;
audits new predictive data to ensure that the settings are adequate to cover the data values encountered in the new data 2007;
creates a new scorecard version of the scorecard being tuned 2008;
converts the raw records in the new predictive dataset into the coarse classed records needed for building weights (sets previously unknown values to no inform) 2009;
builds and scales score weights of the newly created scorecard given the new predictive data 2010; and
archives the newly built scorecard and its performance measures 2019 and 2020.
   Use Cases

Several use cases suggest situations that show how score tuner operates, as follows. Assume the score tuner is delivered, installed, and connected as described above:

Install a New Scorecard into the Score Generation Module:

log onto the system;
create a new project for the scorecard;
access the initial predictive dataset;
establish the performance, sample weight, and characteristics to use;
class performance and the characteristics;
build a scorecard;
if acceptable, set the scaling parameters and scale the scorecard;
save the project; and
publish the scorecard to the score generation module.
   Forced Update of a Scorecard:
invoke the score tuner broker user interface;
open the project that contains the scorecard of interest;
verify the data window to be used is appropriate;
execute the update (score weight engine automatically increments the version number of the scorecard);
review the results;
if acceptable, publish the new version of the scorecard to score generation module; and
save project.
   Stablish Periodic Update of a Scorecard:
invoke the score tuner broker user interface;
identify the project that represents the scorecard that is to be periodically updated;
specify time interval at which the update will be attempted;
specify the (age-based) query criteria to use to extract the predictive data for the update;
specify the warning and error thresholds for attribute counts that should be used when performing an update;
specify scorecard “improvement” criteria for example:
minimum improvement required for new version of the scorecard to replace the published version where the improvement is:

$$\frac{div ( {scorecard}_{new} , {dataset}_{new} )}{div ( {scorecard}_{published} , {dataset}_{new} )} - 1.0 ;$$
percentage of characteristics for which marginal contribution increases;
improvement in percentage of a principal set passing at a given score;
improvement in percentage of a principal set passing at a given aggregate pass rate; and
save project.
   Execute Periodic Update of a Scorecard:
time daemon activates score weight engine at the time frequency specified in the above use case;
score weight engine opens the project for the scorecard to be updated;
score weight engine accesses the predictive dataset that has been (presumably) refreshed since the last version of the scorecard was built;
score weight engine retraces the following steps with the new predictive dataset:
applies the pre-established classings to the variables in the new predictive dataset;
creates a new version of the published scorecard; and
build the new version of the scorecard;
if results are acceptable given the “acceptability criteria” (e.g., divergence of new version is X % better than the divergence of the currently published version), publish the new version; and
save project.
   Periodic Update of a Collection of Scorecards.

It should be appreciated that in one preferred embodiment of the invention Score Tuner evolves an existing scorecard by either 1) modifying its score weights, or 2) changing the alignment parameters for the score produced by the scorecard. The underlying structure of the data, i.e. scorecard characteristics, scorecard classings, and constraints placed on the weights is not expected to be different from the original implementation definition.

Detailed Description

Introduction

The preferred embodiment of the invention seeks scenarios of the modeling process that are narrowly targeted and need less complex software components. Such an instance occurs in the case of score weights updating, in which new weights, are derived for a scorecard containing a designated set of score characteristics, some acting as place holders with zero weights. Alternatively, instead of generating new score weights, the tuning needed is only to adjust the alignment parameters (slope and the intercept of the predicted log of odds as a function of score). ScoreTuner, or score weights updater, is a configuration of software components for this purpose.

Business Requirements

As background, in the preferred embodiment of the invention, scorecard(s) are typically implemented at: 1) information or service bureaus, or 2) in software at clients' data centers. To get the most from the service-based scoring scenarios, it is desirable to keep the outcome prediction finely tuned and calibrated. This means being able to update the scoring models more rapidly than via a long and comprehensive development process.

The scorecard tuning process assumes that much of the context in which the scorecard(s) sit does not change. That is, the data structure of the predictive data, scorecard's model structure, and the implementation environment remain the same. Only the actual score weights or the calibration of the predicted odds vs. score relationship change to reflect drifting relationship between the outcome and the predictors. The drift is captured in periodic snapshots of data that do not change in their structure.

Improve Analyst Productivity

It has been found through user interviews that this objective represented the following requirements for weights updating software:
Rapid Weights Updating/Tuning;
Rapid Score Alignment;
Seamless Export of Resulting Models to Common Decision Support Software, such as that by Fair, Isaac; and
Support a Production Environment.

Rapid Weights Updating/Tuning: Such implies automatically re-optimizing, evaluating, and scaling score weights for one or more scorecards given existing scorecard(s), and sample data with scorecard variables and defined performance. The degree to which the process is automated and the extent to which weights bullet-proofing is applied can be packaged to account for user's expertise and preference. The evaluation output from the process preferably provides sufficient information to satisfy the analyst of the model's performance and reliability. It has been found that the need for such a facility exists today primarily for scorecard updates, e.g. Fair, Isaac's Credit Bureau and CrediTable models. Rapid weights updating can also be applied for custom models existing out in the field, where tuning or regular maintenance, rather than overhaul, is desired. In this discussion, the definition of rapid modeling excludes performance inference, although it could eventually be packaged as well. To enhance ease of use, the ability to automatically update multiple models for multiple segments of a population is also desirable.

Rapid Score Alignment: A simpler instance of rapid modeling is scorecard alignments or re-scaling. Rapid score alignment means scoring out a sample of the scorecard population, determining the current relationship between outcome and score, adjusting the model scaling parameters, and providing a report of the fit. To a greater degree than with rapid weights updating, the ability to re-align multiple models on mutually exclusive segments of the data automatically is desirable. Ideally, this functionality resides close to the necessary alignment data such that it can be carried out automatically at the customer's site using account level records rather than at a task manager's site, such as Fair, Isaac using summarized data.

It should be appreciated that weights updating can take the form of new weights or simply score re-alignment.

Intelligent Software

The preferred embodiment of the invention provides a range from a null set of weights to automated and intelligent variable selection, classing, model building, scaling, and evaluation. The most frequently anticipated scenario is the automated validation of the newly developed weights for a fixed set of characteristics against the previously developed weights on the same characteristic set. Another likely scenario is the automatic re-alignment of a set of scorecards to scale to the same odds. The intelligence may take on different forms depending on user preference or business application. Depending on the customer's level of sophistication, the customer may want a detailed set of reports to assuage concern about a new scorecard. Other customers may want an automated task manager seal of approval on the new set of weights.

The preferred embodiment of the invention provides ease of use. Such implies the capability of specifying the updating or re-scaling of many models at once. This is especially true in the case of alignment. It is preferable to provide the capability to specify a schedule for automatic scorecard updates and scaling, which implies the integration into current decision support systems.

Scope

Score tuner preferably provides data analysis in the context of how the score weights and alignment parameters change. Accompanying report sets typically are limited to weights evaluation reports. Score tuner is assembled in one of two ways: as a stand-alone module that provides new weights for a customer's decision support module, such as Fair, Isaac's Decision Support Module or as a component within such module.

Desired Features

This section discusses the user requirements in detail:
How external data are imported into Score Tuner and data related issues;
Modeling;
Reporting and graphing; and
General issues spanning above categories.
   Data Issues

In this context, data refers to data sets of records that:
Are of the same structure (constituent variables and their data types) as expected by the scorecard(s) being tuned;
Have scorecard characteristics whose values are completely addressed by the attribute definitions in the scorecard, i.e. no out of range or domain failures;
Have the performance already defined;
Contain records of a vintage appropriate for the scorecard being tuned; and
Optionally, keep historical library of previously generated score tuning samples, whether used or unused in previous scorecard tuning.

Some auditing preferably is provided to validate the data/variable structure defined by the user and that expected by the scorecard being tuned.

Support is provided for conditional extraction of data from the large data tables to support multiple model updates and alignments and the training/test/validation sample extraction. It should be appreciated this includes support for multiple model updates from a single data source with unique conditional extractions for each model, as opposed to requiring individual data sources for each model.

Modeling

Score Tuner assumes that performance definition and data analysis have taken place and are represented in the form of a sample with a defined performance variable and a set of scorecard characteristics (with null or existing scorecard weights and score alignment parameters). The scorecard maintains attribute classings. The modeling functionality preferably includes:
Importing of existing scorecards from decision support software;
Auditing for legal values for the scorecard characteristics in the new data set;
Generation of all summarized data in preparation of the tuning process including:
Classing of the values in the variables of the data records into those expected by the scorecard characteristics;
Generating all summarization needed to run the proprietary algorithms, such as Fair, Isaac's INFORMPLUS from the newly provided predictive data set and, possibly, previously summarized results from past tuning runs; and
Displaying some summary statistics of the records encountered;
Specification of expected scaling parameters;
Running of algorithm, such as INFORMPLUS to generate new score weights for the scorecard characteristics;
Running of evaluation procedures on the newly tuned weights: this includes multiple evaluation measures and their variance (generated via jack-knifing or boot-strapping);
Displaying a scorecard and its evaluation results;
Fitting of log odds vs. score to determine the expected odds by score;
Adjustment of alignment parameters (slope and intercept of the log odds vs. score line) to match the user supplied expectation;
Exporting of the tuned model/alignment parameters:
In a format acceptable to decision support software;
While maintaining version control for the scorecard(s) in case an upload needs to be rolled back; and
Ability to sequence any of the above mentioned steps (to implement, for example, tuning of multiple scorecards together).
   Reporting and Visualization

The Score Tuner reporting and visualization capabilities provide summarized views of the new score variable and scorecard characteristics for the purpose of model evaluation. Each view preferably includes a comparison of old weights versus new, where applicable. Potentially allow for subsetting of data by defined bins (attributes) of scorecard characteristics. The proposed collection of report sets includes:
Score weights tables;
Statistic summary reports, e.g. divergence, ROC Area, . . . ;
Score distribution tables (binned score by performance) and graphical versions of the same, e.g. trade-off curves, score histograms, log odds vs. score plots:
by old model vs. new model on same data;
by aligned model 1 vs. aligned model 2 vs. aligned model N on their respective data;
by attributes of any given scorecard characteristic; and
by arbitrary subsets of the data set; and
Scorecard characteristic tables (binned characteristic by performance) and graphical versions of the same, e.g. characteristic frequency distributions, binned characteristic by summary (y).

The user interface for the resulting graphs preferably encompasses generic formatting operations such as scaling, labeling and coloring, and graph management capabilities (interactive or batch report creation, printing and archiving).

Proposed Functionality Partitioning

Score Tuner takes advantage of the flexibility of configuration and enhancement provided by the concept of business components, where each component encapsulates a major piece of functionality, such as task manager functionality. Components are proposed in a new configuration with streamlined functionality.

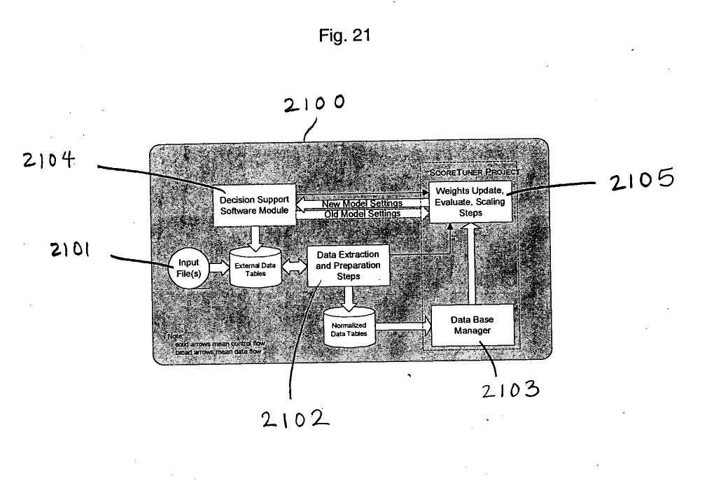

FIG. 21 is a block diagram of a context 2100 for Score Tuner according to the invention. All raw file management takes place outside of Score Tuner. A sample data file 2101 with a defined performance is prepared for use 2102, and is accessible from within Score Tuner by the Data Base Manager 2103. The previous model or existing scorecard can either be read in directly from decision support software 2104 or specified from inside the Score Tuner. The resulting updated weights 2105 are output back to the decision support software 2104.

Proposed Business Components

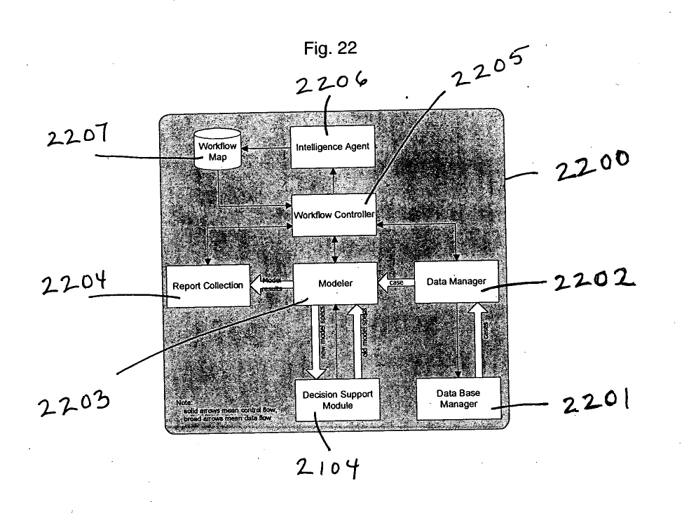

The preferred embodiment of the invention provides the following components as shown in the configuration map 2200 of FIG. 22:
Data Base Manager 2201: Manages collection of cases used in analysis. Provides a bridge to multiple possible input data files and/or database management systems.
Data Manager 2202: Provides data records to other data analysis components, such as Fair, Isaac's Modeler and Reporter, one case at a time in the event that these components are processing cases in a sample point loop. Exposes a data dictionary to other components. Allows posting variables generated in the analysis components back to the Data Base Manager for future recall.
Modeler 2203: Provides score weight re-optimization and log odds to score alignment functionality to the user. In one embodiment, constrains the set of modeling technologies to INFORMPLUS.
Report Collection 2204: Provides viewing, printing and limited editing of a standard set of model evaluation reports generated by the modeling process. It is preferable to provide model evaluation, such as Fair, Isaac's Report-Set, with capability of viewing in tabular and graphical form a series of Reports through a Report Presenter.
Workflow Controller 2205: Acts as a traffic cop among the multiple business components performing a set of actions that are implied by the user's specifications and eventually fulfills the desired data preparation, analysis, and/or presentation step(s). Optionally uses Workflow Maps 2207 to perform sequences of analytic actions.
Intelligence Agent 2206: Performs background checks on the results from user actions and provides suggestions if a query against its rule base returns a recommended intelligent action for the user to take. Rule base may range from no rules to an extensive collection of rules and recommendations governing score weights development and scaling checks.

Modeler, Report Collection and Intelligence Agent are described in more detail in the following sections.

Modeler

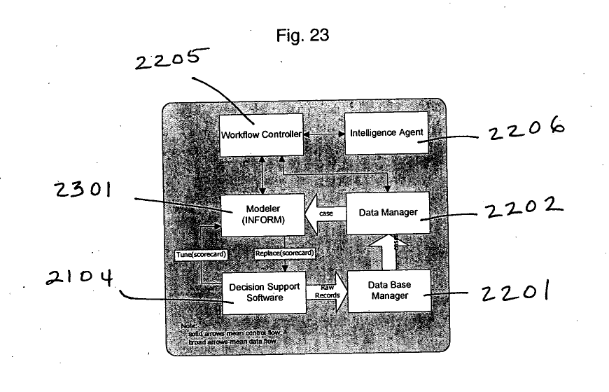

FIG. 23 shows a schematic diagram of how the Modeler 2301 interacts with other business components according to the invention. Existing scorecards can be imported directly from decision support software modules 2302, such as Fair, Isaac's Decision System into Modeler. In addition to a weights engine the Modeler requires services of a Summarizer component to perform some pre-processing and model evaluation, such as those of INFORMPLUS.

Report Collection

Reporting is similar to the Modeler in that it is a high level controller but all the hard work gets done in a number of lower-level specific Report components. A Report is the pre-counted data necessary to show the report. In this case, the pre-counted data structures for each pre-defined “series” for each model, is:
Vector of summary statistics (for binary or continuous outcome case);
Two dimensional matrix of cell counts:
Formatted variable by binary count and its transformation, e.g. WoE, Odds, fitted-log-of-odds, etc.; and
Formatted variable by summary statistic (average, sum, odds, etc.).

A Report Set preferably combines output of several Reports. Report Presenter displays results in tabular or low-density graphical form. For example, the result of a binary score alignment across multiple models is combined in a Score Alignment Report Set, and displayed either as an overlaid log of odds vs. Score line plot or table.

Intelligence Agent

The preferred embodiment of the invention provides intelligent behavior within Score Tuner, categorized into three different types:
Guided specification of analytic steps (similar to Wizards and Assistants in some of the office automation applications);
Reaction to interactive analytic actions with suggestions, via agents, for possible changes by the user (such as suggestions for alternative classing while doing coarse classing); and
Automated, intelligence assisted decision-making in a sequence of analytic actions.

The first item is implemented in the user interface. The second and third items are implemented via an intelligence server that has at its disposal a rule base. The rule base is used to make deterministic or expert system based (potentially probabilistic or fuzzy logic-based) decisions as a result of one or more analytic actions requested by the user. Intelligence implied by the second item stops and proposes alternatives to the user prior to the next user interactive action. Intelligence of the third item makes reasonable decisions and continues the execution of the sequence in a workflow map. The level of automatic decision-making is controlled by the designated proficiency level of the user.

At minimum, the first type of intelligence is provided. The extent to which other intelligence is provided depends on the level of bulletproofing provided the client. For example, when it comes to providing a weights evaluation rule base, nothing may be provided for internal analysts, a rule base returning red flags to certain clients, and an automated warranty for others.

### Strategy Creation

The preferred embodiment of the invention provides means for strategy creation as follows. After building and calibrating the decision model the focus shifts towards optimizing, analyzing results, and creating refined strategies to present to the client.

The preferred embodiment of the invention obtains a strategy or set of strategies the client feels comfortable testing. In the discussion below, the assumption is made that all optimization and strategy building happens within Strategy Optimizer, while it should be appreciated that any strategy optimizing tool can be used.

Inputs

In the preferred embodiment of the invention, input data includes the complete, validated decision model.

Outputs

The preferred embodiment of the invention provides output in the form of a set of candidate strategies to be tested and evaluated, and also, a presentation explaining the strategy, including charts and graphs prepared and given to the client.

Procedure

The preferred embodiment of the invention provides the following procedure for strategy creation. After the decision model is complete, the first step is to determine the variables to track (metric variables) during the optimization runs. Next, optimization settings are determined, including the portfolio to be optimized, the sampling scheme, and the parameters for the optimization algorithm. The portfolio may involve using prior probabilities, a development data set, or a client provided list of cases to optimize. The model is run and the results are used to evaluate the model for validity. After the team is convinced the model is running smoothly and giving good results, sensitivity analysis can be performed on the constraints as well as other variables of particular interest. Once the model is optimized over the correct domain with the correct constraints and giving good results, strategies are created. There are simple techniques for creating strategies and such strategies typically are refined after development.

During the running of the decision model it may be discovered that the model itself needs to be changed. The decision making behavior may not be capturing the essence of the business process, because, i.e. the model is an oversimplification. Formulas in the model may need refining or particular action-based predictive models may not be working well in conjunction with other models. Assessing changes in the model as well as performing sensitivity on the constraints requires rerunning the model many times over different domains.

When the strategies themselves are built, the client may desire specific changes or have aspects of the strategy with which the client is not comfortable, thus requiring possibly running more optimizations or revisiting the model.

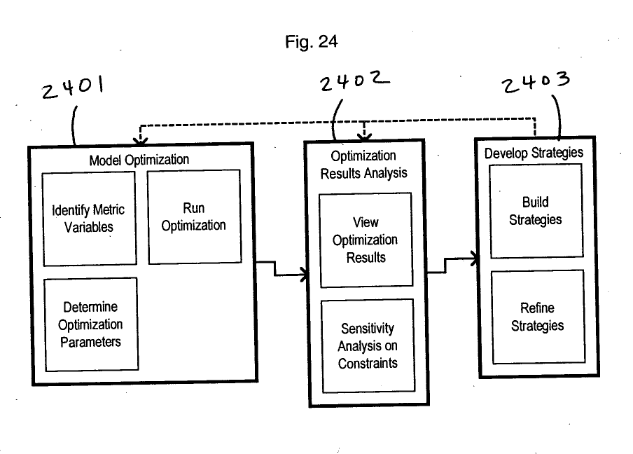

Strategy Creation according to the preferred embodiment of the invention can be described with reference to FIG. 24. FIG. 24 is a schematic diagram showing control flow and iterative flow between three components discussed in detail herein below: model optimization 2401, optimization results analysis 2402, and develop strategies 2403.

Strategy Optimization

The preferred embodiment of the invention provides the following steps for Optimizing the Model:
Identify Metric Variables;
Define Optimization Parameters; and
Run Optimization.

Identifying metric variables allows the analyst to track the desired variables, for example in Fair, Isaac's Strategy Optimizer. Running the model requires a series of parameters, i.e. a domain over which to optimize, which may involve using prior probabilities, choosing the samples per case, and setting the algorithm parameters. Once those parameters are set the optimization runs.

Metric Variable Identification

After a model is created and calibrated the team decides which decision keys and action-based predictors to display, for example in an output window. Each of the variables marked as a metric variable shows up in the output window. Variables not marked as metric variables don't display in the output window, and corresponding computed values during that run are not displayed. It should be appreciated that most times there is no harm in marking all computed variables as metric variables ensuring their values are computed correctly.

Optimization Parameter Determination

Computing an Optimized Strategy requires setting the following parameters:
Portfolio of Cases to Optimize Over;
How to Evaluate Each Case; and
Algorithm settings.

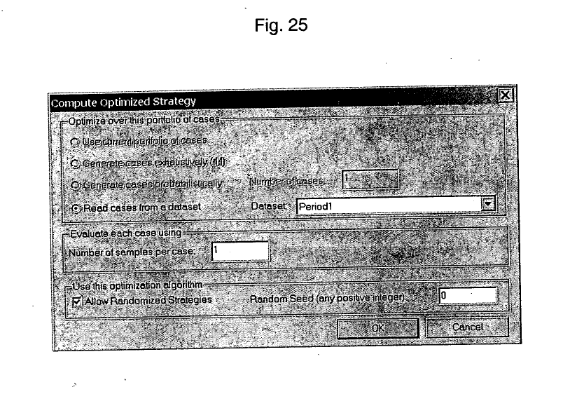

FIG. 25 is a screen print of a user interface window used for making such selections.

Various options are explained herein below. FIG. 25 shows that cases are to be read from the Period1 data set.

Portfolio of Cases to Optimize Over

The first step in running an optimization is determining the portfolio to optimize over.

Four choices are provided, such as those provided in the Optimization dialog box in Strategy Optimizer:

Use Current Portfolio of Cases

If the analyst previously ran Strategy Optimizer, then the most recent run is cached and by selecting this option one can run the optimization on the same data set again. This is useful when one is tweaking parameters, changing constraints, and using the same portfolio repeatedly. The hassle of having to reselect the portfolio each time the model is run is avoided.

Generate Cases Exhaustively

Generating cases exhaustively solves the problem for all possible combinations of the Decision Keys. The number of total cases is shown in parenthesis. Such is a good option when the model is small, on the first several iterations through a problem. When starting out, make sure the answers make sense for all combinations to ensure there are no major errors in the model or typos in the data entry process. This may also be the choice run at the very end of the model building process, when ready to build a final, implementable strategy.

Generate Cases Probabilistically

If the exhaustive cases are too many, then such cases are sampled probabilistically. The analyst enters the total number of cases to generate. This can be a good first step if still configuring a more complex model, and not wanting to spend the time optimizing over all the possible combinations.

Read Cases from a Data Set

Use this option if given a set of accounts the analyst specifically needs to optimize over. Also, this option is used if an analyst chooses to use prior probabilities and creates a data set with such prior probabilities.

One decision to make when optimizing is whether to optimize a particular portfolio of accounts or whether to use prior probabilities for the account distribution.

A prior probability is the probability that an account has those characteristics at the time the strategy is implemented, but before any action is taken on that account.

Using prior probabilities has advantages and disadvantages.

The first advantage is speed. If a data set has millions of records, but only a few decision keys, then many of those records are duplicates over the decision keys in the model. In most cases it does not make sense to compute an answer for both of those same accounts separately, because the answer is the same for each regardless. By creating a prior probability data set, the total number of accounts that are optimized are reduced by just specifying the distribution of the accounts over the decision key space.

The second advantage is flexibility. Optimizing over a particular data set gives answers only for that particular data set. Optimizing over a prior probability data set gives an answer for a population with that distribution. Also, there may be reason to believe the account distribution changes from the time of analysis to the time of implementation. By changing the prior probabilities, this belief is reflected in the developed strategy. Essentially this is performing sensitivity analysis on the population distribution to see how much this is driving the strategy.

The main disadvantage of using prior probabilities is not being able to use Random Strategies. See the discussion of using Random Strategies in the next section for further discussion. To assign different actions to accounts with the same Decision Keys, the accounts must have separate records in the input data set, which using prior probabilities does not allow.

How to Evaluate Each Case

When the analyst decides which portfolio to optimize, the number of samples for each case in that portfolio is decided. Recall that if a given set of Decision Key values is run through the decision model twice, then the Intermediate Variables may take on different values, and thus result in different optimal decisions. Thus there is a tradeoff primarily between accuracy and speed. The increase in time is roughly linear and a function of the number of samples. Therefore, sampling more takes longer, but produces more accurate results, because sampling more reduces the uncertainty.

When determining the exact number of samples, two approaches are provided; one approach is theoretical and the other approach is practical.

The theoretical approach looks at the degree of randomness in each of the decision keys. If a decision key is deterministic, then only one sample is required because the same outcome occurs with each sample from that variable. If a variable has a 0.50/0.50 distribution, then the order of magnitude of the samples is two. It may be that the exact number is four or eight, but the underlying distribution is potentially matched with two. If the variable has a 0.99/0.01 distribution, then the order of magnitude of the samples should be 100. When considering two independent variables the number of samples needed is the product of the individual samples. This can be done over the entire decision space to determine a total number of samples per case.

The practical approach picks some number n and runs the model using that many samples per case. Then the model is run again using 2n samples per case. The percentage change in the results is then measured. Eventually, a sample size where decreasing the number of samples makes results worse may be reached, and increasing the number of samples doesn't make results any better. Thus, the desired sample size is determined.

Algorithm Settings

Another option to apply in the case of when the model has constraints is Allowing Random Strategies. A random strategy is when two accounts have identical decision keys but different strategies. This possibility can occur in a constrained situation because of resource limits. It also occurs when the team wants to collect data on the performance of strategies in the field. It is critical that the strategies provide for experimentation, as testing new customer interactions is an integral part of strategy science.

The analyst can also change the random seed used during the run. Using the same random seed twice produces identical results, which is useful for duplication and comparison purposes. Using different seeds may produce different results.

Run Optimization

An analyst's knowledge of how the algorithm works when an optimization run begins helps the analyst interpret and understand the results.

Comparing Solutions

In the preferred embodiment of the invention, Strategy Optimizer has a set of rules for comparing one solution to another:
S1 is better than S2 if S1 is feasible and S2 is not;
S1 is better than S2 if both are feasible and the objective function for S1 is greater than the objective function for S2; and
S1 and S2 are equally good if both are feasible and their objective functions are the same.

If the algorithm finds several best solutions that are equally good, Strategy Optimizer is free to choose any one as the best solution, S*.

Search Procedure

There are typically an enormous number of possible solutions. For example, consider a situation where one of 10 possible actions is assigned to each of 100 cases. Then, there are 10\hat{ }100 possible solutions, i.e. ways to assign the actions to the cases. In general, a solution's objective function cannot be predicted or determined feasible, without evaluating it. Any algorithm intending to finish in a finite amount of time is restricted to evaluating only a small subset of all possible strategies.

The optimization algorithm in Strategy Optimizer performs a search procedure that selects solutions one at a time. The algorithm first chooses an initial solution and then based on various evaluations of such solution picks a second solution. The algorithm evaluates the second solution, and picks another one, etc.

The choice of the initial solution and the search procedure includes a random element to improve performance. The random component forces the algorithm occasionally to try a solution that is slightly different from the one suggested by the deterministic process. Such a method can possibly find an improved solution not anticipated by the heuristics.

The Strategy Optimizer algorithm stops when one of the following stopping conditions is met:
The last n solutions generated improved little over the current S*; or
Strategy Optimizer has evaluated more than a predetermined number, e.g. 2000, of solutions.

The preferred embodiment of the invention allows for the possibility that the algorithm finds no feasible solution at all, and returns the best infeasible solution found.

Local vs. Global Maxima

The applicable optimization theory does not guarantee that the solution found is a global maximum. A global maximum is guaranteed only if (1) the algorithm evaluates every possible point in the feasible space; or (2) the feasible region and objective function have a special structure, such as convexity, that permits inference about points not evaluated. Neither (1) nor (2) are true in general.

As a consequence, the algorithm may return a local maximum rather than a global maximum. The particular solution found depends somewhat on the starting point for the optimization and on the path taken by the search through the feasible space. In Strategy Optimizer, both the starting point and the algorithm are chosen with some randomness, hence it is possible to get different solutions on successive runs of the same model.

Also as a consequence, some problems are easier to solve than others.

Characteristics that make a problem easier to solve include:
Relatively low number of local maxima in the objective function;
Relatively contiguous or convex feasible region; and
Relatively continuous (not chunky or random) objective function.
   Analyze Optimization Results

In the preferred embodiment of the invention, Analyze Optimization Results consists of the following steps:
View Optimization Results; and
Sensitivity Analysis on Constraints.

After the optimization is run the team determines if the results generated by the model make sense. When the team is comfortable that the model is giving good results, sensitivity analysis can be performed on various variables and constraints.

View Optimization Results

Once the optimization is run, the analyst views output. The preferred embodiment of the invention provides an Output window summarizing the optimal values, showing all the portfolio-level constraints, and showing all variables the analyst marked as metric variables earlier in the optimization process.

The preferred embodiment of the invention provides a screen that shows easily which constraints are binding and which constraints have slack for that particular optimization run. Such data provides insight as to which constraints are driving the strategy and on which constraints sensitivity may be performed.

The output of the optimization is a Strategy Table. A strategy table has one row per case in the optimization portfolio and one column for each decision in the decision space. The value for a particular case for a particular decision is displayed in the intersecting cell. The final column is the decision that corresponds to the optimal value (maximum in Strategy Optimizer case) for that case. This table is useful, because it allows exploring the behavior of the objective function as the decision is varied through all of its potential values.

It is also useful to see all action-based predictors as the decision is taken through its domain. Such is useful for verifying that the decision model is mapping customers to decisions in a reasonable fashion.

Sensitivity Analysis on Constraints

When the model is evaluated and produces good results in an unconstrained situation, the model preferably is rerun with the constraints in place. In one preferred embodiment of the invention, the model is run once for each constraint to see if the optimal policy is bound by the constraint, or if there is slack. This tact gives a sense of how each constraint individually affects the results.

If there is slack in a constraint, then it may be useful to go through the process of lowering (or raising) the level of the constraint until it becomes binding, to get a sense of how close the business setting is to the threshold.

After the process is complete for the individual constraints, and their effect on the model is known and makes sense, the constraints need to be combined in a single optimization run. Combined together, constraints that were binding by themselves may no longer be binding due to another, more binding constraint. When the analysts are comfortable with the results of the completely constrained business problem, it is time to turn those results into strategies.

Develop Strategies

In the preferred embodiment of the invention, once the model is giving good results for a completely constrained situation, a strategy can be constructed. That strategy typically is refined as the testing process occurs.

Build Strategies

After the optimization is run, the invention assigns an optimal decision to each case in the domain over which the model was optimized. However, such domain may not be exhaustive, or the results may be such that it is difficult to pin down a set of business rules to define those results.

The real goal of the process is to know the optimal policy for all cases over the entire domain of possible values, whether they have been realized in the past or not.

Therefore, typically a strategy tree is created as a next step in the process.

The first step in creating a tree is creating manual splits on the exclusion rules provided by the clients. These are business rules that must be enforced. For example, a client may not want to give credit card offers to people with a credit score below 660, regardless of what the optimization results yield. In optimization terms, these are enforcement case-level constraints.

When these exclusions are made, segments of the population for which there are no predefined strategies are left over and this part of the strategy needs to be built. The preferred embodiment of the invention provides for either continuing to make manual splits, or allowing a tool, such as Fair, Isaac's Model Builder for Decision Tree, to split. Making the splits, and, in particular, allowing a tool to make splits, takes care for palatability, ensuring the results at each split in the process make sense. Sometimes the best mathematical split makes no intuitive sense at all.

Also, there may be cases when splits on many variables may be appropriate and statistically significant, but the analyst must just use judgment as to which split makes the most sense. In situations like this it may make the most sense to create two candidate strategies and let the test results drive which is truly best.

Tools

The following tools are provided in the preferred embodiment of the invention. It should be appreciated that a user has discretion over which tools to use, according to the particular implementation of the invention for the user's particular needs.
Strategy Optimizer;
Model Builder for Decision Tree;
Strategy Evaluation; and
Excel.
   Resources

Strategy creation has two parts; one is mechanical and the other greatly benefits from knowledge of the business. The mechanical part can be left to a consultant or analyst with the proper quality assurance support. The creative part requires the input of all members of the Strategy Modeling Team, ensuring that the status quo strategy is understood and out-of-the-box thinking is applied to generate new strategy alternatives. The lead preferably is skilled in identifying opportunities for active data collection. The lead preferably is able to teach the senior members of the team how to think about experimenting and collecting data that has high information-value.

Improvements

More structure can be added to the process as it is repeated with more clients. Specifically, diagnostic methods for decision-models and strategies preferably are formalized in documentation and possibly in software as well.

Deliverables

Once this process is complete a meeting with the client is set up to present the strategies in tree form to the client. Strategy Evaluation is a very useful tool for getting at the key charts and graphs to present to the client. Everyone must understand the strategy and agree that it makes sense before continuing.

### An Exemplary Strategy Optimizer

Effective direct marketing campaigns require continual review and improvement of the strategies that determine which offers are marketed. They also require efficient and timely analysis of the results from previous campaigns. Traditionally, direct marketing strategies take data from previous campaigns into account, but sometimes in an ad hoc or imprecise manner. Therefore, little is understood about the real effects of the terms of the offer, the interactions of the terms, or the optimal offer strategy for each targeted marketing segment.

The preferred embodiment of the invention provides an approach tailored to direct marketing to formulate more efficient test designs and optimize offer strategies using Active Data Collection SM and Action-Based Predictors SM. This section discusses how these approaches lead to improved profitability of direct marketing campaigns. It also describes an exemplary approach to improving test designs and optimizing strategies, such as mail strategies, and the presented opportunities.

Introduction

In recent years, direct marketers have become more rigorous in their approaches to developing target marketing strategies and analyzing the data from these campaigns. However, it is known that today's test designs often fall short in the following areas:
One does not have all the information you needed. It is often too cumbersome and too cost ineffective to market to every possible combination within an offer design, and with the analysis methods used today, insights are limited to the marketing segments actually mailed;
Direct marketing test results may be confounding, i.e. one can not isolate with certainty the cause and effect between offer strategies and the campaign's response and profit results. Direct marketing campaigns can often become large and unwieldy and sometimes it is difficult to spot errors in the test design;
Dozens of direct marketing tests have been implemented, but it is not possible to say whether the maximum benefit realized from the testing investment; and
Perhaps direct marketing campaigns tend to be small, and there is a limit to how much testing one can do and still yield statistically reliable results.

It should be appreciated that Decision Optimization for Direct Marketing comprises advanced techniques for direct marketers for bringing to direct marketing the ability to overcome the limitations mentioned above, as well as the ability to perform smarter, faster, and more profitable direct marketing campaigns.

Business Motivation

The goal is to maximize overall profitability and optimize response. Doing so requires optimal target marketing strategies. To achieve optimal target marketing strategies, it is preferable to understand the effects that different offers and market actions have on the response and ultimately the profitability in different targeted segments, whether or not they were included in the marketing program.

Such is the function of Action-Based Predictors. To build precise Action-Based Predictors, an advanced approach to generating data sets is provided. The approach allows filtering out noise and measuring the direct marketing effects to assess in the most efficient way possible. This step is called Active Data Collection, which uses the science of Experimental Design to create effective, efficient test designs at minimal cost and within required business constraints.

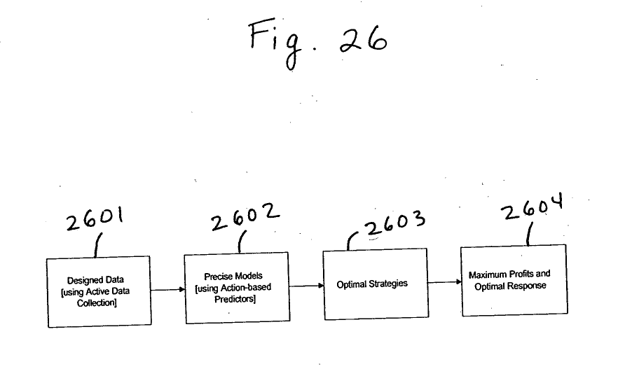

Referring to FIG. 26, the approach provided by the preferred embodiment of the invention for Direct Marketing is twofold:
Develop innovative, efficient test designs using Active Data Collection 2601, which employs the science of Experimental Design and other proprietary techniques tailored specifically to the direct marketing problem; and
Use this designed data to build custom Action-Based Prediction models 2602 to infer the performance of all possible mail cells and to ultimately find optimal strategies 2603, which lead to the best achievable profits 2604.

Each part is discussed in the sections below.

Active Data Collection

Using Active Data Collection, the most efficient test design possible is created given business constraints and goals. The task manager, such as Fair, Isaac, uses the most advanced methods from the science of Experimental Design, along with other proprietary techniques, for example, those of Fair, Isaac, tailored specifically to the direct marketing problem. Such methods are used to:
Diagnose current direct marketing campaigns and determine what is working and what is not working;
Develop a plan for integrating Active Data Collection into the next campaign; and
Recommend an optimal test design, given business constraints, to gather the data needed to build Action-Based Prediction models and optimize strategies.
   Action-Based Prediction and Strategy Optimization

In the preferred embodiment of the invention, together Active Data Collection and Action-Based Predictors are used to optimize direct marketing strategies. Action-Based Predictors are custom models that take into account all aspects of marketing campaigns, including mail criteria and alternate offer assignments. Action-Based Predictors allow:
Understanding the effects that different offers have in different segments, i.e. whether or not such effects were included in test cells;
Measuring effects of changing the terms of the offers, as well as their interactions;
Building effective decision models to optimize offer strategies;
Simulating and forecasting results before executing a campaign; and
Optimizing objectives, such as response and profitability.
   Conclusion

As clients face increased competition in the direct marketing environment, the invention provides a new and innovative way to help the client gain an edge in the marketplace, for example, Fair, Isaac's Strategy Optimization for Direct Marketing, which provides the client a cutting-edge advantage through our custom solutions, Active Data Collection and Action-Based Predictors, which formulate effective and efficient test designs, optimize offer strategies, and boost bottom-line profits.

Another Equally Preferred Optimizer.

It should be appreciated that Strategy Optimizer is by way of an exemplary optimizer only, and that any other non-linear constrained optimization tool can be substituted to provide the same intermediate results. For example, another equally preferred embodiment of the invention uses the Decision Optimizer by Fair, Isaac. Following is a description of common functionality provided by both Fair, Isaac's Strategy Optimizer and Decision Optimizer.

Strategy Optimizer and Decision Optimizer are software tools that can perform the optimization step as well as other steps in the methodology described herein this document. Each have particular strengths and each emphasize particular features of the methodology. The functionality common to both optimizers comprise: editing and viewing a decision model that may include multiple decision variables to be decided together, i.e. in a single decision stage; specifying variables as metric variables to highlight in reporting; importing a portfolio of accounts defined as an existing dataset (either sample weighted or not); assigning a treatment to each account in a portfolio using constrained nonlinear integer optimization; specifying both portfolio-level and account-level constraints; exporting the optimization results to a decision tree creation tool, e.g. Fair, Isaac's Model Builder for Decision Trees, for creating the set of candidate strategies or decision trees; and importing a decision tree to compute and compare the results of applying that decision tree to a particular portfolio and decision model.

Following is a brief description of unique features and strengths of the Decision Optimizer. Decision Optimizer is a client-server application allowing multiple users to access and work with the same decision models, input data, and output data stored on a centralized server, as Decision Optimizer provides an expression language based on the syntax and functions of the Java language. Decision Optimizer provides an optional aggregation step in which accounts are grouped together to receive the same treatment, thus reducing the dimensionality of the optimization problem. Decision Optimizer provides sophisticated reporting based on multi-dimensional OLAP cube views of the optimization results. Decision Optimizer uses a custom model formulation that allows for robust optimization over a set of uncertain states, wherein the custom model is a model developed for a particular client using the client's data and constraints.

Strategy Optimizer is a desktop application that can be used on a single machine by single user at a time. Strategy Optimizer allows creating decision models containing multiple decision variables in multiple stages, i.e. made sequentially. Strategy Optimizer provides an expression language based on a custom syntax similar to the equation syntax of commonly used business spreadsheet programs. Strategy Optimizer integrates two additional methodology steps: calibration of the model using its Predictive Modeling Wizard, and decision tree creation using Model Builder for Decision Trees, the complete functionality of which is integrated into the Strategy Optimizer application. Strategy Optimizer allows the user to generate portfolios of cases automatically, either exhaustively or probabilistically. Strategy Optimizer allows the user to use a previously generated and computed portfolio residing in memory, to eliminate the step of reading the dataset and computing all predicted values. Strategy Optimizer allows case-level uncertainty, wherein there can be uncertainty in the behavior of a given case even with the same inputs, and provides three related features: (1) the ability to specify multiple samples per case (to compute the mean and variance of the distribution of outcomes for a case); (2) the ability to specify the random seed to use to start the random number generator used in this sampling; and (3) the provision of a measure of the variance in the results in its reports. Finally, Strategy Optimizer allows the specification of non-random strategies, wherein similar or identical accounts are guaranteed to receive the same treatment.

### An Exemplary Uncertainty Estimator

What is to be Accomplished?

Strategies are often optimized in order to maximize the amount of profit an institution would receive. Even if a different metric is chosen, such as return on investment, the optimization revolves around a single numeric objective. For developing a strategy, this is a reasonable approach but rarely can a single number adequately describe the future. One might say “It is most likely that this strategy will deliver on average $100 profit per account” but most would be surprised if after a year's time that the results were exactly $100. It is more reasonable to explain the future by something similar to a confidence interval. An alternate expression might be “It is most likely that this strategy will deliver an average profit per account as low as $90 or as high as $110.” Herein below this discussion describes a methodology developed to estimate the uncertainty around estimates of future outcomes.

A decision-maker considers uncertainty for a variety of reasons as follows. Any estimate of the future carries some uncertainty. One can not avoid uncertainty; it is inherent in every analytic estimation technique. Because decision analytics is used to craft a new strategy that optimizes some future outcome, better understanding of the uncertainty around those estimates allows the decision maker to make a more informed choice between alternate strategies. Describing the effect of a strategy as a range of likely outcomes is a valuable tool for understanding the real differences between strategies, and highlights the opportunities that truly have an impact on the bottom line. As well, the analyst developing optimized strategies can make choices in the modeling and optimization process that reduces uncertainty leading to more confident conclusions by the decision maker.

For instance, a decision maker might be faced with deciding whether to implement one of two candidate strategies or stick with the current strategy. For example, candidate strategy A and B both have a higher estimated mean profit per account that the current strategy. Strategy B might have a larger estimated mean profit per account than strategy A, but there might be more uncertainty associated with that estimate. Depending on the risk-aversion of the decision maker, he might actually choose strategy A over strategy B, because the improvement over the current strategy is more certain. Understanding the range of likely outcomes allows the decision maker to choose strategies better aligned with his own (or the institution's own) objectives.

Why is there Uncertainty?

No model is perfect. Two account holders with the same profit projections might have different actual profit. This kind of variation is the result of effects desired to be captured in a model. For instance, one of these account holders might have had a sudden financial windfall resulting in a faster balance paydown. The other account holder might have had a broken refrigerator which needed replacement. This would cause a sudden increase in purchases while maintaining payments. A useful model generally still has some variation around its estimates. This type of variation is called case level variation.

The way to reduce case level uncertainty is to collect more information about the account holder that is relevant to the prediction or squeeze more predictive content from the data at hand. This might involve non-linear transformations or interaction capture.

Another source of uncertainty comes from changes in the economy or in the competitive marketplace which affect account holders. For instance, in light of a weakening economy, some account holders might not respond to a credit line increase as they would before. On the other hand, cash strapped account holders might respond even more so than they would have in a stronger economy. This external variation also affects uncertainty estimates. In one opinion, uncertainty with regard to external variation is best explored using Monte Carlo simulation.

Changes in the composition of the portfolio can also introduce uncertainty. For example, an account contained in a study might have had a balance of $2300. It is unlikely that when the strategy is implemented, the same account will still have a balance of $2300. These normal day-to-day changes for each account holder looks random for each account holder, but, when aggregated, might affect the portfolio composition which in turn affects the profit per account estimate. One can think of the portfolio at any one point in time as a sampling from a larger universe of possible portfolios compositions. Such source of uncertainty can be referred to as portfolio composition variation. Other sources of portfolio composition variation might be the result of external effects that might introduce a more systematic change, but such an effect is considered herein as an external variation effect.

The final source of uncertainty considered herein is the uncertainty inherent in the modeling process itself. The decision models which underlie the optimization are generally empirically derived. This requires pulling a data sample and using statistical procedures to estimate model parameters. Because the model parameters are estimated from a historic sample, a different sample yields different parameters. This variation in parameters due to sampling contributes to model variation. Analytic techniques and model engineering can be applied to minimize this variation. It is conceivable to think that a way to reduce model variation is to not sample at all and build on the entire portfolio. Such approach does not work because today's portfolio is different from next month's portfolio, for example. The portfolio composition variation continues to contribute to model variation.

How Uncertainty is Captured

First of all, the decision model must explicitly include nodes which capture the uncertainty. Decision models are typically comprised of two types of models: those that estimate amounts (such as revenue or losses) and those that estimate probabilities (such as likelihood to charge-off or likelihood to attrite). The decision model, if it does not include such nodes already, can be easily rewritten so that each node explicitly includes a deterministic and stochastic portion. The deterministic portion holds the expected value and the stochastic portion holds the uncertainty around that expected value. Below shows an example of how to re-express each model type separately.

Models Estimating Amounts.

Typically these models can be expressed in a simplified form as
rᵢ=\hat{r}ᵢ+εᵢ where ε_{r,i}˜Normal (0, σᵣ²).

The empirically developed model is used to calculate a value of \hat{r}ᵢ. The model is based on a set of parameters that are estimated during development of the model, so the equation is more precisely written as
rᵢ=\hat{r}ᵢ(\vec{x}ᵢ,0ᵣ)+ε_{r,i} where ε_{r,i}˜Normal (0, σᵣ²)
where \vec{x}ᵢ is a vector holding all of the information available about an individual and θᵣ is a vector of parameters that comprise the model itself. Typically the parameters represented by θᵣ are chosen in order to minimize σᵣ², the variance of the error distribution.

It has been found based on research that, according to the preferred embodiment of the invention, one more refinement to the model is still necessary. The error distribution rarely has a constant variance across all individuals. This variation in the variance term is generally modeled as a function of the estimate itself, so the model is re-expressed as
rᵢ=\hat{r}ᵢ(\vec{x}ᵢ,θᵣ)+ε_{r,i}, where ε_{r,i}˜Normal (0, σᵣ²(\hat{r}ᵢ)).

The functional form of σᵣ²(\hat{r}ᵢ) remains somewhat generic, although the most common form found suggest the variance can be reasonably expressed as a quadratic function of \hat{r}ᵢ or a linear function of \hat{r}ᵢ. An example where a constant value is an obvious choice has yet to be seen and, similarly, an example where a more complex function is advantageous has yet to be seen.

Re-expressing the model more precisely is preferred because the uncertainty is now expressed as part of the decision model. The term, ε_{r,i}, captures the case-level variation. This accounts for the effect of factors not included in the model on the observed value of rᵢ. Once the functional form of σᵣ²(\hat{r}ᵢ) is estimated, the impact of case-level uncertainty on derived estimates of future outcomes can begin to be explored.

The term, θᵣ, is called out explicitly as well because it is used to capture the model variation. The distribution of the model parameter estimates, \hat{θ}ᵣ, can be estimated non-parametrically, whereby such distribution is used to explore the impact of model uncertainty on the derived estimates of future outcomes.

Models Estimating Probabilities.

Typically these models can be expressed in a simplified form as
bᵢ˜Bernoulli(βᵢ) where βᵢ=βᵢ(\vec{x}ᵢ,θ_{β}).

To be clear, bᵢ, takes on the value of 0 or 1 and might represent any binary outcome such as whether an individual actually charged-off to bad debt or closed his account. This can be modeled as a random draw from a Bernoulli distribution with probability βᵢ. That probability is calculated as a function of the individual's attributes and some model represented by the θ_{β}, where θ_{β} is a vector of parameters that comprise the model itself.

Note that the bᵢ term carries with it both model variation, because θ_{β} is estimated, and case level variation, because it cannot be known with certainty ahead of time whether or not any individual will charge-off to bad debt. As is true for models estimating amounts, the distribution of the model parameter estimates, θ_{β}, can also be estimated non-parametrically, and such distribution can be used to explore the impact of model uncertainty on derived estimates of future outcomes.

Summary of how Uncertainty is Captured.

The case-level variation results because there is no completely perfect model. That lack of perfection is represented herein by random pulls from distributions that are customized to each individual. The preferred embodiment of the invention uses the Normal distribution when estimating amounts and the Bernoulli distribution when estimating binary outcomes, while it should be appreciated that other similar distributions can also be used. This is captured by the ε_{r,i} term and the bᵢ term, respectively.

The model variation results because several parameters in this model are estimated. Specifically θᵣ, θ_{β} and the σᵣ²(\hat{r}ᵢ) functions must be estimated. Such estimation process depends on pulling samples from a population, and different random samples produce slightly different estimates.

Although uncertainty has been described primarily at the individual level, the effectiveness of a strategy is typically described by an aggregate measure, such as the sum of profit across all accounts, for example. The preferred embodiment of the invention provides an estimation procedure that allows the introduction of uncertainty at the individual level and then allows aggregating that uncertainty at a more aggregated level. Thus the invention provides the flexibility and means for describing the distribution of any aggregate measure using the same estimation mechanism.

The preferred embodiment of the invention uses a Monte-Carlo process to estimate uncertainty by simulating the effect of the case-level variation, model variation, and portfolio composition. In terms of calculations, this becomes quite a tangle because the model variation and case-level variation are linked together. The linkage between model variation and portfolio composition is also very strong. To capture these linkages in a reasonable way, the estimation process is very complex. The Monte-Carlo run comprises a number of simulated portfolios, simulated case-level effects and simulated model variations. The results of the Monte-Carlo simulation are estimates of the distributions of any aggregated measure estimated from items in the decision model.

The Two Stage Process

According to the preferred embodiment of the invention, the uncertainty estimation process runs as a two stage process. Stage One is repeated for each component model making up the entire decision model. During this stage the model variation is captured and the case-level variation is quantified. Once Stage One is completed for all component models, Stage Two rolls-up the variations into the aggregate measures and presents the range of expected outcomes.

Stage One focuses on estimating the model parameters that will capture the uncertainty and relies on a bootstrapping procedure. The bootstrapping procedure pulls a series of samples with replacement from the development sample. Each sample is called a bootstrap sample and preferably contains the same number of observations as the development sample. The bootstrap sample contains duplicate observations and also likely contains repeated copies of a few observations.

Following is a suggested outline for Stage One pull a development sample;
estimate all parameters making up the model, (i.e. estimate θᵣ or θ_{β});
if the model predicts an amount, estimate the potential functional forms of σᵣ²(\hat{r}ᵢ);
do for j=1 to 200:
   pull a bootstrap sample from development;
   re-estimate all parameters making up the model and call this θ_{r,j} or θ_{β,j};
   if the model predicts an amount, estimate the potential functional forms of σ_{r,j}²(\hat{r}ᵢ);
enddo; and
choose the final functional form of σᵣ²(\hat{r}ᵢ).

It should be appreciated that 200 samples have been found in practice to be a good balance between increased accuracy and increased time and expense, but that the invention is by no means limited by the number 200, especially given the variety of computing environments in which to implement the invention.

Following is a detailed description of the meaning of “estimate the potential functional forms of σᵣ²(\hat{r}ᵢ)”. First, consider three functional forms of σᵣ²(\hat{r}ᵢ), namely:
σᵣ²=(\hat{r}ᵢ−rᵢ)²=a_{0,2}+a_{1,2}*\hat{r}ᵢ+a_{2,2}*\hat{r}ᵢ² (13)
σᵣ²(\hat{r}ᵢ)=(\hat{r}₁−rᵢ)²=a_{0,1}+a_{1,1}*\hat{r}ᵢ (14)
σᵣ²(\hat{r}ᵢ)=(\hat{r}ᵢ−rᵢ)²=a_{0,0} (15)

Each of these three forms is fit on the development sample once the model has been estimated. For each iteration in the bootstrapping loop, each of these three forms is estimated on the leftover sample. Recall that the bootstrap sample is pulled with replacement from the development sample. This means that some observations are duplicated in the bootstrap sample and others are not sampled. The observations that were not pulled into the bootstrap sample comprise the leftover sample. The error distribution is estimated using both the development sample and the series of leftover samples to obtain a more realistic description. It has been found that from statistical theory and practice, the error distribution on the development sample is downwardly biased. In other words, it underestimates the errors anticipated on an independent sample. The leftover samples provide an opportunity to remove this downward bias, but the size of each leftover sample is small relative to the entire development sample, so does not produce as robust an estimate as desired. These sets of estimates are combined using a slight modification of the 632-bootstrap estimate first described in Efron and Tibshirani's book, An Introduction to the Bootstrap (1993). Specifically,
Q^{(j)}=0.368*Q^{(dev)}+0.632*Q^{(leftover=j)}
where Q represents each a_{**} above

Then, “choose the final functional form of σᵣ²(\hat{r}ᵢ)” means to complete the 632-estimate by calculating:

$$Q = \frac{1}{200} * {\sum }_{j = 1}^{200} {Q}^{( j )} .$$

where Q represents each a_{**} above

Then, apply the following series of tests to determine which form of σᵣ²(\hat{r}ᵢ) is appropriate. Such series of tests, the pseudocode of which is provided below, are applied to the 632-estimates of the coefficients in forms (13), (14), and (15) on each bootstrap sample as well as the final averaged versions:
Set quadratic-flag and linear-flag to TRUE;
For each set of Q^{(j)} and Q:
If a_{2,2}≦0, then set quadratic-flag to FALSE
/* quadratic form is only reasonable if concave-up */;
If (4*a_{2,2}*a_{2,0}−a_{2,1}*a_{2,1})/(4*a_{2,2}))<0, then set quadratic-flag to FALSE
/* quadratic form is only reasonable if vertex is not negative */;
If a_{1,1}<0, then set linear-flag to FALSE
/* linear form is only reasonable if slope is not negative */; and
If a_{1,0}<0, then set linear-flag to FALSE
/* linear form is only reasonable if intercept is not negative */;
endfor;
If quadratic-flag=TRUE, then equation (1) best describes σᵣ²(\hat{r}ᵢ);
Else if linear-flag=TRUE, then equation (2) best describes σᵣ²(\hat{r}ᵢ); and
Else equation (13) best describes σᵣ²(\hat{r}ᵢ).

Once Stage One has been repeated for each component model, all of the parameters needed to capture the uncertainty will have been estimated. Stage Two uses those parameters to gauge how much uncertainty exists in the aggregated measures.

Following is a suggested outline for Stage Two.
pull a representative sample;
do for j=1 to 200:
pull a bootstrap sample from the representative sample;
select a set of models (i.e. select θ_{r,j} or θ_{β,j});
for each individual in this Bootstrap sample:
   (For Each Model Predicting an Amount):
calculate \hat{r}ᵢ;
calculate σᵣ²(\hat{r}ᵢ);
randomly draw δ_{r,i} from Normal (0, 1);
calculate ε_{r,i}=δ_{r,i}*{square root over (σᵣ²(\hat{r})}ᵢ); and
calculate rᵢ
(endfor):
   (For Each Model Predicting a Probability):
calculate βᵢ;
randomly draw δ_{b,i} from Uniform (0, 1);
calculate

$${b}_{i} = \{ \begin{matrix}1 , & if {δ}_{b , i} < {β}_{i} \\ 0 , & otherwise\end{matrix} ;$$
(endfor);
endfor;
calculate the aggregated measure across all individuals (call this Pⱼ);
enddo;
display the histogram of the 200 values of Pⱼ; and
report the average of Pⱼ with a confidence interval of ±2 standard deviations.

This final report quantifies the uncertainty around the aggregate measures by reporting on the variability that is expected in the final outcome due to variation based on case-level variation, model variation, and portfolio composition.

Summary

The decision model specifically encapsulates case-level uncertainty;
Non-parametric bootstrapping techniques are used to capture model variation;
Analysis of historic data on holdout samples is used to describe the case-level error distributions; and
Portfolio composition variation is captured as an integral element of the process.
   Estimating Uncertainty.

Although each source of uncertainty is tied to one another, it is possible to detangle each source to gain deeper understanding of the relative contribution of each. To explore the effect of ignoring portfolio composition on overall uncertainty, Stage Two can be altered by not pulling bootstrap samples, such as 200 samples for example, but instead reusing the entire representative sample that many times, such as 200 times. To explore the effect of ignoring model variation, Stage Two can be altered by not selecting a set of models within each iteration, but rather reusing the set of development models in each iteration. Finally to explore the effect of ignoring case-level variation, Stage Two can be altered to replace each estimate with an expected value of that estimate. Practically speaking that involves setting the error term to zero, i.e. ε_{r,i}≡0, or replacing the random draw from the Bernoulli distribution with the probability itself, i.e. bᵢ≡βᵢ. It should be appreciated that in this case, it is important to verify that the decision model remains appropriate using the expected values. These options can be combined in order to focus on various effects. It should also be appreciated that such gives the analyst a general sense of the impact of the sources of uncertainty. It is not as likely that such sources can be unbundled so cleanly this way.

Occasionally an analyst is interested in the uncertainty at the individual level. This might be necessary if the analyst wants to switch to maximizing a different objective function. As an example, rather than determining the strategy to maximize total profit, e.g.

$$P = {\sum }_{all individuals i} {P}_{i} ,$$

it may be desired to choose to maximize total risk-adjusted all individuals i profit, e.g.

$${P}^{′} = {\sum }_{all individuals i} ( {P}_{i} - λ * {σ}_{i} ) ,$$

where σᵢ captures the uncertainty for each individual in that individual's profit estimate and λ is chosen by the analyst to specify the amount of discounting for uncertainty desired. The analyst then needs to calculate σᵢ for each individual (and perhaps for each possible action). In this case, Stage Two is modified (1) to ignore portfolio composition and (2) to calculate and save each profit estimate for each individual i for each of the j=1 to 200 iterations (call each of these estimates: Pᵢ^{(j)}). Once all of the Pᵢ^{(j)} estimates are calculated, then σᵢ can be calculated as the standard deviation of the Pᵢ^{(j)} across the 200 estimates. This would then be output as an extra column on the sample dataset, so that the analyst could develop an optimal strategy which maximizes risk-adjusted profit.

It is often interesting to compare aggregated measures across strategies to assess whether two or more strategies are significantly different. When making such comparison, the effect of case-level uncertainty must be fixed for a given individual across strategies. In other words, the random draws from the Normal(0,1) and Uniform(0,1) distributions must be held constant within each bootstrap sample processed in Stage Two.

If the decision model has several component models, any co-variation between component models preferably is preserved according to the preferred embodiment of the invention. For example if the same model development sample is used to estimate a revenue and attrition model, that linkage is preserved in this uncertainty estimation process. In this case, care is taken during the bootstrapping process in Stage One to ensure that the j^{th} bootstrap sample pulled for the revenue model is exactly the same as the j^{th} bootstrap sample pulled for the attrition model. Furthermore, when the set of models is selected in Stage Two during the bootstrap iteration, the j^{th} revenue model and the j^{th} attrition model are preferably selected as a pair.

Finally, when comparing the expected results of new strategies to an historic strategy, the performance of the historic strategy is preferably estimated in light of the same case-level and model variation used to explore new strategies. While a tendency exists to consider the observed performance from an historic strategy as the average performance in light of uncertainty, it has been found that such assumption is not preferred, as it may lead the decision-maker to reach a faulty conclusion.

Strategy Testing

The preferred embodiment of the invention provides strategy testing. After a set of candidate strategies are created, attention turns toward testing the strategies to guide refinement of the strategies and decision model as well as to select the best strategy for deployment. In an equally preferred embodiment of the invention, Strategy Testing also encompasses field testing of strategies. Recall that strategies are designed to collect the necessary data in the field required for this type of evaluation. Specifically, they need to experiment on a subset of the customers, i.e. trying different interactions with the goal of identifying the ones that work best.

Inputs

In the preferred embodiment of the invention, input data includes a strategy or set of candidate strategies.

Outputs

The preferred embodiment of the invention provides output in the form of test results that can be used to evaluate the performance of the strategy set.

Procedure

The preferred embodiment of the invention provides the following procedure for Strategy Testing. The process begins by taking a set of candidate strategies (or a single candidate strategy) and testing them. Testing may be as simple as running a strategy simulation on the development data set or as involved as field-testing on a sampled population over a designated performance period. After the testing is complete, the findings are used to evaluate the performance of the strategy. At this time in the process the team preferably revisits the Active Data Collection described in Data Request and Reception and has another discussion incorporating everything learned during the development process.

If during the evaluation process it is discovered that the strategy does not perform well enough, other tests may be run to evaluate the performance or it may be necessary to recreate different strategies based on the knowledge gained during the testing process.

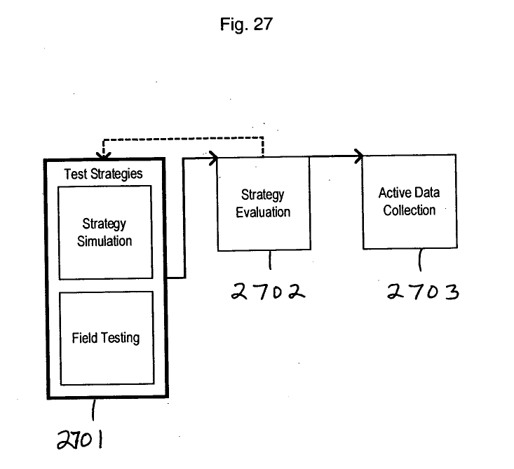

FIG. 27 is a schematic diagram showing control flow and iterative flow between three components discussed in detail herein below: test strategies 2701, strategy evaluation 2702, and active data collection 2703.

Testing Strategies

Testing Strategies includes the following two steps:
Strategy Simulation; and
Field Testing.

These steps are alternative ways to test strategies. Ideally both are used, but time and other constraints may dictate that only the Strategy Simulation is performed.

Strategy Simulation

After the team has generated a strategy and assigned decisions to cases in a data set, Strategy Simulation is run to see how that strategy performs and all of the computed variables in the model are instantiated. Such simulation is useful, because the candidate strategy may differ through the strategy refinement process from the optimization results. By running a strategy simulation the team quantifies such effects and sees how the effects change the performance of the strategy. Varying the simulation model and running the strategy through each model variation can measure the sensitivity of the strategy to modeling assumptions. Strategy Simulation can also be used to determine if there is any over-fitting in the data. The simulation can be run on the development data set, a holdout data set to ensure against over-fitting, or on a data set created using prior probabilities if possible. Usually it is probable that the population distribution changes from the time of development to the time of implementation.

Field Testing

It may be possible to test a strategy in-market on a small percentage of the population before implementing it full scale on the entire customer base.

If this is feasible, the first decision made is how the results of the test are to be measured. One way is to collect performance data for the same period of time as the true performance period. However, it may not be practical, for time and monetary reasons, to collect data for this period of time, in which case new measures may need to be developed to accurately evaluate the strategies performance. In earlier research analysts found that the performance in a small time frame was highly correlated with the performance in a larger time span, and therefore only needed to collect data for the smaller time span to have an accurate reflection of the strategy's performance.

Once the measures for evaluating the strategy are established and measurable, the population over which to test the strategy must be determined. For example, it may be that there are particular segments of the strategy that are of interest, because they produce the highest revenue. It may also be the case that 5% of the population is randomly assigned the new strategy, while the other 95% receive the existing strategy, and such is randomly assigned at the time the decision is made.

Strategy Evaluation

After performance data is gathered, the team needs to determine whether the strategy developed over the course of the previous steps works well.

Some key questions considered during this process include:

How does the strategy compare with the status quo (champion) strategy both in terms of performance and in terms of targeting population?

Does the strategy make intuitive sense?

Why does the strategy treat customers with certain characteristics differently?

Why does the strategy treat customers with very similar characteristics so differently?

Where is the gain coming from?

Key Population Differences

The preferred embodiment of such process is currently mostly manual, although it should be appreciated that the process can be automated. Another equally preferred embodiment of the invention provides a strategy evaluation capability for analysts to explore the data more easily and generate a series of reports to aide in the process of determining whether the strategy makes sense. This process has analysts thinking and using their common sense and data exploration expertise.

Inevitably the team encounters something in the strategy that does not make sense and go back to determine why it does not make sense and how to reengineer the models to make strategy make sense. This is a very iterative process involving remodeling, rerunning the optimizations, and looking at the resulting strategies.

This part of the process repeats itself until the analyst arrives at a strategy with which the Strategy Modeling Team is comfortable.

Active Data Collection

One of the primary advantages of Strategy Science is it allows for feedback into the strategy design process. Each strategy set can include components whose function is to collect information which assists in the improvement of future strategies.

After the model building process is complete the team learns a great deal about the client's business, the client's processes, and the client's data. The notion of Active Data Collection is preferably revisited in a meeting with the client. At this time the team has quantified the types of data or collection processes that help the client and the task manager going forward. The strategy recommended by the team includes experimentation to provide the data required to evaluate the strategy in the field.

Tools

The following tools are provided in the preferred embodiment of the invention. It should be appreciated that a user has discretion over which tools to use, according to the particular implementation of the invention for the user's particular needs:
Strategy Optimizer (Strategy Simulation); and
Strategy Evaluation.
   Resources

The process of strategy testing requires expertise in the appropriate statistical and data-mining methodologies, as well as an understanding of the types of reports that the leader of the team needs to see to be convinced of the quality of the analysis. A lead or experienced consultant can often provide the necessary guidance as to how to test strategies properly. An analyst or consultant skilled in the use of Strategy Optimizer can carry out the mechanics. It is not uncommon that the leader of the Strategy Modeling Team exerts control on this process to ensure confidence with standing behind the results.

Improvements

Development of metrics or reports that add more rigors to the process is preferable.

As the first few projects develop, a set of standard metrics typically is used to help determine if a strategy is performing well. For example, if a strategy is perhaps a particular percentage from, or is an absolute difference from the optimized strategy, as well as from the current champion strategy across different populations.

Deliverables

The preferred embodiment of the invention provides a deliverable of strategy testing in the form of a report that compares the candidate strategies and argues for the deployment of the best one.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. An iterative method for creating and evaluating strategies, comprising the steps of:
providing any of:
a team development module for developing a strategy modeling team;
a strategy situation analysis module for framing a decision situation;
a data request and reception module for designing and executing logistics of specifying, acquiring, and loading data required for decision and strategy modeling;
a data transformation and cleansing module for verifying, cleansing, and transforming data;
a decision key and intermediate variable creation module for computing additional variables from data and constructing a data dictionary;
a data exploration module for determining characteristics that are effective decision keys and intermediate variables;
a decision model structuring module for formalizing relationships between decisions, decision keys, intermediate variables, and value of a decision model;
a decision model quantification module for encoding information into a decision model;
a strategy creation module for determining strategies that a client can test; and
a strategy testing module for testing strategies to guide refinement of strategies and refinement of a decision model and to select a best strategy for deployment;
wherein each of said modules has capability to interact with an expert task manager, wherein said expert task manager provides expert knowledge about strategy modeling processes and sub-processes.

2. The iterative method of claim 1, the step of providing said team development module further comprising:
said strategy modeling team executing analysis to allow a leader of said strategy modeling team to convince a decision maker to implement a strategy favored by said analysis.

3. The iterative method of claim 1, the step of providing said strategy situation analysis module further comprising:
identifying the values of the organization; and
ensuring that the right decisions and strategies are considered in an analysis.

4. The iterative method of claim 1, the step of providing said data request and reception module further comprising:
designing and executing logistics of specifying, acquiring, and loading data required for decision and strategy modeling.

5. The iterative method of claim 1, the step of providing said data transformation and cleansing module further comprising:
verifying, cleansing, and transforming data.

6. The iterative method of claim 1, the step of providing said decision key and intermediate variable creation further comprising:
computing intermediate variables from said data, said intermediate variables dependent on decision keys; and
constructing a data dictionary.

7. The iterative method of claim 1, the step of providing said data exploration module further comprising:
providing insight into said data by determining which decision keys are most relevant for predicting said intermediate variables; and
gaining insight into a customer's business and business processes.

8. The iterative method of claim 1, the step of providing said decision model structuring module further comprising:
formalizing relationships between decisions, decision keys, intermediate variables, and value by connecting such in a model.

9. The iterative method of claim 1, the step of providing said decision model quantification module further comprising:
encoding information into a decision model.

10. The iterative method of claim 1, the step of providing said strategy creation module further comprising:
applying optimization methods to a decision model to determine an optimal strategy for a set of cases.

11. The iterative method of claim 1, the step of providing said strategy creation module further comprising:
evolving using results from a decision model being enriched and from strategies tested.

12. The iterative method of claim 1, the step of providing said strategy testing module further comprising:
providing means for evaluating each strategy based on simulation; and
providing means for evaluating a strategy in the field.

13. The iterative method of claim 1, further comprising the steps of:
beginning with a simplified value model having less than eight drivers;
wherein each of said drivers is modeled crudely by one or two decision keys;
initially including no constraints;
using said simplified value model for beginning said strategy creation module and said strategy testing module, said strategy creation module and said strategy testing module indicating areas of said decision model where refinement adds particular value; and
after interaction between said decision model and strategies is acceptable, iteratively adding details reflecting limitations of a business process.

14. The iterative method of claim 1, wherein said team development module comprises a team creation component and a decision quality component.

15. The iterative method of claim 1, further comprising the step of:
providing a decision quality process for enabling an organization to systematically identify, understand, and track views of quality of decision making.

16. The iterative method of claim 1, further comprising the step of:
providing any of six dimensions associated with any of six links in a decision quality chain, said any of six links comprising:
appropriate frame;
creative-feasible alternatives;
meaningful-reliable Information;
clear values and tradeoffs;
logically-correct reasoning; and
commitment to action;
wherein said chain supports an organization's value.

17. The iterative method of claim 1, said step of providing a strategy situation analysis module further comprising the steps of:
framing a problem by:
identifying issues;
developing a decision hierarchy;
understanding an organization's values; and
brainstorming and clarifying alternatives;
further understanding said organization's values by:
developing value metrics and prototyping metric results; and
planning for data acquisition by:
identifying intermediate variables; and
developing a plan for assessment;
wherein for clarification:
optionally returning to said framing a problem step after said further understanding said organization's values step; and
optionally returning to said further understanding said organization's values step after said planning for data acquisition step.

18. The iterative method of claim 1, the step of providing said data request and reception module further comprising the steps of:
developing data parameters, including:
determining data elements;
designing a performance period;
determining data records; and
constructing an initial data dictionary;
determining transfer parameters, including:
determining transfer format; and
determining transfer method;
preparing data, including:
assembling transfer data; and
transferring data; and
loading data on a target system.

19. The iterative method of claim 1, said step of providing a data transformation and cleansing module further comprising the steps of:
validating original data sets, comprising:
investigating original data sets; and
cleaning original data sets;
creating analysis data sets, comprising; and
transforming data; and
computing additional variables;
validating analysis data sets, comprising;
transforming data; and
computing additional variables;
wherein while creating analysis data sets and problems are uncovered in original data sets, then original data sets are further cleaned and retransformed; and
wherein while validating analysis data sets and problems in said transformation, or in original data sets, are uncovered, then such tasks are revisited.

20. The iterative method of claim 1, said step of providing a decision key and intermediate variable creation module further comprising the steps of:
first creating dependent variables useful for decision models, comprising:
identifying concepts;
triaging concepts; and
defining dependent variables; and
creating independent variables useful for decision models, comprising
identifying concepts;
triaging concepts; and
defining dependent variables;
wherein intermediate variables depend on decision keys, other intermediate variables, or decisions; and
wherein each intermediate variable encapsulates a predictive model with a dependent variable and independent variables.

21. The iterative method of claim 1, said step of providing a data exploration module further comprising the steps of:
applying basic statistical analysis, comprising:
analyzing continuous variables; and
analyzing discrete variables;
applying variable reduction techniques, comprising:
applying human and business judgment; and
applying computational methods;
applying advanced statistical analysis;
verifying results; and
presenting said results.

22. The iterative method of claim 1, said step of providing a decision model structuring module further comprising the steps of:
conceptualizing, comprising the steps of:
selecting intermediate variables that drive value;
building coarse models of intermediate variables; and
verifying constraints; and
drawing a decision model structure;
wherein said conceptualizing step is iteratively available for use after said drawing step.

23. The iterative method of claim 1, said step of providing a decision model quantification module further comprising the steps of:
modeling intermediate variables;
filling in nodes with models, functions, and/or constants; and
validating said decision model;
wherein said modeling step is iteratively available from said filling in step, and
wherein said filling in step is iteratively available from said validating said decision model step.

24. The iterative method of claim 1, further comprising the step of providing a score tuner component for automating decision model updating and reporting, said score tuner component comprising any of:
data awareness capability;
triggering rules;
model history retention;
self-guided model development;
connection to a decision engine; and
execution and analytic audit trails;
wherein when a tuning run is triggered, results are reviewed and either accepted and an update is deployed, or rejected.

25. The iterative method of claim 1, said step of providing a strategy creation module further comprising the steps of:
performing model optimization, comprising:
identifying metric variables;
determining optimization parameters; and
running optimization;
analyzing optimization results, comprising
viewing optimization results; and
performing sensitivity analysis on constraints; and
developing strategies, comprising:
building strategies; and
refining strategies;
wherein the performing model optimization step and the analyzing optimization results step are available to be used iteratively from either the analyzing optimization results step or the developing strategies step.

26. The iterative method of claim 1, further comprising the step of:
providing a non-linear constrained optimization tool for improving test designs and optimizing strategies.

27. The iterative method of claim 1, said step of providing a strategy testing module further comprising the steps of:
testing strategies, comprising:
performing strategy simulation; and
performing field testing;
evaluating strategies; and
performing active data collection;
wherein said testing strategies step is available for being used iteratively from said evaluating strategies step.

28. An apparatus for iteratively creating and evaluating strategies in an iterative, comprising:
means for providing any of:
a team development module for developing a strategy modeling team;
a strategy situation analysis module for framing a decision situation;
a data request and reception module for designing and executing logistics of specifying, acquiring, and loading data required for decision and strategy modeling;
a data transformation and cleansing module for verifying, cleansing, and transforming data;
a decision key and intermediate variable creation module for computing additional variables from data and constructing a data dictionary;
a data exploration module for determining characteristics that are effective decision keys and intermediate variables;
a decision model structuring module for formalizing relationships between decisions, decision keys, intermediate variables, and value of a decision model;
a decision model quantification module for encoding information into a decision model;
a strategy creation module for determining strategies that a client can test; and
a strategy testing module for testing strategies to guide refinement of strategies and refinement of a decision model and to select a best strategy for deployment;
wherein each of said modules has capability to interact with an expert task manager, wherein said expert task manager provides expert knowledge about strategy modeling processes and sub-processes.

29. The apparatus of claim 28, said team development module further comprising:
means for said strategy modeling team executing analysis to allow a leader of said strategy modeling team to convince a decision maker to implement a strategy favored by said analysis.

30. The apparatus of claim 28, said strategy situation analysis module further comprising:
means for identifying the values of the organization; and
means for ensuring that the right decisions and strategies considered in an analysis.

31. The apparatus of claim 28, said data request and reception module further comprising:
means for designing and executing logistics of specifying, acquiring, and loading data required for decision and strategy modeling.

32. The apparatus of claim 28, said data transformation and cleansing module comprising:
means for verifying, cleansing, and transforming data.

33. The apparatus of claim 28, said decision key and intermediate variable creation further comprising:
means for computing intermediate variables from said data, said intermediate variables dependent on decision keys; and
means for constructing a data dictionary.

34. The apparatus of claim 28, said data exploration module further comprising:
means for providing insight into said data by determining which decision keys are most relevant for predicting said intermediate variables; and
means for gaining insight into a customer's business and business processes.

35. The apparatus of claim 28, further comprising:
means for said decision model structuring module formalizing relationships between decisions, decision keys, intermediate variables, and value by connecting such in a model.

36. The apparatus of claim 28, further comprising:
means for said decision model quantification module encoding information into a decision model.

37. The apparatus of claim 28, further comprising:
means for said strategy creation module applying optimization methods to a decision model to determine an optimal strategy for a set of cases.

38. The apparatus of claim 28, further comprising:
means for said strategy creation module evolving using results from a decision model being enriched and from strategies tested.

39. The apparatus of claim 28, further comprising:
means for said strategy testing module:
providing means for evaluating each strategy based on simulation; and
providing means for evaluating a strategy in the field.

40. The apparatus of claim 28, further comprising:
means for beginning with a simplified value model having less than eight drivers
wherein each of said drivers is modeled crudely by one or two decision keys;
means for initially including no constraints;
means for using said simplified value model for beginning said strategy creation module and said strategy testing module, said strategy creation module and said strategy testing module indicating areas of said decision model where refinement adds particular value; and
means for after interaction between said decision model and strategies is acceptable, iteratively adding details reflecting limitations of a business process.

41. The apparatus of claim 28, wherein said team development module comprises:
a team creation component; and
a decision quality component.

42. The apparatus of claim 28, further comprising:
means for providing a decision quality process for enabling an organization to systematically identify, understand, and track views of quality of decision making.

43. The apparatus of claim 90, further comprising:
means for providing any of six dimensions associated with any of six links in a decision quality chain, said six links comprising:
appropriate frame;
creative-feasible alternatives;
meaningful-reliable Information;
clear values and tradeoffs;
logically-correct reasoning; and
commitment to action;
wherein said chain supports an organization's value.

44. The apparatus of claim 28, said means for providing a strategy situation analysis module further comprises:
means for framing a problem by:
identifying issues;
developing a decision hierarchy;
understanding an organization's values; and
brainstorming and clarifying alternatives;
means for further understanding said organization's values by
developing value metrics and prototyping metric results; and
means for planning for data acquisition by:
identifying intermediate variables; and
developing a plan for assessment;
wherein for clarification:
optional means for returning to said framing a problem step after said further understanding said organization's values step; and
optional means for returning to said further understanding said organization's values step after said planning for data acquisition step.

45. The apparatus of claim 28, said data request and reception module further comprising:
means for developing data parameters, comprising any of:
determining data elements;
designing a performance period;
determining data records; and
constructing an initial data dictionary;
means for determining transfer parameters, comprising:
determining transfer format; and
determining transfer method;
means for preparing data, comprising:
assembling transfer data; and
transferring data; and
means for loading data on a target system.

46. The apparatus of claim 28, said means for providing a data transformation and cleansing module further comprising:
means for validating original data sets, comprising:
investigating original data sets; and
cleaning original data sets;
means for creating analysis data sets, comprising; and
transforming data; and
computing additional variables;
means for validating analysis data sets, comprising;
transforming data; and
computing additional variables;
wherein while creating analysis data sets and problems are uncovered in original data sets, then original data sets are further cleaned and retransformed; and
wherein while validating analysis data sets and problems in said transformation, or in original data sets, are uncovered, then such tasks are revisited.

47. The apparatus of claim 28, said means for providing a decision key and intermediate variable creation module further comprising:
means for first creating dependent variables useful for decision models, comprising:
identifying concepts;
triaging concepts; and
defining dependent variables; and
means for creating independent variables useful for decision models, comprising
identifying concepts;
triaging concepts; and
defining dependent variables;
wherein intermediate variables depend on decision keys, other intermediate variables, or decisions; and
wherein each intermediate variable encapsulates a predictive model with a dependent variable and independent variables.

48. The apparatus of claim 28, said means for providing a data exploration module further comprising:
means for applying basic statistical analysis, comprising:
analyzing continuous variables; and
analyzing discrete variables;
means for applying variable reduction techniques, comprising:
applying human and business judgment; and
applying computational methods;
means for applying advanced statistical analysis;
verifying results; and
presenting said results.

49. The apparatus of claim 28, said means for providing a decision model structuring module further comprising:
means for conceptualizing, comprising the steps of:
selecting intermediate variables that drive value;
building coarse models of intermediate variables; and
verifying constraints; and
means for drawing a decision model structure;
wherein said conceptualizing step is iteratively available for use after said drawing step.

50. The apparatus of claim 28, said means for providing a decision model quantification module further comprising:
means for modeling intermediate variables;
means for filling in nodes with models, functions, and/or constants; and
means for validating said decision model;
wherein said modeling step is iteratively available from said filling in step, and wherein said filling in step is iteratively available from said validating said decision model step.

51. The apparatus of claim 28, further comprising:
means for providing a score tuner component for automating decision model updating and reporting, said score tuner component comprising any of:
data awareness capability;
triggering rules;
model history retention;
self-guided model development;
connection to a decision engine; and
execution and analytic audit trails;
wherein when a tuning run is triggered, results are reviewed and either accepted and an update is deployed, or rejected.

52. The apparatus of claim 28, said means for providing a strategy creation module further comprising:
means for performing model optimization, comprising:
identifying metric variables;
determining optimization parameters; and
running optimization;
means for analyzing optimization results, comprising
viewing optimization results; and
performing sensitivity analysis on constraints; and
means for developing strategies, comprising:
building strategies; and
refining strategies;
wherein the performing model optimization step and the analyzing optimization results step are available to be used iteratively from either the analyzing optimization results step or the developing strategies step.

53. The apparatus of claim 28, further comprising:
a non-linear constrained optimization tool for improving test designs and optimizing strategies.

54. The apparatus of claim 28, said means for providing a strategy testing module further comprising:
testing strategies, comprising:
performing strategy simulation; and
performing field testing; and
evaluating strategies; and
performing active data collection;
wherein said testing strategies step is available for being used iteratively from said evaluating strategies step.

55. An apparatus for automating decision model updating and reporting, comprising:
at least one tuning apparatus, comprising any of:
data awareness capability;
triggering rules;
model history retention;
self-guided model development;
connection to a decision engine; and
means for triggering a parameter tuning run execution and analytic audit trails; and
means for reviewing results, wherein said results are either accepted and an update is deployed, or rejected.

56. The apparatus of claim 55, further comprising:
means for interacting with a server that handles tuning parameters, and running a scripted model optimization engine for generating new models and evaluation reports;
wherein said tuning parameters are any of sample sizes, population definition, and whether tuning is manually initiated or triggered on a set schedule.

57. A decisioning client apparatus, comprising:
a decisioning client application processing system for:
supplying data associated with a customer to a decision engine; and
requesting a decision; and
wherein said decision engine comprises a score generation module;
means for said decision engine, using said score generation module, generating needed transformations of said data and generating at least one score, said at least one score based on at least one score weight of at least one scorecard at a time;
means for said decision engine applying pre-specified decision rules and strategies using said data and said transformed data, and at least one score for generating a vector of recommended decision actions;
means for said decision engine returning requested data, said transformed data, said at least one score, information about said at least one scorecard, and said recommended actions to said decisioning client application processing system;
means for said decisioning client application processing system optionally implementing said recommended actions, and storing results into a data store.

58. The decisioning client apparatus of claim 57, further comprising any of:
means for said decisioning client application processing system optionally taking additional non-score-based decisions over time;
means for said decisioning client application processing system monitoring and recording periodic signals from customers and general environment;
means for said decisioning client application processing system gathering data over time about a customer for helping determine one or more outcomes of interest; and
an asynchronous process periodically triggering preparation of a matched data set from information about a customer, said information from a predetermined time, wherein said results are appended to a growing store of predictive plus performance data records; and
said asynchronous process further comprising means for a score tuner component having a triggering mechanism, using said triggering mechanism for periodically taking said matched data set and producing, if appropriate, score weight updates of at least one active scorecard, wherein said scorecard is installed into said score generation module after a review.

59. A score tuner method, comprising the steps of:
providing a score tuning broker module for performing administrative tasks associated with updating of score weights, said score tuning broker module comprising the steps of:
determining which scorecards are candidates for tuning;
checking any operating scorecards are flagged for updates; and
at a pre-specified and parameterized time frequency, determining from a rule database which scorecards are up for score weight re-tuning;
extracting needed data set sub-population based on rules determining what sampling window and stratification a current scorecard needs;
for a scorecard that is a candidate for re-tuning for the current time stamp:
requesting generation of a data set to be used for said tuning; and
determining what score weight engine project is associated with said scorecard;
passing a reference to said data set and a project id to said score weight engine, and requesting metrics of scorecard performance from said score weight engine; and
determining whether updated version is better or not; and
providing a score weight engine module for performing activities related to scorecard results and score weights, said score weight engine module comprising the steps of:
reporting on an existing scorecard's development measures;
computing a scorecard's performance measures on a new sample;
auditing new predictive data set to ensure that settings are adequate to cover data values encountered in said new data;
creating a new scorecard version of said scorecard being tuned;
converting raw records in said new predictive data set into coarse classed records needed for building weights;
building and scaling score weights of said newly created scorecard given said new predictive data; and
archiving said newly built scorecard and its performance measures.

60. The score tuner method of claim 59, wherein said score weight engine module is script-driven.

61. A score tuner method, comprising the steps of:
providing rapid weights tuning for modifying score weights of a scorecard; and/or
providing rapid score alignment for aligning parameters of said scorecard;
wherein said underlying structure of said scorecard's data is not different from original implementation definition.

62. The score tuner method of claim 61, further comprising any of the steps of:
providing a range from a null set of weights to automated and intelligent variable selection, classing, model building, scaling, and evaluation;
providing automated validation of newly developed weights for a fixed set of characteristics against a set of previously developed weights on said same characteristic set; and
providing automatic re-alignment of a set of scorecards to scale to a previous set of odds.

63. The score tuner method of claim 61, further comprising any of the steps of:
providing capability of specifying updating or re-scaling of many models at once; and
providing capability of specifying a schedule for automatic scorecard updates and scaling, implying integration into current decision support systems.

64. The score tuner method of claim 61, further comprising the step of:
providing modeling functionality comprising the steps of:
importing of existing scorecards from decision support software;
auditing for legal values for scorecard characteristics in a new data set;
generating summarized data in preparation of the tuning process including:
classing of values of data records variables into those expected by the scorecard characteristics;
generating all summarization needed to run proprietary algorithms from a newly provided predictive data set and previously summarized results from past tuning runs; and
displaying some summary statistics of records encountered;
providing specification of expected scaling parameters;
running an algorithm to generate new score weights for scorecard characteristics;
running evaluation procedures on newly tuned weights;
displaying a scorecard and its evaluation results;
fitting of log of odds vs. score to determine expected odds by score;
adjusting alignment parameters to match user supplied expectation;
exporting of said tuned alignment parameters in a format acceptable to decision support software, and while maintaining version control for said scorecard; and
providing ability to sequence any of above mentioned steps.

65. The score tuner method of claim 61, further comprising the step of:
providing reporting and visualization capabilities, comprising summarized views of new score variable and scorecard characteristics; wherein each view includes a comparison of old weights versus new, if applicable, and wherein data is divided by defined bins of scorecard characteristics.

66. A score tuner apparatus, comprising:
a database manager component for managing collection of cases used in analysis, and for providing a bridge to multiple possible input data files and/or database management systems;
a data manager component for providing data records to other data analysis components, one case at a time in the event that said data analysis components are processing cases in a sample point loop, for exposing a data dictionary to other components, and for allowing posting variables generated in said data analysis components back to said database manager for future recall;
a modeler component for providing score weight re-optimization and for logging odds to score alignment functionality;
a report collection component for providing viewing, printing, and limited editing of a standard set of model evaluation reports generated by said modeler;
a workflow controller for controlling flow of multiple business components performing a set of actions that are implied by user specifications and eventually fulfilling desired data preparation, analysis, and/or presentation steps; and
an intelligence agent for performing background checks on results from user actions and for providing suggestions if a query against its rule base returns a recommended intelligent action to take.

67. The score tuner apparatus of claim 66, wherein said intelligence agent comprises:
means for guiding specification of analytic steps;
means for reacting to interactive analytic actions with suggestions, via agents, for possible changes; and
means for automating intelligence-assisted decision-making in a sequence of analytic actions.

68. A system for estimating an uncertainty interval around at least one estimate of at least one expected outcome, comprising:
an input device operable to allow entering and transferring input data to a processor;
an output device for displaying human readable results of manipulation of said input data;
one or more communications buses between said input device and said processor and said output device and said processor, respectively; and
said processor comprising a memory, wherein said memory stores at least one program for quantifying said uncertainty interval due to variation based on case-level variation, model variation, and portfolio composition, said program performing a sequence of instructions, the sequences of instructions, which, when executed by said processor, cause the processor to perform the steps of:
causing a decision model to encapsulate case-level variation;
implementing non-parametric bootstrapping techniques to capture model variation;
using analysis of historic data on holdout samples to describe case-level error distributions; and
capturing portfolio composition variation as an integral element of said quantifying said uncertainty interval process.

69. The system of claim 68, wherein said process of quantifying said uncertainty interval comprises two stages:
wherein said first stage is repeated for each component model making up said decision model, resulting in estimating all necessary parameters, and
wherein said second stage uses said estimated parameters for rolling said up variations into aggregated measures and presenting a range of said at least one expected outcome.

70. A method for estimating an uncertainty interval around at least one estimate of at least one expected outcome, comprising the steps of:
providing an input device operable to allow entering and transferring input data to a processor;
providing an output device for displaying human readable results of manipulation of said input data;
providing communications buses between said input device and said processor and said output device and said processor, respectively; and
said processor comprising a memory, wherein said memory stores at least one program for quantifying said uncertainty interval due to variation based on case-level variation, model variation, and portfolio composition, said program performing a sequence of instructions, the sequences of instructions, which, when executed by said processor, cause the processor to perform the steps of:
providing a decision model to encapsulate case-level variation;
implementing non-parametric bootstrapping techniques to capture model variation;
using analysis of historic data on holdout samples to describe case-level error distributions; and
capturing portfolio composition variation as an integral element of said quantifying said uncertainty interval process.

71. The method of claim 70, wherein said process of quantifying said uncertainty interval comprises two stages:
wherein said first stage is repeated for each component model making up said decision model, resulting in estimating all necessary parameters, and
wherein said second stage uses said estimated parameters for rolling said up variations into aggregated measures and presenting a range of said at least one expected outcome.
